(19) United States
(12) Patent Application Publication
(10) Pub. No.: US 2023/0211886 A1
(43) Pub. Date: Jul. 6, 2023

(54) NUCLEAR AIRCRAFT SYSTEM "KARAVAN", AIRCRAFT THRUST NUCLEAR POWER PLANT, ITS HYBRID THERMAL POWER CYCLE, ITS MAINTENANCE SYSTEM AND EMERGENCY RESPONSE SYSTEM

(71) Applicants: Vladimir Petrovich SEVASTYANOV, Novosibirsk (RU); Oleksii Ivanovich PETROV, Kiev (UA); Vitalii Nikolaevich VARYGIN, Novosibirsk (RU)

(72) Inventors: Vladimir Petrovich SEVASTYANOV, Novosibirsk (RU); Oleksii Ivanovich PETROV, Kiev (UA); Vitalii Nikolaevich VARYGIN, Novosibirsk (RU)

(21) Appl. No.: 17/780,962

(22) PCT Filed: Nov. 29, 2019
(86) PCT No.: PCT/RU2019/000870

§ 371 Date: May 27, 2022

(51) Int. Cl. B64D 27/22; G21D 1/00; B64D 3/02; B64D 27/24; B64D 17/00; B64C 31/02; B60L 53/00; B64U 50/34

(52) U.S. Cl. CPC B64D 27/22; G21D 1/00; B64D 3/02; B64D 27/24; B64D 17/00; B64C 31/02; B60L 53/00; B64U 50/34; B64D 2027/026

(57) ABSTRACT

Nuclear Aircraft Transportation System “KARAVAN” with its components is represented by a group of inventions in the technical and organizational relations. The main and basic invention is Nuclear Aircraft Transportation System “KARAVAN” (NATS). This invention includes two other ones: Aircraft Thrust Nuclear Power Plant, (ATNPP), which in turn includes—Thermal Power Cycle of ATNPP, (TPC ATNPP). In addition, the represented group of inventions is made up of two more inventions: Maintenance System of ATNPP, (MS ATNPP) and Emergency Response System of NATSK, (ERS NATSK).

The concept of practical implementation of the presented group of inventions involves the fact that ATNPP, which is a large unmanned drone aircraft “Tiagach”, supplies the aero-train composed of a number of passenger liners and cargo transport planes using electric motors with traction electric energy in the air.

The power supply of such an aero-train is based on the onboard Nuclear Power Plant of the aircraft “Tiagach”. In this case, the transmission of electric power to the towed electric aircraft of the aero-train is carried out by means of electric split feeders and cables, connecting and disconnecting of which between airplanes of the aero-train is carried out in the air, by analogy with refueling of airplanes in the air with JP fuel.

During the flight of the aero-train on a logistically optimized route, electric airplanes can detach from and attach to the aero-train, taking off and landing along the flight route of the aero-train using their own electric accumulators. In addition, extra ATNPP may be included in the aero-train during its flight, if it is necessary to increase the thrust. At the same time, due to the use of nuclear power, such ATNPP can remain in the air for a conditionally indefinite period of time.

The invention is aimed at creating cost-effective air freight and passenger traffic.

### BACKGROUND OF THE INVENTION

The global development of socio-cultural cycles is currently characterized by enormous communicative and economic factors accompanied by the physical movement of material resources in increasingly large volumes and over greater distances.

As a result, there is a continuous development and improvement of various vehicles under which their user capabilities are changing from a competitive point of view. For example, maritime transport successfully competes with other means of transport in terms of cargo carrying capacity, while aviation efficiently competes in relation to the cargo delivery speed.

In addition, the requirement of environmental human security on the planet, as well as economic factors, determines not only the dynamics, but also the structure of vehicles. So, for example, previously highly developed vehicles powered by coal have almost come to naught, and instead of them the fossil-fuel powered vehicles are widely used which also do not affect the planet's ecology in the best way. However, the vehicles using nuclear power, such as atomic icebreakers and the military fleet, have also emerged in the last decades. Nuclear-powered transport is more environmentally friendly than other means of transport if there are no accidents involving releases of radioactive substances into the environment as a result of its usage. Consequently, there are ongoing developments in nuclear engineering increasing its reliability—technology is improved and new materials are applied that are more resistant to the severe service conditions.

### FIELD OF INVENTION

The presented group of inventions refers to the field of atomic aviation of transport and passenger purposes, representing a multi-aircraft system based on the functional similarity of railway rolling stocks.

THE OBJECT OF THE GROUP OF INVENTIONS is to develop a new type of transport system with a large carrying capacity ensuring rapid delivery of cargo and passengers.

The PROBLEM SOLVED BY APPLICATION OF THE GROUP OF INVENTIONS in the complex, due to the flexibility of the proposed technology on the use and application of components of this system provides its economic efficiency in terms of a significant increase in cargo capacity and a relative extension of logistics capabilities in cargo and passenger transportation while preserving the speeds typical for aviation.

In addition, the application of the proposed group of inventions in the complex provides an exceptionally high environmental safety and considerable cost-effectiveness of the new system.

### SUMMARY OF THE INVENTION

### Disclosure of the Group of Inventions as a Whole

As mentioned above, there is an ongoing development and improvement of various vehicles in the world in the course of which their user capabilities are changing from a competitive point of view. For this reason and due to the improvement of atomic engineering and aviation, it seems reasonable to develop new transportation systems that functionally combine the capabilities of aviation and railroads, using the speed of aviation along with the facilities of railroads in terms of their logistics and high cargo turnover. Thus, the proposed invention has the TASK to show the ability of creating completely new, high-efficiency freight and passenger transportation systems. The proposed invention demonstrates the technique and shows the technical result of new cargo-passenger systems endowed with the best properties of aviation and railroads, according to the inventive conception.

The set TASK is solved by a group of inventions, which are used to create multi-tonnage and above-tonnage aircraft complexes with highly flexible logistics, providing fast delivery of cargo and passengers over long distances.

The application technology of the group of presented inventions is actually focused on aircraft with electric traction, cargo and passenger aircraft, and on a traction power unit represented by a flying nuclear power plant.

Attempts to move away from JP fuels in aviation are facilitated by the latest developments in the area of accumulators. Electric aircraft engines are being developed in a number of countries. For example, Rolls-Royce presented a concept of an electric aircraft engine at the 2013 Paris Air Show, [1]. The German company Bauhaus Luftfahrt is also introducing a future fully electric aircraft “Ce-Liner” powered by replaceable lithium-ion batteries, [2].

### Other Examples of the Tendencies in Electric Aircraft Development

The X-57 Maxwell electric aircraft was being developed by NASA as part of the New Aviation Horizons initiative. The first flight trials of the X-57, which is expected to have 14 engines, were scheduled for spring 2018, [3];
Siemens tested a prototype f of the Extra 330LE airplane. The aircraft broke the speed record among electric-powered airplanes and towed the glider in just 76 seconds. The prototype of the Extra 330LE electric airplane reached a speed of 340 km/h, covering a distance of three kilometers. Trials of the vehicle were held on 24 Mar. 2017, [4].
The Wright Electric startup expects to replace the most popular passenger aircraft, the Boeing 737, with an electric airplane for short-haul air lines. Fuel is the most expensive thing for airlines. And the easiest way to cut these costs is to stop using it at all, [5].

Known from open sources analysis of mobile nuclear reactors and consideration of the largest aircraft in terms of their cargo carrying capacity, as well as taking into account attempts to create atomic bombers in the USSR and in the USA [6, 7] indicate the possibility of creating safe atomic aviation in its “development” and based on modern advances in atomic technology.

The application technology of the group of proposed inventions is also focused on the means of flight power supply of these aircraft for building the air caravans, as well as on the airfield Stations and Maintenance Systems (MS). Besides, the application technology of the group of proposed inventions assumes the possible use of special Emergency Response System (ERS) including Emergency Parachute System of Nuclear Reactors. Based on this, the Nuclear Aircraft System “Karavan” (NASK) is presented according to the inventive conception.

Taking into account the basic opportunities for NASK creation, conditioned by the research and technological groundwork available in one or another country, it is possible to outline the “geography” of possible design and manufacturing processes and locations of NASK regarding the application of the group of proposed inventions. First of all, these are the countries possessing technologies of mobile nuclear power and possessing aircraft construction in terms of the largest planes, such as Boeing 747 LCF Dreamlifter, Airbus A400M, Airbus A300-600ST Beluga, Airbus A380, Airbus A390, AN-22SH, AN-124, AN 225, Project Lightning-1000—“Hercules” and a twin-fuselage aircraft Scaled Composites Stratolaunch model 351.

Phenomenological model of the proposed group of inventions implies their technical relationship, from which, according to the inventive conception, this group of inventions is created. Thus, the main and basic invention is the Nuclear Aviation System “Karavan”, (NASK). This invention includes two more inventions:

Aircraft Thrust Nuclear Power Plant, (ATNPP), which in turn contains an invention—its Hybrid Thermal Power Cycle, (HTPC ATNPP);

In addition, the represented group of inventions is made up of two more inventions: Maintenance System of ATNPP, (MS ATNPP) and Emergency Response System of ATNPP, (ERS ATNPP).

The concept of practical implementation of the presented group of inventions involves the fact that Aircraft Thrust Nuclear Power Plant, (ATNPP), which is a large unmanned drone aircraft “Tiagach”, supplies the aero-train composed of a number of passenger liners and cargo transport planes using electric motors with electric energy in the air. Such an aero-train can be composed of both airliners and, transport aircraft.

The idea of an unmanned nuclear aircraft with remote control via electric cable was being developed in the United States [6, No 3, p. 33]. Moreover, it was assumed that the pilots could be in the conventional aircraft, which could be towed behind the nuclear aircraft on a long cable.

In the USSR, when developing a nuclear aircraft, the problem of heavy radiation protection for the crews logically led to the idea of an unmanned strategic bomber, [6, No 4, p. 17; 8, p. 8; 9, p. 69].

Transmission of electric power from the onboard Nuclear Power Plant of the aircraft “Tiagach” to the towed airliners and transport aircraft of the aero-train is carried out by means of electric cables, connecting and disconnecting of which between the towed airplanes and ATNPP by special feeders is conducted in the air, by analogy with refueling of airplanes in the air with JP fuel. Examples of this analogy are the application of refueling aircraft such as the IL-96-400TZ, AN-122-KC, Airbus A330 MPTT, Airbus CC-150 Polaris, Boeing KC135 Stratotanker, Boeing KC-45, EADS/Northrop Grumman KC-45, McDonnell Douglas KC-10 Extender.

A certain concept of transmitting electrical power to the group of aircraft from a single vehicle has already been outlined in [10]. Here, not only electric power, but also liquid fertilizer, which is sprayed by the drones, is transmitted by air lines during the flight from one helicopter to several drones moving in a certain formation. In [11], the option of transmitting electric power to a single unmanned aircraft over an air line is also described.

During the flight of the aero-train on a logistically optimized route, electric airliners and transport aircraft can detach from and attach to the aero-train, taking off and landing along the flight route of the aero-train using electric power from their own accumulators. In addition, extra ATNPP may be included in the aero-train during its flight, if it is necessary to increase the thrust.

At the same time, due to the use of nuclear power, such ATNPP can remain in the air from several days to a conditionally indefinite period of time, as it was planned in the process of developing the nuclear bombers, [6, 7, 9, 12, 20].

And, of course, the problem of jet engine noise is solved radically.

### Field of Invention of the Nuclear Aircraft System “Karavan” (NASK)

The invention refers to the field of aviation of transport and passenger purposes, representing a multi-aircraft system based on the functional similarity of railway rolling stocks.

The application of the NASK invention ensures economic efficiency in cargo and passenger transportation due to its large carrying capacity, extensive logistics facilities while preserving the speeds typical for aviation.

### Background of the Invention Relating to the Technology of NASK Application

Concerning the technology of NASK application, the authors of the proposed invention are aware of poorly relevant technical solutions, which can be grouped on the basis of their functional purpose:
processes of lifting and towing gliders as well as their landing;
functional configurations of aircraft with gliders;
design solutions concerning glider towing aircraft;
design solutions for towed gliders.

Most of the well-known solutions are focused on the application of cargo gliders, including the task of landing of military equipment and people.

The proposed invention, due to its structure, is focused on commercial cargo and passenger applications, with technological flexibility in terms of logistics and with highly efficient technical features.

In relation to the proposed NASK invention from [13] the large Gotha Go 242 gliders are known to have been used in the number of 1,500 specimens. Two such gliders were simultaneously towed by a “Tiagach” Heinkel He 111.

### Here the Common Features with the Proposed Invention Include

the availability of a tow airplane for aircraft;
the functional configuration of aircraft in the air—an aero-train;
the presence of more than one towed aircraft in composition of an aero-train.

REASONS PREVENTING THE NASK FROM OBTAINING A TECHNICAL RESULT, compared to the aero-train described in [13]:
impossibility of independent takeoff of towed aircraft;
impossibility to dock the towed aircraft to the tow one in the air;
low carrying capacity of towed aircraft;
small number of towed aircraft;
short delivery range of towed aircraft to their landing sites;
relatively low flight speeds of the aero-train;
a high restriction of the aero-train in terms of logistics of its application, due to the impossibility of applying the sorting of towed aircraft in the course of its flight, namely the impossibility of undocking one or another towed aircraft leading the following vehicle, as well as the inability to insert “new” vehicles into the composition of the aero-train in the air.

According to the data from [14] the application of the aero-train with American cargo gliders Waco CG-4A is well known. Here the relatively low weight of Waco CG-4A gliders allowed one aircraft towing two gliders at once.

### The Common Features with the Proposed NASK Invention Include

the availability of a tow airplane for aircraft;
the functional configuration of aircraft in the air—an aero-train;
the presence of more than one towed aircraft in composition of an aero-train.

REASONS PREVENTING THE NASK FROM OBTAINING A TECHNICAL RESULT, compared to the aero-train described in [14]:
impossibility of independent takeoff of towed aircraft—gliders;
impossibility to dock the towed aircraft to the tow one in the air;
low carrying capacity of towed aircraft;
small number of towed aircraft;
short delivery range of towed aircraft to their landing sites;
relatively low flight speeds of the aero-train;
a high restriction of the aero-train in terms of logistics of its application, due to the impossibility of applying the sorting of towed aircraft in the course of its flight, namely the impossibility of undocking one or another towed aircraft leading the following vehicle, as well as the inability to insert “new” vehicles into the composition of the aero-train in the air.

Variants of towing a large Messerchmitt Me 321 Gigant cargo glider are also known. Here the “triplets” of Ju 90 tow aircraft, or the “triplets” of Bf 110 tow aircraft were initially used, and then a single twin-fuselage Heinkel He 111Z Zwilling tow aircraft was applied, [13 [symbol] 15].

### The Common Features with the Proposed NASK Invention Include

the availability of tow airplanes for aircraft;
the functional configuration of aircraft in the air—an aero-train;
the presence of more than one towed aircraft in composition of an aero-train.

REASONS PREVENTING THE NASK FROM OBTAINING A TECHNICAL RESULT, compared to the aero-train described in [13 [symbol] 15]:
impossibility of independent takeoff of towed aircraft;
impossibility to dock the towed aircraft to the tow one in the air;
low carrying capacity of towed aircraft;
small number of towed aircraft—one;
short delivery range of towed aircraft;
relatively low flight speeds of the aero-train;
a high restriction of the aero-train in terms of logistics of its application, due to the impossibility of applying the sorting of towed aircraft in the course of its flight, namely the impossibility of undocking one or another towed aircraft leading the following vehicle, as well as the inability to insert “new” vehicles into the composition of the aero-train in the air.

The aero-train, which flew and was made up of nine gliders towed by the ANT-4 aircraft, (TB-1) is also known. The gliders of this aero-train were towed in the V-shaped formation, [16].

### Here the Common Features with the Proposed Invention Include

the availability of tow airplanes for aircraft;
the functional configuration of aircraft in the air—an aero-train;
relatively close number of towed aircraft in the aero-train;

REASONS PREVENTING THE NASK FROM OBTAINING A TECHNICAL RESULT, compared to the aero-train, photos of which are presented in [16]:
impossibility of independent takeoff of towed aircraft;
impossibility to dock the towed aircraft to the tow one in the air;
low carrying capacity of towed aircraft;
relatively short delivery range of towed aircraft to their landing sites;
relatively low flight speeds of the aero-train;
a high restriction of the aero-train in terms of logistics of its application, due to the impossibility of applying the sorting of towed aircraft in the course of its flight, namely the impossibility of undocking one or another towed aircraft leading the following vehicle, as well as the inability to insert “new” vehicles into the composition of the aero-train in the air.

In [13] you can find information about Pavel Grohovsky's original project—a transport aero-train. The leading aircraft of this project could tow up to TEN gliders with cargo, towed in a row—one after another. According to the authors of the proposed invention—NASK, this project most closely correlates with the inventive conception and is accepted as a prototype, although the relevance here is obviously rather low. However, the authors of the proposed invention are not aware of any similar technical solutions.

Here, the ESSENTIAL FEATURES of the prototype include:
the availability of tow airplanes for aircraft of the aero-train;
the functional configuration of aircraft in the air—an aero-train;
various number of towed aircraft in the aero-train—up to ten;
takeoff of the aircraft of the aero-train is carried out due to the mechanical thrust from the tow aircraft;
the ability of autonomous independent landing of towed aircraft of the aero-train.

### The Common Essential Features of the Prototype with the Proposed Invention—NASK, Include

the availability of tow airplanes for aircraft of the aero-train;
the functional configuration of aircraft in the air—an aero-train;
various number of towed aircraft in the aero-train;
the ability of autonomous independent landing of towed aircraft of the aero-train.

REASONS AND FEATURES PREVENTING THE NASK FROM OBTAINING A TECHNICAL RESULT, compared to the aero-train described in [13]:
impossibility of independent takeoff of towed aircraft;
impossibility to dock the towed aircraft to the tow one in the air;
low carrying capacity of towed aircraft;
relatively short delivery range of towed aircraft to their landing sites;
relatively low flight speeds of the aero-train;
a high restriction of the aero-train in terms of logistics of its application, due to the impossibility of applying the sorting of towed aircraft in the course of its flight, namely the impossibility of undocking one or another towed aircraft leading the following vehicle, as well as the inability to insert “new” vehicles into the composition of the aero-train in the air.

### Disclosure of the Invention in the Part of the Nuclear Aircraft System “Karavan”, (Nask)

The task solved in the NASK invention is the ideological conversion of the basic logistics of freight transportation by railroads into the concept of logistics of aero-train application, as in the railway rolling stocks, based on the traction locomotive and towed carriages and, by this analogy, for NASK based on the Aircraft Thrust NPP and towed electrical aircraft.

Based on the above-described concept, the proposed invention applies the well-known concept of railroad logistics as a basic one. And its realization in general and in a broader sense is ensured by the presence in the presented invention of technical tool capabilities, such as:
Forming the primary sets of aero-trains by passenger liners and cargo transport aircraft with electric traction in connection with the economic optimization of their routes;
Operational sorting of the sequence of airliners and transport aircraft as part of aero-trains in the air, due to the expediency of landing those or other aircraft detached from the aero-train during the flights;
Operational sorting of the sequence of airliners and transport aircraft as part of aero-trains in the air due to the possibility of using connections of different electric aircraft to one or another aero-train during its flight;
Operational cooperation between different aero-trains in the air, including the possibilities of cooperation between various airlines;
The application of several Aircraft Thrust Nuclear Power Plants (ATNPP) within an aero-train, including the possibility of their attachment to and detachment from the aero-train along the flight route that may be necessary to increase/decrease thrust power for the series of electric aircraft as a result of the foregoing cooperation.

The result of a sophisticated computational strategy based on the above-mentioned tool capabilities will be the improvement of the key economic indicators of NASK air logistics, namely:
Reduction of turnaround time for electric passenger airliners and electric transport aircraft within the airline;
Reduction of air transportation costs due to decreased downtime of aircraft waiting for a fuller load as a result of cooperation;
Reduction of all operating costs for air transportation in relation to traditional widely used solutions, especially due to the failure to use expensive JP fuel.

In view of the NASK mentioned conceptual provisions on the basis of cooperation between different airlines, a global network of Air Nuclear Transportation may be developed in the future.

The structural composition of the NASK is shown in FIG. 1 and FIG. 2. Here the position 1 stands for the Aircraft Thrust Nuclear Power Plant (ATNPP). FIG. 1 shows the ATNPP in flight as part of the NASK. In FIG. 2, NASK is shown during takeoff and landing. In FIG. 1, the first driven electric aircraft (e.g., cargo/transport one) is shown in flight as part of the NASK under position 2, while position 3 shows the first over-flight electric aircraft—passenger one/liner.

The power supply to the driven aircraft is carried out sequentially from the ATNPP 1 to the aircraft 2 and then to the subsequent aircraft (they are shown in FIG. 3 instead of FIG. 2). The power supply to the over-flight aircraft is carried out sequentially from ATNPP 1 to the aircraft 3 and further to the next aircraft ahead (they are shown in FIG. 3 instead of FIG. 2).

### The Technical and Technological Process of NASK can be Summarized in the Following Way

At takeoff of ATNPP 1 (see FIG. 2), the over-flight Electric Grid Module (EGM) marked by position 4 is mounted in the nose of ATNPP 1, while the Towed Electric Grid Glider (TEGG) marked by position 5 is mounted in the tail of ATNPP 1.

EGM 4 and TEGG 5 in terms of their controllability are designed as unmanned ones with combined control:
by remote manual control;
by means of automatic systems.

Takeoffs of the aircraft of the aero-train primary series are performed sequentially according to the plan of their landings during the aero-train flight. At the same time, it is assumed that the runways of these aircraft are located nearby the takeoff site of ATNPP 1, the takeoff of which is “synchronized” in time due to the rate-of-climb capabilities of these aircraft. In this case the takeoff of ATNPP 1 to the optimal height of docking with “towed” aircraft is carried out by the thrust of the air screws, driven by electric motors and by own on-board accumulators, charged from the airfield maintenance stations of electric aircraft.

At some optimal height, the taking-off aircraft and ATNPP 1 line up in a large, connecting, closed cyclic route, e.g., in the way of a rectangular or truncated circle, on the chord of which these aircraft connect with ATNPP 1 and between each other, thus forming an optimized aero-train, (see, for example, FIGS. 3÷5). As taking-off aircraft begin to dock with ATNPP 1, its nuclear reactors are gradually being put into cruise modes. During these processes in ATNPP 1 smooth transitions of traction force formation of electromotive organic steam generating units are performed from electric traction to steam-turbine one, carrying out power supply to electrically towed aircraft at the same time.

The dockings of ATNPP 1 with “towed” aircraft are performed in the following way. At the height of the dockings and on the chord section of the connecting truncated circle the EGM 4 is undocked from the ATNPP 1, and due to the electromotive thrust of the air screw of this EGM 4, the Lead-in Cable 7 (LIC) is pulled out of ATNPP 1 (see FIG. 1). The power supply of EGM 4 in this case is carried out by means of LIC 7 from the ATNPP 1 on-board energy source. Here the controlled mechanical linkage of EGM 4 with ATNPP 1 is applied, by means of which the corresponding mechanical docking and undocking is performed, if required, by some analogy with the device [17].

The length of the LIC 7 is selected based on the level of radiation safety in relation to the first over-flight aircraft 3, taking into account the presence of increased radiation protection built into the ATNPP 1. Such increased radiation protection is possible due to the fact that the ATNPP 1 aircraft does not have any cargo on board and such enhanced protection is provided due to their possible weight.

The main shadow protection is aligned along the ATNPP fuselage to maximize its efficiency in relation to the “towed” aircraft of the aero-train.

After full extraction of the LIC 7 from the ATNPP 1 by means of the docking feeder 8 and the elastic electrical cable bar 9 (ECB) the electric lines are docked by analogy with the widespread dockings with flight refueling aircraft, (see FIG. 1). New design solutions can be applied to the quick-release electrical connections, for example, in relation to the aviation counterpart, [18].

For the purpose of compensating the dynamic instability of the distance between EGM 4 and ATNPP 1, LIC 7 is kept with some slack by means of autopiloting and tension automatics of this LIC 7.

To dock the first driven aircraft 2 with ATNPP 1, TEGG 5 is detached from the ATNPP and TEGG 5 draws this TEGG 10 from ATNPP 1 to a reasonable length for radiation protection reasons due to the tension of the Lead-in Cable 10 (LIC). Thus, based on the required planning speed of the TEGG 5 and on the required drawing force of the LIC 10, the geometry of the TEGG 5 glider is changed in order to correct its aerodynamic quality.

To improve controllability and increase the aerodynamic efficiency of the TEGG 5, its glider is constructed with forward-swept wings.

Once the TEGG 5 flight is stabilized by means of the docking feeder 11 and the elastic Electrical Cable Bar 12 (ECB), the aircraft 2 is docked with the TEGG 5. Then sequential dockings of the driven planes 13, 14 and following aircraft are carried out in flight along the chord of the docking truncated circle behind the aircraft 2, as shown in FIG. 3.

Simultaneously with docking of the driven aircraft 13, 14, etc. in the aero-train, a series of dockings of over-flight aircraft 15, 16 and other aircraft ahead of them is performed, as shown in FIG. 3. In this process, between electrically “towed” aircraft flexible air and Controlled Electric Lines 17 (CEL) are applied, through which energy is transmitted sequentially to all “towed” aircraft. The analogues of the technical solutions concerning such CEL 17 can be docking technologies of flight JP refueling aircraft and design solutions, for example, such as those in [18].

To ensure the reliable performance of all aero-train CEL 17, due to their structural length, the distance between the aero-train planes is stabilized by means of special autopiloting.

Once the formation of the primary series of aero-train is completed, it is lifted to the route height and accelerated in the direction of the planned flight. At the same time in ATNPP 1 an expedient number of these or those nuclear reactors is switched to cruise modes, depending on the calculated number of aircraft in the primary composition of the aero-train. In this flight ATNPP 1 generates electrical power through one or more electric turbine-generator units that is transmitted to all electrically “towed” aircraft.

During the aero-train flight, the possible EXCESS OF MECHANICAL ENERGY on the shafts of the organic steam generating units that drive the ATNPP 1 air traction screws is TRANSFERED to the electric machines, which are switched from motoring modes to generating ones. Such modes are implemented if the number of “electrically towed” aircraft in the aero-train is less than the maximum possible one under the energy conditions, considering also the fact that during the flight all aircraft of the aero-train, including ATNPP 1, recharge the onboard accumulators, which are discharged during takeoffs.

For reasons of radiation protection, several EGMs and TEGGs can be used during the aero-train flight, which are not shown in FIG. 3. Due to such a solution the distances between ATNPP 1 and the “electrically towed” aircraft can be increased.

In addition, in electric airplanes designed for aero-trains, the accumulators in the bodies of these airplanes are placed oriented between the crew cabins and the passenger cabins, providing some additional protection against possible residual ionizing radiation.

When the aero-train approaches the aircraft sorting airfield, one or another aircraft, or airplanes according to their arrival schedule, are undocked from the aero-train and land on the traction of their own accumulators, which were charged earlier in the flight, as mentioned above. Here the “accurate” correction of the spatial coordinates of undocking the landing airplanes from the aero-train and their landings can be carried out by some analogy with the solutions presented in [19].

In addition, when the aero-train approaches the aircraft sorting airfield, the scheduled takeoffs of other aircraft and their docking into the aero-train are carried out from that airfield. Therefore, the sequence of forming a “new” aero-train is optimized when planning the undocking and docking of planes by the criterion of minimum time in the air of this “new” aero-train over the next “sorting” airfield.

At the same time, undocking and docking of aircraft are performed according to a certain local estimated schedule of “sorting” airfield—a schedule of aircraft sorting dynamics, the construction of which is carried out by means of optimization with the construction of a local aero-train route with its altitudes, speeds and glides of the corresponding aircraft. If the number of sorted planes is such that a “straight line” flight of the aero-train, even at its minimum speeds, near the sorting airfield is not efficient in terms of energy consumption of the accumulators of sorted planes, then the local route of the aero-train is planned on a truncated docking circle, as mentioned above, when the primary series of aero-train takes off.

Once all scheduled aircraft undockings and dockings are completed, the aero-train is directed to the next sorting airfield, and so on.

Thus, the logistics of aero-train flights generally involves an end-to-end “preventive” planning of the traffic dynamics of all aircraft involved in one or another aero-train along its entire route. In this case, the inventive conception implies that planning of the next route of the aero-train is performed during the flight along some primary-planned route or even earlier, and so on. Obviously, all this is provided by continuous flight planning, and the “planning horizon” is determined and updated in time in connection with the operational receipt of requests for those or other transportations.

Here the basic principles of the aero-train logistics are outlined above, mainly for understanding the nature of the proposed invention and its authors do not claim to develop a complete algorithm for the logistics of NASK aero-train application. However, the basics of this concept limit the possible claim to authorship of the development of full algorithms for the application of aero-trains.

### The Essential Features Required to Achieve the Technical Result of the Nask Invention

the functional configuration of aircraft in the air—an aero-train;
as part of the aero-train aircraft, the tow aircraft is a nuclear-powered airplane;
various number of towed aircraft in the aero-train—up to several dozen;
the ability of autonomous independent takeoff and landing of towed aircraft;
ability to dock the towed aircraft to the tow one in the air;
high carrying capacity of towed aircraft;
unlimited delivery range of towed aircraft to their landing sites;
high flight speeds of aero-trains, like those of modern airplanes;
the logistics of aero-train application is limitless, due to the possibility of sorting towed aircraft during its flight, namely due to the ability to undock one or another towed aircraft from any place in the aero-train, as well as due to the opportunity to insert “new” aircraft, at any place in the aero-train in the air.

### All Essential Features of the NASK Invention

the functional configuration of aircraft in the air—an aero-train;
as part of the aero-train aircraft, the tow aircraft is a nuclear-powered airplane;
various number of towed aircraft in the aero-train—up to several dozen;
the ability of autonomous independent takeoff and landing of towed aircraft;
ability to dock the towed aircraft to the tow one in the air;
high carrying capacity of towed aircraft;
unlimited delivery range of towed aircraft to their landing sites;
high flight speeds of aero-trains, like those of modern airplanes;
the logistics of aero-train application is limitless, due to the possibility of sorting towed aircraft during its flight, namely due to the ability to undock one or another towed aircraft from any place in the aero-train, as well as due to the opportunity to insert “new” aircraft, at any place in the aero-train in the air.

### The Essential Features of the NASK Invention Distinctive from Those of the Prototype

as part of the aero-train aircraft, the tow aircraft is a nuclear-powered airplane;
the ability of autonomous independent takeoff of towed aircraft;
ability to dock the towed aircraft to the tow one in the air;
the number of towed aircraft in the aero-train is up to several dozen;
high carrying capacity of towed aircraft;
unlimited delivery range of towed aircraft to their landing sites;
high flight speeds of aero-trains, like those of modern airplanes;
the logistics of aero-train application is limitless, due to the possibility of sorting towed aircraft during its flight, namely due to the ability to undock one or another towed aircraft from any place in the aero-train, as well as due to the opportunity to insert “new” aircraft, at any place in the aero-train in the air.

### BRIEF DESCRIPTION OF THE DRAWINGS AS APPLIED TO THE NASK INVENTION

FIG. 1 shows the in-flight fragment of the NASK, illustrating the active condition of its elements which provide electric power to “electrically towed” aircraft with their electric traction cargo/transport and passenger airliners, marked by positions 2 and 3. It also shows one of the possible general configurations of the ATNPP 1 construction in flight.

FIG. 2 illustrates the ATNPP 1 on takeoff and landing, when using the thrust for its glider by the air screws driven by electric machines from the own ATNPP 1 accumulators. The elements of the NASK power supply in the passive condition are also shown here.

FIG. 3 shows one of the possible variants of constructing the NASK cargo-passenger aero-train. The positions 3, 15 and 16 herein indicate airliners moving ahead of ATNPP 1 in flight, while the positions 2, 13 and 14 indicate the cargo/transport aircraft following ATNPP 1. The application of the aero-train power supply elements EGM 4, TEGG 5, LIC 7, LIC 10 and CEL 17 described above are also shown.

FIG. 4 shows one of the possible variants of NASK passenger aero-train construction. Here the positions 3, 15, 16, 18, 19 and 20 indicate airliners moving ahead of ATNPP 1 in flight, and the positions show power supply elements of aero-train EGM 4, LIC 7, and CEL 17.

FIG. 5 shows one of the possible variants of NASK cargo aero-train construction. Here the positions 2, 3, 13, 14, 15 and 16 indicate transport aircraft—“electrically towed” by means of ATNPP 1. Application of power supply elements of this aero-train EGM 4, TEGG 5, LIC 7, LIC 10 and CEL 17 is also illustrated.

FIG. 6 shows one of the possible variants of NASK aero-train construction of a large cargo composition, with two ATNPPs 1. Here, positions 2 and 3 fragmentarily indicate some transport aircraft of the aero-train composition. The application of some power supply elements of this aero-train EGM 4, TEGG 5, LIC 7, LIC 10 and CEL 17 is also demonstrated.

FIG. 7 shows one of the possible variants of NASK aero-train construction of large composition of cargo and passenger purpose, with two ATNPPs 1. Here the “electrically towed” aircraft 2 and 3 are shown fragmentarily from the aero-train composition. Also a part of the aero-train elements providing power supply for these aircraft 2 and 3, including EGM 4, TEGG 5, LIC 7, LIC 10 and CEL 17, are demonstrated.

### THE BEST OPTIONS FOR EMBODIMENT OF THE MAIN BASIC INVENTION—THE NUCLEAR AIRCRAFT SYSTEM “KARAVAN”, (NASK)

The embodiment of the invention implies that an aero-train is formed in the air by some number of passenger liners, or cargo transport aircraft with electric engines. In flight, the aero-train is powered by the ATNPP, which is a very large unmanned drone aircraft “Tiagach”. Such an aero-train can also be made up of airliners and, transport planes.

The transfer of power from the ATNPP to the electrically “towed” airliners and transport aircraft of the aero-train is carried out by means of electrical cables, docking and undocking of which between the “towed” aircraft and the ATNPP is performed in the air.

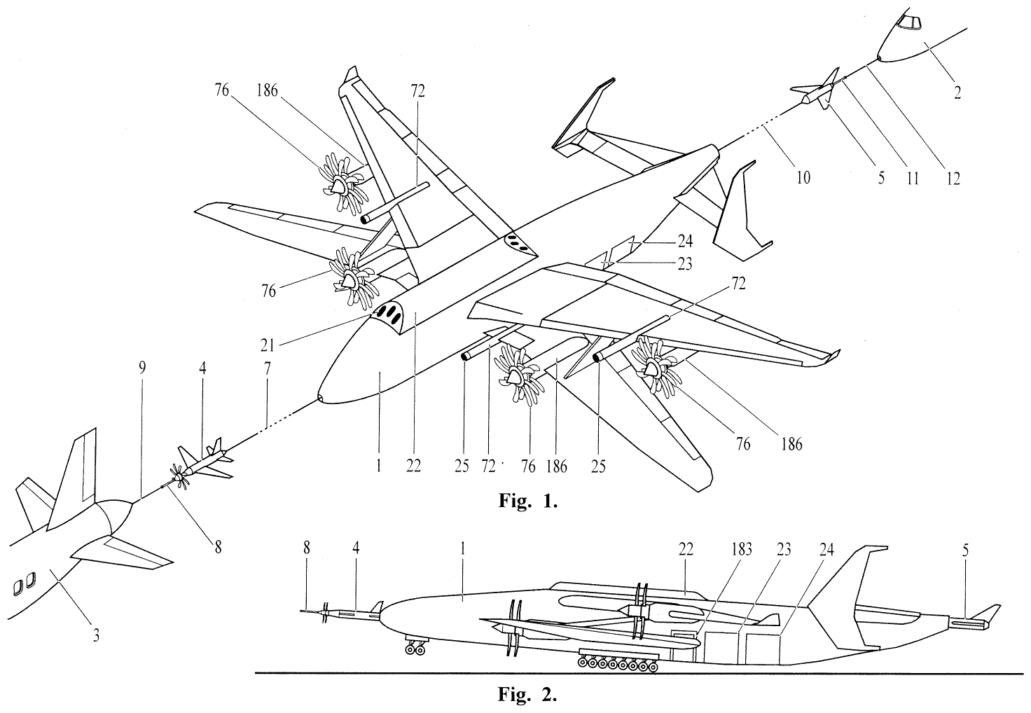

In FIG. 1, position 2 shows the first driven electric aircraft (e.g., cargo/transport one) in flight as part of the NASK, and position 3 indicates the first over-flight electric aircraft—a passenger one/airliner.

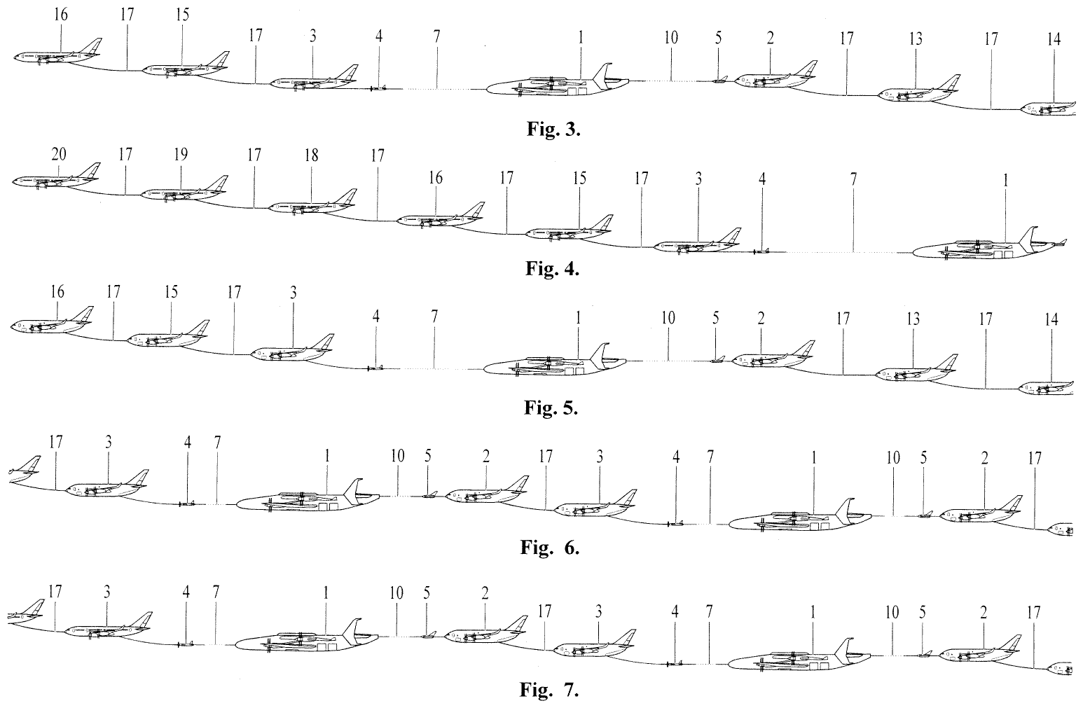

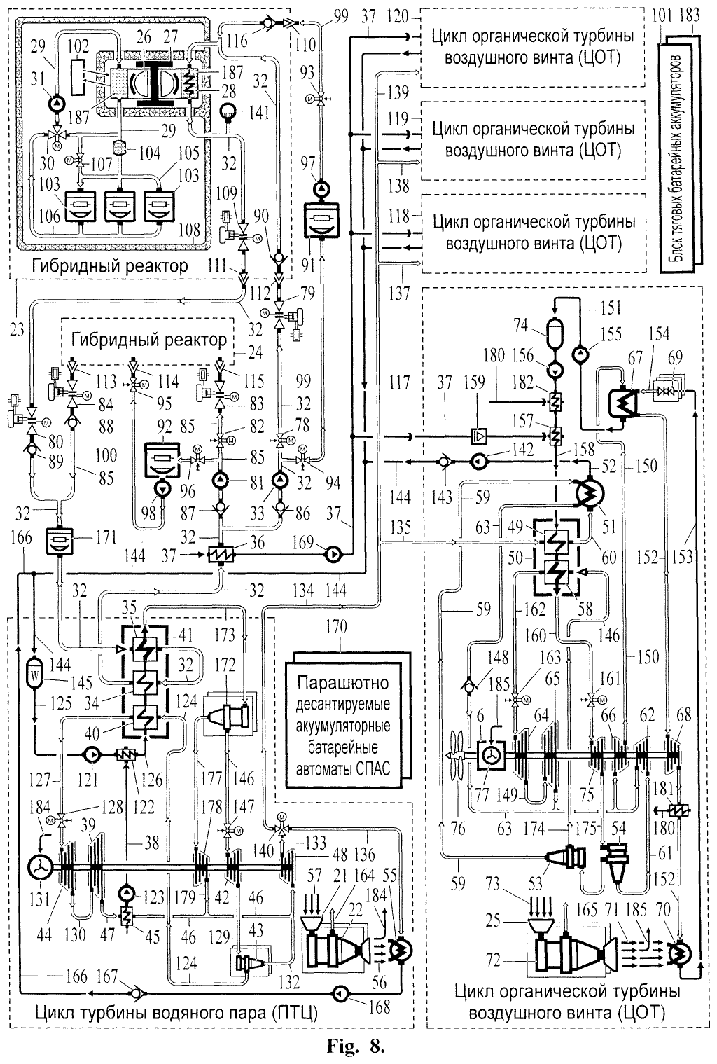

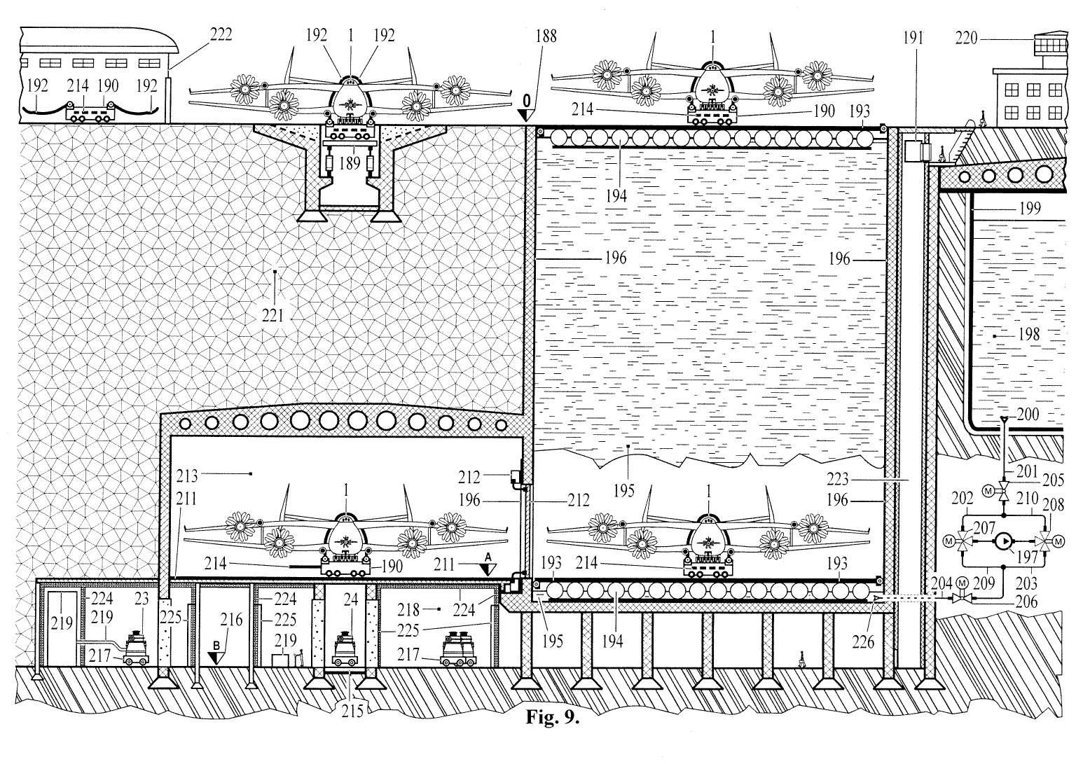

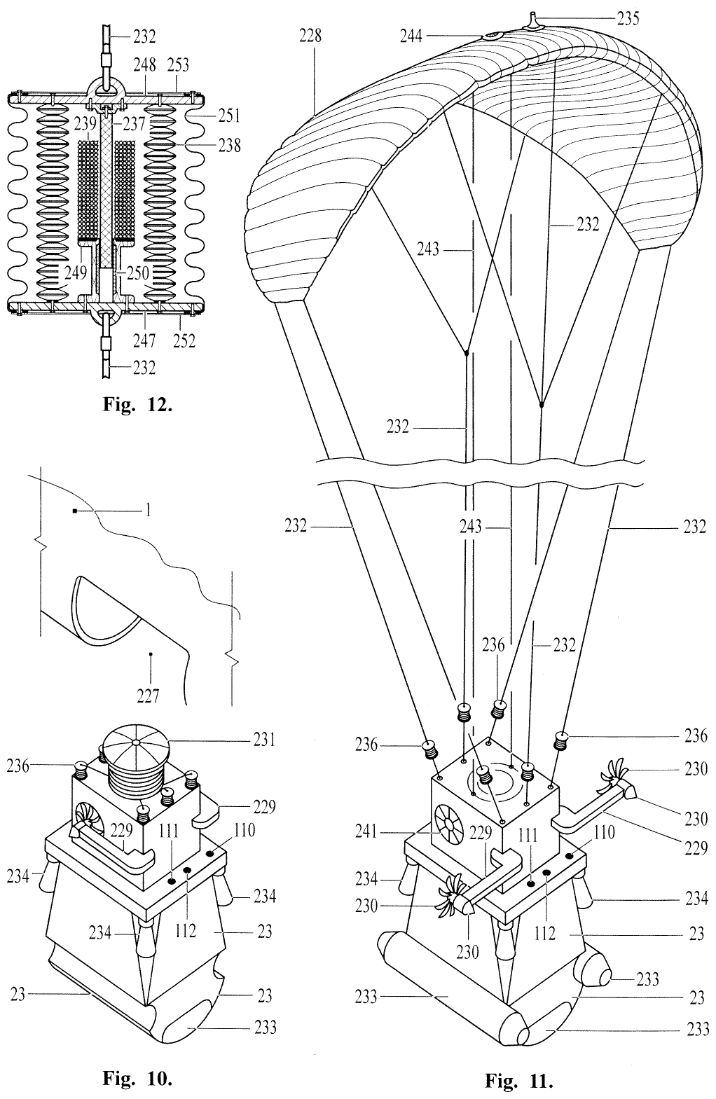

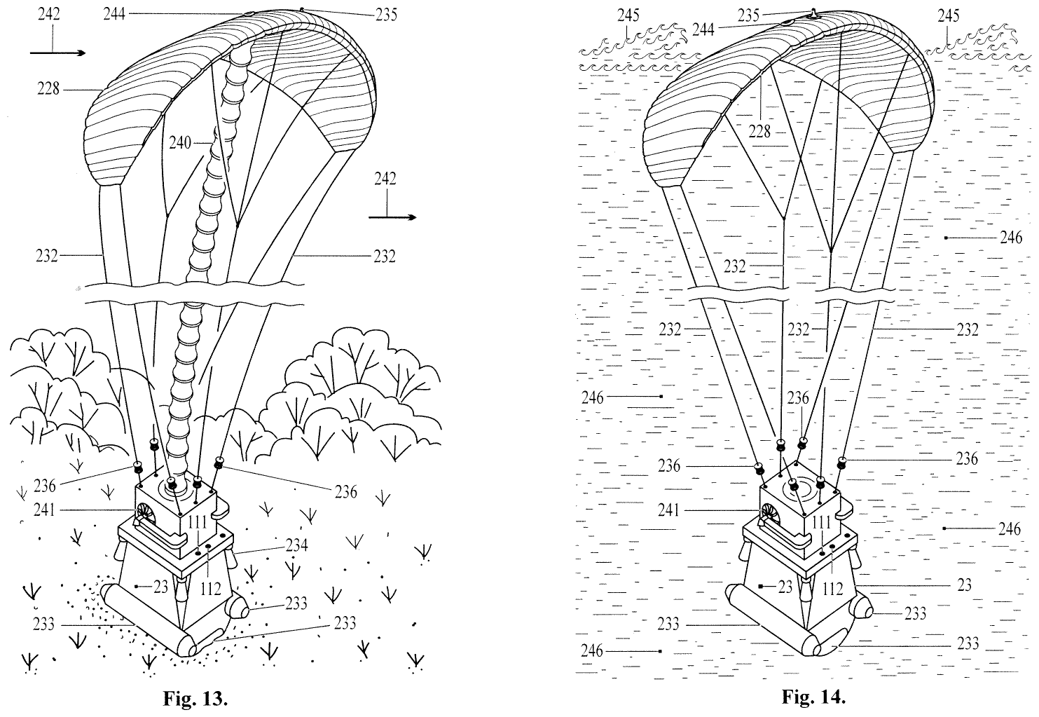

The driven aircraft are powered sequentially from ATNPP 1 to aircraft 2 and further on to the following aircraft 13 and 14 as shown in FIG. 3. The power supply to the over-flight aircraft is carried out sequentially from ATNPP 1 to aircraft 3 and further on to the preceding aircraft 15 and 16 as shown in FIG. 3. At the same time, it is assumed that the number of driven and over-flight aircraft can be up to several dozens, due to the ability to include additional ATNPPs 1 in the NASK, to increase the traction power of the aero-train, as shown in FIG. 6 and FIG. 7.

During the flight of the aero-train on a logistically optimized route, electric airliners and transport aircraft can detach from and attach to the aero-train, taking off and landing along the flight route of the aero-train due to the electrical power stored in its own accumulators. In addition, extra ATNPP may be included in the aero-train during its flight, if it is necessary to increase the thrust.

At the same time, due to the use of nuclear power, such ATNPP can remain in the air for a conditionally indefinite period of time.

The result of a sophisticated computational strategy—logistics based on the NASK tool capabilities will be the improvement of the key economic indicators of air transportation.

By using the concept of a few dozen of NASKs, large airlines can develop global networks of Air Nuclear Transportation on the basis of flight cooperation. Meanwhile, the cooperation between the different airlines may eventually lead to the formation of a GENERAL GLOBAL NETWORK of such high-efficiency transportation.

### Technical and Technological Process of the Nask Aero-Train Application

At takeoff of ATNPP 1 (see FIG. 2), the over-flight Electric Grid Module (EGM) marked by position 4 is mounted in the nose of ATNPP 1, while the Towed Electric Grid Glider (TEGG) marked by position 5 is mounted in the tail of ATNPP 1. EGM 4 and TEGG 5 in terms of their controllability are designed as unmanned ones with remote control.

Takeoffs of the aircraft of the aero-train primary composition are performed sequentially according to the plan of their landings during the aero-train flight. The runways of these aircraft are located nearby the takeoff site of ATNPP 1, the takeoff of which is “synchronized” in time due to the rate-of-climb capabilities of these aircraft to a certain docking height. In this case the takeoff of ATNPP 1 to the optimal height of docking with electrically “towed” aircraft is carried out by the thrust of the air screws, driven by electric motors and by own on-board accumulators, charged from the airfield maintenance stations of electric aircraft.

At some optimal height, the taking-off aircraft and ATNPP 1 line up in a large, connecting, truncated circle, on the chord of which these aircraft connect with ATNPP 1 and between each other, thus forming an optimized aero-train, (see, for example, FIGS. 3÷5).

As taking-off aircraft begin to dock with ATNPP 1, its nuclear reactors are gradually being put into cruise modes. During these processes in ATNPP 1 smooth transitions of traction force formation of electromotive organic steam generating units are performed from electric traction to steam-turbine one, carrying out power supply to electrically towed aircraft at the same time.

The dockings of ATNPP 1 with “towed” aircraft are performed in the following way. At the height of the dockings and on the chord section of the connecting truncated circle the EGM 4 is undocked from the ATNPP 1, and due to the electromotive thrust of the air screw of this EGM 4, the Lead-in Cable 7 (LIC) is pulled out of ATNPP 1 (see FIG. 1). The power supply of EGM 4 in this case is carried out by means of LIC 7 from the ATNPP 1 on-board energy source. The length of the LIC 7 is selected based on the level of radiation safety in relation to the first over-flight aircraft 3, taking into account the presence of increased radiation protection built into the ATNPP 1. After full extraction of the LIC 7 from the ATNPP 1 by means of the docking feeder 8 and the elastic electrical cable bar 9 (ECB) the electric lines are docked by analogy with the widespread dockings with flight refueling aircraft, (see FIG. 1).

In addition, the attachment of the LIC 7 to the nose part of the ATNPP 1 is carried out by winding on a drum, the “tensioning rotation” of which is performed by means of a half-spiral spring and with an electric drive for torque effect stabilization on this drum.

To dock the first driven aircraft 2 with ATNPP 1, TEGG 5 is detached from the ATNPP and TEGG 5 draws this TEGG 10 from ATNPP 1 to a reasonable length for radiation protection reasons due to the tension of the Lead-in Cable 10 (LIC). Thus, based on the required planning speed of the TEGG 5 and on the required drawing force of the LIC 10, the geometry of the TEGG 5 glider is changed in order to correct its aerodynamic quality.

To improve controllability and increase the aerodynamic efficiency of the TEGG 5, its glider is constructed with forward-swept wings.

Once the TEGG 5 flight is stabilized by means of the docking feeder 11 and the elastic Electrical Cable Bar 12 (ECB), the aircraft 2 is docked with the TEGG 5. Then sequential dockings of the driven planes 13, 14 and following aircraft are carried out in flight along the chord of the docking truncated circle behind the aircraft 2, as shown in FIG. 3.

Simultaneously with docking of the driven aircraft 13, 14, etc. in the aero-train, a series of dockings of over-flight aircraft 15, 16 and other aircraft ahead of them is performed, as shown in FIG. 3. In this process, between electrically “towed” aircraft flexible air and Controlled Electric Lines 17 (CEL) are applied, through which energy is transmitted sequentially to all “towed” aircraft.

Once the formation of the primary series of aero-train is completed, it is lifted to the route height and accelerated in the direction of the planned flight, while ATNPP 1 nuclear reactors are maneuvered to their optimum modes. In this flight ATNPP 1 generates electrical power through one or more electric turbine-generator units that is transmitted to all electrically “towed” aircraft.

During the aero-train flight, the possible EXCESS OF MECHANICAL ENERGY on the shafts of the organic steam generating units that drive the ATNPP 1 air traction screws 76 is TRANSFERED to the electric machines 77, which are switched from motoring modes to generating ones. Such modes are implemented if the number of “electrically towed” aircraft in the aero-train is less than the maximum possible one under the energy conditions of the maneuverability of the nuclear reactors. Here it is taken into account that during the flight all aircraft of the aero-train, including ATNPP 1, recharge the onboard accumulators, which were partly discharged after takeoffs.

For reasons of radiation protection, several sequentially connected EGMs and TEGGs can be used during the aero-train flight, which are not shown in FIG. 3. Due to such a solution the distances between ATNPP 1 and the “electrically towed” aircraft can be increased.

When the aero-train approaches the aircraft sorting airfield, one or another aircraft, or airplanes according to their arrival schedule, are undocked from the aero-train and land on the traction of their own accumulators, which were charged earlier in the flight, as mentioned above.

In addition, when the aero-train approaches the aircraft sorting airfield, the scheduled takeoffs of other aircraft and their docking into the aero-train are carried out from that airfield. Therefore, the sequence of forming a “new” aero-train is optimized when planning the undocking and docking of planes by the criterion of minimum time in the air of this “new” aero-train over the next “sorting” airfield.

At the same time, undocking and docking of aircraft are performed according to a certain local estimated schedule of “sorting” airfield—a schedule of aircraft sorting dynamics, the construction of which is carried out by means of optimization with the construction of a local aero-train route with its altitudes, speeds and glides of the corresponding aircraft. If the number of sorted planes is such that a “straight line” flight of the aero-train, even at its minimum speeds, near the sorting airfield is not efficient in terms of energy consumption of the accumulators of sorted planes, then the local route of the aero-train is planned on a truncated docking circle, as mentioned above, when the primary series of aero-train takes off.

Once all scheduled aircraft undockings and dockings are completed, the aero-train is directed to the next sorting airfield, and so on.

Thus, the logistics of aero-train flights generally involves an end-to-end “preventive” planning of the traffic dynamics of all aircraft involved in one or another aero-train along its entire route. In this case, planning of the next route of the aero-train is performed during the flight along some primary-planned route or even earlier, and so on. All this is provided by continuous flight planning, and the “planning horizon” is determined and updated in time in connection with the operational receipt of requests for those or other transportations.

### INDUSTRIAL APPLICABILITY OF THE NASK INVENTION

The claimed NASK construction method can be effectively applied for air high-speed large-capacity transportation of both cargo and passengers with highly flexible logistics.

The majority of component units of NASK equipment with a high degree of technical proximity to it as well as those used for its construction according to the presented invention are either in operation in a number of countries or projects aimed at their improvement are intensively conducted. Here an example of the proximity of the technical solutions is the current refueling systems of aircraft in the air.

### FIELD OF INVENTION OF THE AIRCRAFT THRUST NUCLEAR POWER PLANT, (ATNPP)

The ATNPP invention relates to the field of aviation using traction engines and electric generators powered by nuclear heat.

The application of the ATNPP invention according to the inventive conception provides the ATNPP flight with mechanical traction energy and supplies electrical energy to the traction electric motors of the electric aircraft of the aero-train.

### BACKGROUND OF THE ATNPP INVENTION

Concerning the application of the proposed ATNPP invention, there is a poorly relevant solution for the development of an M-30 type nuclear aircraft in the USSR, [6 and 9]. It was assumed here that the aircraft would be a supersonic strategic missile bomber with a closed-cycle nuclear propulsion system.

The aircraft was designed according to the canard aerodynamic configuration with delta wings and a significant sweep canard surface. Six nuclear turbojets were intended to be positioned in the tail section of the aircraft and combined into one, or two, packages. The reactor was placed in the fuselage. A liquid metal, such as lithium or sodium, was to be used as the coolant. The engines could also be powered by JP fuel.

The closed cycle of the propulsion system allowed the crew cockpit to be ventilated with atmospheric air and enabled the mass of the radiation protection to be greatly reduced.

The usage of JP fuel in this M-30 aircraft was intended for take-off, reaching cruising speed and performing fast maneuvers, [9]. In the other flight modes, the M-30 used only the power generated by the nuclear propulsion system, [6]. Thus, this project provided a slight radioactive background from the nuclear propulsion system.

### Essential Features of the Analogue

The glider structure involves the use of more than one engine;
The presence of one nuclear reactor on an aircraft, which is the source of thermal energy used to generate thrust;
The use of a closed type propulsion system, (when no atmospheric air is blown through the nuclear reactor);
The ability to stay in the air for longer periods of time in comparison to the capabilities of aircraft using conventional JP fuels;
The application of energy generated by a nuclear reactor only for cruising flights, (when take-offs and landings of nuclear aircraft are performed by other on-board energy sources);
The application of on-board Auxiliary Power Units (APUs);
The presence of heavy radiation protection, mostly shadow protection.

### The Common Features of the Analogue with the Proposed Invention Include

The glider structure involves the use of more than one engine;
The presence of one nuclear reactor on an aircraft, which is the source of thermal energy used to generate thrust;
The use of a closed type propulsion system, (when no atmospheric air is blown through the nuclear reactor);
The ability to stay in the air for longer periods of time in comparison to the capabilities of aircraft using conventional JP fuels;
The application of energy generated by a nuclear reactor only for cruising flights, (when take-offs and landings of nuclear aircraft are performed by other on-board energy sources);
The application of on-board Auxiliary Power Units (APUs);
The presence of heavy radiation protection, mostly shadow protection.

REASONS AND FEATURES PREVENTING THE PROPOSED ATNPP FROM OBTAINING A TECHNICAL RESULT, compared to the design of the M-30 nuclear aircraft, the basics of which are described in [6 and 9]:
Relatively low aerodynamic maneuverability of the M-30 glider structure compared to the ATNPP glider, with the distinctive feature that the M-30 glider (based on the canard configuration) had a balancing loss factor;
The lower maneuverability of fuel-powered traction engines in terms of their acceleration response relative to ATNPP hybrid drives based on the mechanical power of steam turbines combined with the booster use of electric vehicles powered by on-board accumulators (by analogy with hybrid cars);
The use of one on-board nuclear reactor, as compared to the use of more than one nuclear reactor in ATNPP, increases the reliability of the power supply of ATNPP as a whole;
Due to the use of multiple nuclear reactors in ATNPP, its energy maneuverability in cruising modes is higher;
The use of totally safe nuclear reactors on molten salts of an undercritical type, driven by a proton accelerator, or neutron flux from a compact fusion reactor in ATNPP;
The use of a single proton accelerator in ATNPP for pulsed control of several on-board nuclear reactors, through proton beam deflection devices to one or the other reactor;
In flight, the ATNPP, by means of one or more electric turbine-generator units, produces electrical power which is transmitted to all electrically towed aircraft making up the aero-train;
The use of ATNPP in-flight active electrical network devices for the aero-train—electrical cables, feeders and bars ensuring in-flight transmission of electrical power to towed electric aircraft over sufficient distances in relation to their radiation safety;
Provision of recharging of the on-board accumulators, which are discharged during take-offs, from ATNPP electric power in flight for all aircraft of the aero-train;
In some cruising flight modes, the possible “excess” of mechanical energy on the shafts of the organic steam generating units that drive the ATNPP air traction screws is transferred to the electric machines, which are switched from motoring modes to generating ones, and the electrical power generated in this way is directed to the ATNPP generating electric grid;
In ATNPP, rejected heat from heat and power cycles of electric power generation is used in engineering solutions to combat icing in flight of its glider;
Application in ATNPP of unmanned control of its take-offs, flights and landings as well as maneuvering during dockings and undockings with towed electric aircraft, piloted not only by crews of towed aircraft, but also by their own autopilot and remote control from the ground;
In case of a severe incident at ATNPP, the targeted parachute and powered paraglider airdrop of nuclear reactors is applied to a relatively long horizontal distance and to optimally safe landing sites for nuclear reactors in a soft manner and, if necessary, with deployment of special systems for reactor shutdown cooling;
In cases of severe incidents at ATNPP, when the Hybrid Thermal Power Cycle (HTPC) equipment cannot ensure the flight of an emergency ATNPP to the nearest MS ATNPP due to the large flight distance, then the ATNPP glider is constructed according to a modular principle and individual modules of the ATNPP glider are mutually undocked and passively parachuted to an optimally safe location;
To drive the ATNPP on the taxiways of the airfield structure and for its positioning in the MS shelter, the ATNPP landing gear is equipped with robotic electric drives to ensure this movement.
An ATNPP option is an amphibious aircraft whose landing gear and glider design could ensure take-off and landing using not only the hard surface of the runway, but also the water surface.

From [9] the M-60M design is known, which is the predecessor of the M-30 design, described above as an analogue.

### The Essential Features of the Analogue

The glider structure involves the use of more than one engine;
The presence of nuclear reactors on the aircraft, which are the sources of thermal energy used to generate thrust;
The use of an open-type propulsion system (when atmospheric air is blown through the nuclear reactor);
The design of the M-60M glider is a hydroplane with a design that could enable it to take off from and land on the water surface.
The ability to stay in the air for longer periods of time in comparison to the capabilities of aircraft using conventional JP fuels;
The application of energy generated by a nuclear reactor only for cruising flights, (when take-offs and landings of nuclear aircraft are performed by other on-board energy sources);
Alternatively, automatic aircraft navigation, (unmanned operation);
The application of on-board Auxiliary Power Units (APUs);
The presence of significantly heavy radiation protection;

### The Common Features of the Analogue with the Proposed Invention Include

The glider structure involves the use of more than one engine;
The presence of more than one nuclear reactor on an aircraft, which is the source of thermal energy used to generate thrust;
An ATNPP option is an amphibious aircraft whose landing gear and glider design could ensure take-off and landing using not only the hard surface of the runway, but also the water surface;
The ability to stay in the air for longer periods of time in comparison to the capabilities of aircraft using conventional JP fuels;
The application of energy generated by a nuclear reactor only for cruising flights, (when take-offs and landings of nuclear aircraft are performed by other on-board energy sources);
Automatic aircraft navigation, (unmanned operation);
The application of on-board Auxiliary Power Units (APUs);
The presence of heavy radiation protection, mostly shadow protection.

REASONS AND FEATURES PREVENTING THE PROPOSED ATNPP FROM OBTAINING A TECHNICAL RESULT, compared to the design of the M-60M nuclear aircraft, the basics of which are described in [9]:
Relatively low aerodynamic maneuverability of the aircraft glider structure compared to the ATNPP glider;
The low maneuverability of traction engines in terms of their acceleration response relative to ATNPP hybrid drives based on the mechanical power of steam turbines combined with the booster use of electric vehicles powered by accumulators;
The use of one on-board nuclear reactor, as compared to the use of more than one nuclear reactor in ATNPP, that increases the reliability of the power supply of ATNPP as a whole;
Due to the use of multiple nuclear reactors in ATNPP, its energy maneuverability in cruising modes is higher;
The use of totally safe nuclear reactors on molten salts of an undercritical type, driven by a proton accelerator, or neutron flux from a compact fusion reactor in ATNPP;
The use of a single proton accelerator in ATNPP for pulsed control of several on-board nuclear reactors, through proton beam deflection devices to one or the other reactor;
In flight, the ATNPP, by means of one or more electric turbine-generator units, produces electrical power which is transmitted to all electrically towed aircraft making up the aero-train;
The use of ATNPP in-flight active electrical network devices for the aero-train—electrical cables, feeders and bars ensuring in-flight transmission of electrical power to towed electric aircraft over sufficient distances in relation to their radiation safety;
Provision of recharging of the on-board accumulators, which are discharged during take-offs, from ATNPP electric power in flight for all aircraft of the aero-train;
In some cruising flight modes, the possible “excess” of mechanical energy on the shafts of the organic steam generating units that drive the ATNPP air traction screws is transferred to the electric machines, which are switched from motoring modes to generating ones, and the electrical power generated in this way is directed to the ATNPP generating electric grid;
In ATNPP, rejected heat from heat and power cycles of electric power generation is used in engineering solutions to combat icing in flight of its glider;
In case of a severe incident at ATNPP, the targeted parachute and powered paraglider airdrop of nuclear reactors is applied to a relatively long horizontal distance and to optimally safe landing sites for nuclear reactors in a soft manner and, if necessary, with deployment of special systems for reactor shutdown cooling;
In cases of severe incidents at ATNPP, when the Hybrid Thermal Power Cycle (HTPC) equipment cannot ensure the flight of an emergency ATNPP to the nearest MS ATNPP due to the large flight distance, then the ATNPP glider is constructed according to a modular principle and individual modules of the ATNPP glider are mutually undocked and passively parachuted to an optimally safe location;
To drive the ATNPP on the taxiways of the airfield structure and for its positioning in the MS shelter, the ATNPP landing gear is equipped with robotic electric drives to ensure this movement.

Regarding the creation of the atomic aircraft the US program “Nuclear Energy for the Propulsion of Aircraft”, in force since 1946, is known from [6, 7, 12, 20]. Under this program, the American company “Convir” has constructed an experimental atomic aircraft NB-36H(X-6) Crusader, based on the B-36 aircraft, which made 47 experimental and test flights with the switched-on nuclear reactor, [6, 7].

In this aircraft, even under the previous American program “Aircraft Nuclear Propulsion” the engine with a huge air screw was developed that was driven by a steam turbine, steam for which was heated by the heat of a nuclear reactor, [6, No 3, p. 33; 12, p. 27]. The main technical solutions developed in these mentioned programs are accepted as a PROTOTYPE.

### The Essential Features of the Prototype

The glider structure involves the use of more than one engine;
The presence of a nuclear reactor on an aircraft, which is the source of thermal energy used to generate thrust;
The use of an on-board nuclear reactor on molten salts;
The use of a closed type propulsion system (when no atmospheric air is blown through the nuclear reactor);
The use of traction engines with air screws driven by steam turbines;
The ability to stay in the air for longer periods of time in comparison to the capabilities of aircraft using conventional JP fuels;
The application of energy generated by a nuclear reactor only for cruising flights, (when take-offs and landings of nuclear aircraft are performed by other on-board energy sources);
Alternatively, unmanned operation of a limited format, where the atomic aircraft could be controlled remotely by an electrical cable from a special manned aircraft/glider that could be mechanically towed behind the atomic aircraft;
The application of on-board Auxiliary Power Units (APUs);
The presence of heavy radiation protection, mostly shadow protection.

### The Common Features of the Nb-36H(X-6) Crusader Prototype with the Proposed Invention Include

The glider structure involves the use of more than one engine;
The presence of a nuclear reactor on an aircraft, which is the source of thermal energy used to generate thrust;
The use of an on-board nuclear reactor on molten salts;
The use of a closed type propulsion system (when no atmospheric air is blown through the nuclear reactor);
The use of traction engines with air screws driven by steam turbines;
The ability to stay in the air for longer periods of time in comparison to the capabilities of aircraft using conventional JP fuels;
The application of energy generated by a nuclear reactor only for cruising flights, (when take-offs and landings of nuclear aircraft are performed by other on-board energy sources);
Alternatively, unmanned operation of a limited format, where the atomic aircraft could be controlled remotely by an electrical cable from a special manned aircraft/glider that could be mechanically towed behind the atomic aircraft;
The application of on-board Auxiliary Power Units (APUs);
The presence of heavy radiation protection, mostly shadow protection.

REASONS AND FEATURES PREVENTING THE PROPOSED ATNPP FROM OBTAINING A TECHNICAL RESULT, compared to the prototype, the design of an atomic aircraft under the “Aircraft Nuclear Propulsion” and “Nuclear Energy for the Propulsion of Aircraft” programs, the concept of which is described in [6, 7, 12, 20]:
Relatively low aerodynamic maneuverability of the aircraft glider structure compared to the ATNPP glider;
The lower maneuverability of traction engines in terms of their acceleration response relative to ATNPP hybrid drives based on the mechanical power of steam turbines combined with the booster use of electric vehicles powered by on-board accumulators;
An ATNPP option is an amphibious aircraft whose landing gear and glider design could ensure take-off and landing using not only the hard surface of the runway, but also the water surface;
The use of one on-board nuclear reactor, as compared to the use of more than one nuclear reactor in ATNPP, that increases the reliability of the power supply of ATNPP as a whole;
Due to the use of multiple nuclear reactors in ATNPP, its energy maneuverability in cruising modes is higher;
The use of totally safe nuclear reactors on molten salts of an undercritical type, driven by a proton accelerator;
The use of a single proton accelerator in ATNPP for pulsed control of several on-board nuclear reactors, through proton beam deflection devices to one or the other reactor
In flight, the ATNPP, by means of one or more electric turbine-generator units, produces electrical power which is transmitted to all electrically towed aircraft making up the aero-train;
The use of ATNPP in-flight active electrical network devices for the aero-train—electrical cables, feeders and bars ensuring in-flight transmission of electrical power to towed electric aircraft over sufficient distances in relation to their radiation safety;
Provision of recharging of the on-board accumulators, which are discharged during take-offs, from ATNPP electric power in flight for all aircraft of the aero-train;
In some cruising flight modes, the possible “excess” of mechanical energy on the shafts of the organic steam generating units that drive the ATNPP air traction screws is transferred to the electric machines, which are switched from motoring modes to generating ones, and the electrical power generated in this way is directed to the ATNPP generating electric grid;
In ATNPP, rejected heat from heat and power cycles of electric power generation is used in engineering solutions to combat icing in flight of its glider;
Application in ATNPP of unmanned control of its take-offs, flights and landings as well as maneuvering during dockings and undockings with towed electric aircraft, piloted not only by crews of towed aircraft, but also by their own autopilot and remote control from the ground;
In case of a severe incident at ATNPP, the targeted parachute and powered paraglider airdrop of nuclear reactors is applied to a relatively long horizontal distance and to optimally safe landing sites for nuclear reactors in a soft manner and, if necessary, with deployment of special systems for reactor shutdown cooling;
In cases of severe incidents at ATNPP, when the Hybrid Thermal Power Cycle (HTPC) equipment cannot ensure the flight of an emergency ATNPP to the nearest MS ATNPP due to the large flight distance, then the ATNPP glider is constructed according to a modular principle and individual modules of the ATNPP glider are mutually undocked and passively parachuted to an optimally safe location;
To drive the ATNPP on the taxiways of the airfield structure and for its positioning in the MS shelter, the ATNPP landing gear is equipped with robotic electric drives to ensure this movement.

### Disclosure of the Invention in the Part of the Aircraft Thrust Nuclear Power Plant, (ATNPP)

The OBJECTIVE of the proposed ATNPP invention is to develop an efficient, almost limitlessly long-flying Nuclear Power Plant.

The objective of the ATNPP invention is to ensure an efficient electric power supply to an aero-train with electric traction aircraft, which requires technical solutions for the construction of an air mobile electrical grid of the aero-train with its selective power supply logistics for the aircraft of the aero-train. The objective of the ATNPP invention is also aimed at ensuring absolute reliability in the application of nuclear reactors on board of ATNPP and at developing engineering solutions with the best value of the ATNPP mass-dimensional indicators, which is the achievable technical result that ensures the invention.

As mentioned earlier, the ATNPP is a large aircraft the AIRFRAME of which must have a large carrying capacity providing for the presence on board of one or more nuclear reactors, several turbines such as water steam and organic steam turbines with their power engineering dressing and electrical generators, as well as several electrical machines providing the thrust of the air screws of the ATNPP itself. In addition, power accumulators are installed on board of the ATNPP, which provide the ATNPP takeoffs and landings, as well as the radiation protection is set up.

In cases of severe incidents at ATNPP, when the Hybrid Thermal Power Cycle (HTPC) equipment cannot ensure the flight of an emergency ATNPP to the nearest MS ATNPP due to the large flight distance, then the ATNPP glider is constructed according to a modular principle and individual modules of the ATNPP glider are mutually undocked and passively parachuted to an optimally safe location by some analogy to the solutions represented in [21, 22, 23, 24, 25, 26, 27, 28, 29, 30].

The design placement of the reactor units on board of the ATNPP is assumed to be in vibration insulation supporting nodes, similar to solutions on nuclear-powered fleets, as in the invention [31].

The ATNPP also contains EXTERNAL ACTIVITY ELEMENTS: Over-flight Electric Grid Module 4 (EGM) and Towed Electric Grid Glider 5 (TEGG), (see FIG. 2).

To provide the increased maneuverability of the ATNPP and to reduce the wing span, one of the variants of its glider design uses the scheme of semi-sequential biplane, which is implemented through the use of forward and reverse swept wings (see FIG. 1.). In this regard, the interference of the wings is minimized, increasing the aerodynamic efficiency of the ATNPP glider.

In this case, the front wing is positioned at the bottom so that the rear wing is away from the jet from the front wing and, with proper selection of the distance between the upper and lower wings, their efficiency can be increased due to the possible effect of the slotted flap.

In this regard, the relatively enhanced maneuverability of the ATNPP makes the engineering performance of its unmanned operation easier. This, in turn, excludes the presence of people on board of the ATNPP for radiation safety reasons.

An ATNPP option is an amphibious aircraft whose landing gear and glider design could ensure take-off and landing using not only the hard surface of the runway, but also the water surface.

To drive the ATNPP on the taxiways of the airfield structure and for its positioning in the MS shelter, the ATNPP landing gear is equipped with robotic electric drives to ensure this movement.

In the version of ATNPP glider design as an amphibious aircraft, its movement is performed along the seaway of the airfield structure for positioning to and from the MS dock/hangar, ATNPP is equipped with an integrated unmanned pilot navigation system for its interactive collaboration when towing ATNPP by robotic sea tugs.

In the past, from 1946 to 1956, the US and the USSR had already had atomic bomber designs which were not fully realized due to the successful construction of nuclear submarines and missile armaments, including air-defense capabilities. Thus, the American company “Convir” has constructed an experimental atomic aircraft NB-36H(X-6) Crusader, based on the B-36 aircraft, which made 47 experimental and test flights with the switched-on nuclear reactor, [6, 7].

In 1946, the US Air Force program “Nuclear Energy for the Propulsion of Aircraft” initiated solving the following issues, [6]:
How to transfer heat from a nuclear reactor to engines?
How to cool the reactor in flight and manage its power?
How to protect yourself effectively from radiation? Not only was it destructive to humans, but it also reduced the strength of the aircraft structural materials, destroyed lubricants and damaged electronic equipment.

The same problematic issues were also being raised and solved in the USSR. The number of technical problems that seemed almost impossible to solve made it very difficult to build a nuclear aircraft in the future. However, the next work program “Aircraft Nuclear Propulsion” in the USA actually made it possible to get closer to constructing a nuclear aircraft.

In the USSR it was also planned, [6, 7]:
To research the effects of neutron and gamma radiation on the structural materials of the aircraft and its thrust propulsion system;
To determine the parameters for protection of the crew against radiation in flight and of the maintenance personnel on the ground;
To consider the consequences of possible emergency situations.

Experimental studies of the problems related to the construction of a nuclear aircraft and their successful solutions in the USSR based on experimental ground-based simulators and flying laboratories, the TU-95LAL (34 flights) and the TU-119, have also allowed us to form the opinion on the PRACTICAL POSSIBILITY of a nuclear aircraft [6, 8, 20]. Designs of such aircraft were also under consideration, such as the M-60, M-60M, [9] and TU-120, [6, 20] with open-circuit nuclear propulsion systems—where the atmospheric air passed directly through the reactor, being subjected to strong radiation poisoning. In this regard, a design of the M-30 aircraft with a “closed type” nuclear propulsion system, with a double-circuit reactor, was promoted and this M-30 aircraft was supposed to use JP fuel on take-off, reaching cruising speed and performing fast maneuvers, [9]. In the other flight modes, the M-30 used only the energy generated by the nuclear propulsion system, [6]. This design produced a slight radioactive background from the nuclear propulsion system.

The PRACTICAL CONSTRUCTION OF NASK APPEARS TO BE FEASIBLE AND POSSIBLE in view of the extensive and positive scientific and technological groundwork on construction of nuclear aircraft and the fact that there is no cargo onboard the ATNPP that provides enhanced radiation protection and due to the absence of people on board as well as the remoteness of aero-train aircraft from ATNPP.

A significant and distinctive difference between ATNPP and previous nuclear aircraft designs is that here the “propulsion function” is realized by means of air screws with turbine generators, rather than the conventional turbojet schemes and even less so by the scheme of ramjets. Here, the electric power of the entire NASK is also provided by the onboard nuclear power plant of the towing aircraft—ATNPP.

At the same time, the thermal power scheme of ATNPP differs significantly from the conventional schemes of NPPs due to the specific external conditions of the flight type. Namely, original air condensers are used here, and the thermal power scheme as a whole is represented by a hybrid combined cycle of the steam-water and organic-vapor parts.

At ATNPP, the issues of de-icing the airframe structure are also solved in the untypical way—by using the rejected heat from the thermal power cycles of the power generation.

However, as a ‘propulsion function’ option, turbojet engines without air screws could be used in ATNPPs, if there is a cryogenic air-liquefying unit on board, as proposed in [32] for a nuclear-powered aerospace aircraft. The efficiency of this solution is based on the fact that the evaporative expansion of liquid air is about 700 times, when heated, for example, by free-air temperatures of minus 35, minus 45 degrees Celsius, which is typical for a NASK cruising altitude.

Here it is obvious that heating the air by the heat of the ATNPP's nuclear on-board reactors to high temperatures will provide an even greater coefficient of air expansion, increasing the efficiency of the “propulsion function”.

In this version of the “propulsion function”, it is also possible for the ATNPP itself to use the expansion of liquid air to generate grid-wide NASK power and, in addition, the liquid air can be used as a source of mechanical energy for the ATNPP take-offs and landings.

The many years of operating compact nuclear reactors in submarine fleets, [33] represent a major and positive scientific and technological groundwork in terms of heat generation on board of the NASK towing aircraft—ATNPP.

Obviously, in terms of the types of nuclear reactors used in ATNPP, new solutions will be chosen carefully, mostly driven by safety. As the world's nuclear technology continues to improve and the intensity of this improvement has increased after known large accidents in nuclear power plants in various countries, some promising solutions that are being developed, including passive systems of inherent safety, could be applied in the ATNPP. The significance of the latter is difficult to be underestimated. For example, the passive safety systems of even large and powerful Generation III+ reactors such as the AP1000 and AP1400 can provide safety for at least three days without power supply, or human intervention, [34].

ATNPP is likely to use, for example, reactors on molten salt, the history of which dates back to the late 1940s. Until the late 1960s, attempts to improve such reactors remained ongoing, given their compact size, as power sources for aircraft. The first operating reactor was completed in 1954, and the USA even managed to equip the B-36 bomber with it [35, 36]. Such reactors can also be uranium-thorium ones, with all their inherent benefits, [37].

Fast reactors with lead [38] or lead-bismuth coolant having a number of advantages are also likely to be used in ATNPP. These reactors also have a high level of internal self-protection and passive safety while being relatively simple in design and small in size, [33, 39].

In general, the task of constructing flying nuclear reactors will be performed by the appropriate specialists and it is not advisable to describe their technology in detail in the present invention. However, when choosing the reactor type for ATNPP, specific emphasis is likely to be placed on undercritical reactors, which have unprecedented safety features. By definition, the safety of such reactors is based on their deep subcriticality: 0.36 to 0.4 [40]. Here, in probably the best solutions [41, 42], the nuclear energy heat generation is carried out due to the fact that the accelerator carries out the nuclear cascade excitation with relativistic beam of protons directed “from external environment” to the ablative target for neutron production that is the reactor fuel core, see also [40, 43, 44, 45, 46, 47, 48] and as soon as the accelerator is switched off, the nuclear reaction is stopped immediately. And since the fuel substances do not form a critical mass, there is no need for traditional control and protection systems, [41].

For on-board reactors, accelerators in which the accelerating structures are linked together by magnetic assemblies of proton beams rotating at angles of less than 180 degrees can be used here [44, 49], these are also backward wave accelerators, [50].

The compactness of such accelerators (without optimization for aircraft applications) is estimated in [43] as 60×18×4 meters, in [40] as 60×24×6 meters. For example, a 1 GeV proton accelerator is the most compact: it can be placed, (also without optimization for aircraft applications) in the area of 50×8 square meters, while a 10 GeV accelerator in an area of 60×15 m, [50]. In addition, in [48] there are data on cyclotron proton accelerators with power up to 900 MeV placed on a site of 15×35 square meters, and including a site of 15×15 square meters with an intermediate stage of 120 MeV.

In this regard, the idea of installing accelerators on the aircraft has already been mentioned in [51].

There are also designs of undercritical nuclear reactors on molten salts. In this case, the molten salt can also serve as a target for the accelerator-driver that solves the problem of the fuel target strength and its burn-up uniformity [37, 47, 52].

Decisions on the use of a particular reactor type in ATNPP will take into account its maneuverability along with a number of criteria. Solutions are already appearing to increase the maneuverability of nuclear reactor thermal power, e.g., in [53, 54].

When selecting the reactor type for the ATNPP, special emphasis is also likely to be given to HYBRID UNDERCRITICAL REACTORS, [52, 55, 56, 57, 58, 59, 60].

In such reactors the nuclear energy heat is generated due to excitation of nuclear cascade fission processes in the fuel by means of neutrons of very high power up to 14.1 MeV, directed from “external environment” into the fuel reactor core from Thermonuclear Neutron Sources (TNS) [55, 56, 57, 61, 62], as a result of deuterium-tritium fusion reactions, implemented in the well-known thermonuclear reactors, mainly in the so-called TOKAMAKS.

Regarding the possible application of hybrid undercritical reactors in ATNPP, it is worth mentioning the resolution of one of the most important problems of fusion reactors, such as the TNS to control, for example, a molten salt fission reactor. This reference is relevant to the proposed invention because of the high probability of future applications for hybrid undercritical reactors due to the currently visible prospects for TNS. As a result of the “modern imperfection” of plasma confinement by magnetic fields, plasma particles in tokamaks interact with the structural materials of the vacuum chambers of tokamaks and some atoms from the inner surfaces of the chambers pass into plasma, polluting it, get ionized and increase losses with braking radiation. The flow of particles onto the structural elements of the vacuum chamber is reduced by the use of special plasma neutralization devices—DIVERTORS. Thus, the flow of charged particles running into the inner surface of the tokamak vacuum chamber is diverted by a special magnetic force line of a specific configuration called a separatrix into the divertor chamber and deposited on the contact surfaces of the DIVERTOR, [63]. The DIVERTOR also performs the task of cleaning the plasma from contaminants that interfere with the fusion reaction. The DIVERTOR is the most heat-stressed element in the tokamak's structure. And the problems of tokamaks are now predominantly found in the DIVERTOR. Part of the plasma flows into it, from where the closed magnetic surface lines change into open lines, [64]. The specific heat loads here can reach 10÷20/sqm. The plasma entering the diverter will be cooled and neutralized, and sucked out by cryogenic pumps, to remove the produced helium and impurities from the plasma, to maintain its constant composition, [64].

An efficient application of the American invention, [65, 66, 67] the “Super-X” DIVERTOR, is likely to be assumed. The magnetic geometry of this invention significantly improves reradiation and energy loss, [68]. With the “Super-X” DIVERTOR, the exhaust stream is expanded and cooled to reach acceptable temperatures and heat flux, [58]. Thus the “Super-X” DIVERTOR is 5 times superior to its analogues in its ability to “process” the strong energy flows from the “core” of the fusion reactor without destroying itself! [56].

New solutions are being developed in relation to DIVERTORS, e.g. [69, 70].

The applicability of the hybrid reactor in the ATNPP, e.g. on molten salts of uranium 238, or thorium 232 is determined by the compactness of the TNS that is estimated to have a plasma radius of 1500÷2000 mm, [60] or just 400÷1400 mm, [59, 71] and 360÷240 mm according to data from [61].

Another important problem for TNS is plasma confinement time, i.e. the ‘pulse’ time of its operation to control the fission reactor for thermal power generation in ATNPP. Efficient solutions have already been worked out here. For example, the calculated time is 453 seconds, [60]. Experimental time is 70 seconds, [72] and 1000 seconds! [73].

Concerning tritium that is the most expensive part of the fuel in TNS, it seems to be already a “solved” problem by now. For example, to reproduce tritium burned out in a fusion reactor, an “active” blanket breeder containing lithium isotope components is used [74, 75].

Another apparently solvable problem of tokamaks is the protection of the vacuum chamber walls from the effects of high-temperature plasma, which is solved by so-called LIMITERS.

Existing structural materials of LIMITER, such as tungsten, beryllium, and graphite have significant disadvantages. And here the unique properties of lithium provide an already existing basis for solving the problem of tokamak wall protection, [76, 77, 78, 79]. At the same time it is also important that lithium is used, as mentioned above, as a tritium-producing material and as an efficient coolant.

It is also possible that hybrid ATNPP reactors may apply solutions for heating up the TNS plasma by means of laser technology. Some solutions are also available here, such as those shown in [80, 81, 82, 83].

According to the inventive conception, to ensure the RELIABILITY of ATNPP ENERGY SUPPLY, it is assumed that in addition to accumulators, auxiliary power units (APUs), traditionally applied in modern aviation with JP fuel, will also be used on board of the ATNPP. However, ATNPPs would use the heat from nuclear reactors for APUs. And the APUs themselves could be designed on steam turbines, or Stirling engines, or even Rayleigh engines.

In addition, the reactors will be equipped with battery breakers and their own mini-APUs for reactor shutdown cooling.

The importance of ensuring on-board power reliability can be seen in the case of submarines such as Project 627 implemented in the USSR, where an auxiliary power unit was applied along with electric accumulators, [84]. Here, the diesel driven generator was auxiliary and designed for small surface running and maneuvering when mooring, as well as for starting the steam power plant and for reactor shutdown cooling when the steam power plant was taken out of action. Here, in nuclear-powered submarine of project 627 (USSR), the accumulator provided power supply to consumers during steam-power plant start-up, reactor shut-down cooling during taking the steam-power plant out of operation, and could be used to run two electric propulsion motors at 15% of their capacity, [84].

Moreover, the USSR boat of the 651E Project used the heat of a nuclear reactor for its APU, [85, 86]. Here, the TVP-4 boiling-type reactor with a heat output of 5 MW was used in the small nuclear power plant ANPU-6, while the production of electrical power reached the high value of 600 kW. In this case the APU-6 was constructed in a cylindrical casing with a diameter of 2.9 m, a length of 6.5 m and a weight of 70 tonnes, including this own casing with radiation protection.

In case of a severe incident at ATNPP, the targeted parachute and powered paraglider airdrop of nuclear reactors is applied to a relatively long horizontal distance and to optimally safe landing sites for nuclear reactors in a soft manner and, if necessary, with deployment of special systems for reactor shutdown cooling.

### The Essential Features Required to Achieve the Technical Result of the Proposed Invention

Several engines are used in the ATNPP glider construction;
The ATNPP glider is constructed according to a modular principle and individual modules of the ATNPP glider can be passively targeted and parachuted in cases of severe incidents;
The presence of nuclear reactors on board of the ATNPP which are sources of thermal energy used to generate thrust for its engines and to supply power to the mobile electrical grid of the aero-train;
The use of a closed type propulsion system, (when no atmospheric air is blown through the nuclear reactor);
The use of traction engines with air screws driven by steam turbines, for instance on organic substances;
The ability to stay in the air for longer periods of time in comparison to the capabilities of aircraft using conventional JP fuels;
The application of energy generated by a nuclear reactor only for cruising flights, (when take-offs and landings of ATNPP are performed by on-board energy sources—electrical ones or, alternatively, ones based on liquid air);
The presence of heavy radiation protection, mostly shadow protection;
The use of more than one on-board nuclear reactor in ATNPP increases the reliability of the power supply of ATNPP as a whole;
The use of totally safe nuclear reactors on molten salts of an undercritical type in ATNPP—hybrid controlled TNS and, alternatively, ones driven by a proton accelerator;
The use of ATNPP in-flight active electrical network devices for the aero-train—electrical cables, feeders and bars ensuring in-flight transmission of electrical power to towed electric aircraft over sufficient distances in relation to their radiation safety;
Provision of recharging of the on-board accumulators, which are discharged during take-offs, from ATNPP electric power in flight for all aircraft of the aero-train;
Application in ATNPP of unmanned control of its take-offs, flights and landings as well as maneuvering during dockings and undockings with towed electric aircraft, piloted not only by crews of towed aircraft, but also by their own autopilot and remote control from the ground;
In case of a severe incident at ATNPP, the targeted parachute and powered paraglider airdrop of nuclear reactors is applied to a relatively long horizontal distance and to optimally safe landing sites for nuclear reactors in a soft manner and, if necessary, with deployment of special systems for reactor shutdown cooling that can be carried out on battery power.

### All the Essential Features Providing the Proposed Invention

Several engines are used in the ATNPP glider construction;
The ATNPP glider is constructed according to a modular principle and individual modules of the ATNPP glider can be passively targeted and parachuted in cases of severe incidents;
The presence of nuclear reactors on board of the ATNPP which are sources of thermal energy used to generate thrust for its engines and to supply power to the mobile electrical grid of the aero-train;
The use of on-board nuclear reactors on molten salts;
The use of a closed type propulsion system, (when no atmospheric air is blown through the nuclear reactor);
The use of traction engines with air screws driven by steam turbines, for instance on organic substances;
The ability to stay in the air for longer periods of time in comparison to the capabilities of aircraft using conventional JP fuels;
The application of energy generated by a nuclear reactor only for cruising flights, (when take-offs and landings of ATNPP are performed by on-board energy sources—electrical ones or, alternatively, ones based on liquid air);
The application of on-board Auxiliary Power Units (APUs);
The presence of heavy radiation protection, mostly shadow protection;
Relatively high aerodynamic maneuverability of the ATNPP glider structure;
The high maneuverability of ATNPP traction engines in terms of their acceleration response relative to ATNPP hybrid drives based on the mechanical power of steam turbines combined with the booster use of electric vehicles powered by on-board accumulators;
The use of more than one on-board nuclear reactor in ATNPP increases the reliability of the power supply of ATNPP as a whole;
Due to the use of multiple nuclear reactors in ATNPP, its energy maneuverability in cruising modes is higher;
The use of totally safe nuclear reactors on molten salts of an undercritical type in ATNPP—hybrid controlled TNS and, alternatively, ones driven by a proton accelerator;
The use of a single proton accelerator in ATNPP for pulsed control of several on-board nuclear reactors, through proton beam deflection devices to one or the other reactor;
In flight, the ATNPP, by means of one or more electric turbine-generator units, produces electrical power which is transmitted to all electrically towed aircraft making up the aero-train;
The use of ATNPP in-flight active electrical network devices for the aero-train—electrical cables, feeders and bars ensuring in-flight transmission of electrical power to towed electric aircraft over sufficient distances in relation to their radiation safety;
Provision of recharging of the on-board accumulators, which are discharged during take-offs, from ATNPP electric power in flight for all aircraft of the aero-train;
In some cruising flight modes, the possible excess of mechanical energy on the shafts of the organic steam generating units that drive the ATNPP air traction screws is transferred to the electric machines, which are switched from motoring modes to generating ones, and the electrical power generated in this way is directed to the ATNPP generating electric grid;
In ATNPP, rejected heat from heat and power cycles of electric power generation is used in engineering solutions to combat icing in flight of its glider;
Application in ATNPP of unmanned control of its take-offs, flights and landings as well as maneuvering during dockings and undockings with towed electric aircraft, piloted not only by crews of towed aircraft, but also by their own autopilot and remote control from the ground;
In case of a severe incident at ATNPP, the targeted parachute and powered paraglider airdrop of nuclear reactors is applied to a relatively long horizontal distance and to optimally safe landing sites for nuclear reactors in a soft manner and, if necessary, with deployment of special systems for reactor shutdown cooling that can be carried out on battery power;
To drive the ATNPP on the taxiways of the airfield structure and for its positioning in the MS shelter, the ATNPP landing gear is equipped with robotic electric drives to ensure this movement;
In the version of ATNPP glider design as an amphibious aircraft, its movement is performed along the seaway of the airfield structure for positioning to and from the MS dock/hangar, ATNPP is equipped with an integrated unmanned pilot navigation system for its interactive collaboration when towing ATNPP by robotic sea tugs.

### The Essential Features of the Proposed Invention Distinctive from Those of the Prototype

Increased aerodynamic maneuverability of the ATNPP glider structure compared to the PROTOTYPE glider designed with the canard configuration having a balancing loss factor;
The ATNPP glider is constructed according to a modular principle and individual modules of the ATNPP glider can be passively targeted and parachuted in cases of severe incidents;
The high maneuverability of ATNPP traction engines in terms of their acceleration response relative to ATNPP hybrid drives based on the mechanical power of steam turbines combined with the booster use of electric vehicles powered by on-board accumulators;
The use of more than one on-board nuclear reactor in ATNPP increases the reliability of the power supply of ATNPP as a whole;
Due to the use of multiple nuclear reactors in ATNPP, its energy maneuverability in cruising modes is higher;
The use of totally safe nuclear reactors on molten salts of an undercritical type in ATNPP driven by a proton accelerator;
The use of a single proton accelerator in ATNPP for pulsed control of several on-board nuclear reactors, through proton beam deflection devices to one or the other reactor;
In flight, the ATNPP, by means of one or more electric turbine-generator units, produces electrical power which is transmitted to all electrically towed aircraft making up the aero-train;
The use of ATNPP in-flight active electrical network devices for the aero-train—electrical cables, feeders and bars ensuring in-flight transmission of electrical power to towed electric aircraft over sufficient distances in relation to their radiation safety;
Provision of recharging of the on-board accumulators, which are discharged during take-offs, from ATNPP electric power in flight for all aircraft of the aero-train;
In some cruising flight modes, the possible excess of mechanical energy on the shafts of the organic steam generating units that drive the ATNPP air traction screws is transferred to the electric machines, which are switched from motoring modes to generating ones, and the electrical power generated in this way is directed to the ATNPP generating electric grid;
In ATNPP, rejected heat from heat and power cycles of electric power generation is used in engineering solutions to combat icing in flight of its glider;
Application in ATNPP of unmanned control of its take-offs, flights and landings as well as maneuvering during dockings and undockings with towed electric aircraft, piloted not only by crews of towed aircraft, but also by their own autopilot and remote control from the ground;
In case of a severe incident at ATNPP, the targeted parachute and powered paraglider airdrop of nuclear reactors is applied to a relatively long horizontal distance and to optimally safe landing sites for nuclear reactors in a soft manner and, if necessary, with deployment of special systems for reactor shutdown cooling;
To drive the ATNPP on the taxiways of the airfield structure and for its positioning in the MS shelter, the ATNPP landing gear is equipped with robotic electric drives to ensure this movement;
In the version of ATNPP glider design as an amphibious aircraft, its movement is performed along the seaway of the airfield structure for positioning to and from the MS dock/hangar, ATNPP is equipped with an integrated unmanned pilot navigation system for its interactive collaboration when towing ATNPP by robotic sea tugs.

BRIEF DESCRIPTION OF THE DRAWINGS illustrating an enlarged version of the ATNPP GLIDER CONFIGURATION and its active/in-flight state and its passive state during take-offs and landings.

FIGS. 1 and 2 show the general appearance of the ATNPP 1 configuration. These figures show how its glider is designed according to the scheme of semi-sequential biplane.

FIG. 1 shows in-flight fragment of NASK illustrating active state of its elements supplying electric power to electrically towed aircraft with their electric traction—cargo/transport and passenger airliners, marked by positions 2 and 3. It also shows one of the possible general design configurations of the ATNPP 1 glider in flight.

FIG. 2 illustrates the ATNPP 1 on takeoff and landing, when using the thrust for its glider by the air screws driven by electric machines from the own ATNPP 1 accumulators. The elements of the NASK power supply in the passive condition are also shown here.

### Embodiment of the Invention—Aircraft Thrust Nuclear Power Plant

FIG. 1 and FIG. 2 show the general appearance of ATNPP 1. Its glider is designed according to the scheme of a semi-sequential biplane and as mentioned before, the ATNPP is a large aircraft the GLIDER of which must have a large carrying capacity providing for the presence on board of one or more nuclear reactors, several water steam and organic steam turbines with their power engineering dressing and electrical generators, as well as several electrical machines providing the thrust of the air screws of the ATNPP itself. In addition, power accumulators are installed on board of the ATNPP, which provide the ATNPP takeoffs and landings, as well as the radiation protection is set up. The design placement of the reactor units on board of the ATNPP is assumed to be in vibration insulation supporting nodes. The ATNPP also contains EXTERNAL ACTIVITY ELEMENTS: Over-flight Electric Grid Module 4 (EGM) and Towed Electric Grid Glider 5 (TEGG), (see FIG. 2).

To provide the increased maneuverability of the ATNPP and to reduce the wing span, the scheme of semi-sequential biplane is used, which is implemented through the use of forward and reverse swept wings (see FIG. 1.). In this regard, the interference of the wings is minimized, increasing the aerodynamic efficiency of the ATNPP glider. In this case, the front wing is positioned at the bottom so that the rear wing is away from the jet from the front wing and, with proper selection of the distance between the upper and lower wings, their efficiency can be increased due to the possible effect of the slotted flap.

In this regard, the relatively enhanced maneuverability of the ATNPP makes the engineering performance of its unmanned operation easier. To drive the ATNPP on the taxiways of the airfield structure and for its positioning in the MS shelter, the ATNPP landing gear is equipped with robotic electric drives to ensure this movement.

The PRACTICAL CONSTRUCTION OF NASK APPEARS TO BE FEASIBLE AND POSSIBLE in view of the extensive and positive scientific and technological groundwork on construction of nuclear aircraft and the fact that there is no cargo onboard the ATNPP that provides enhanced radiation protection and due to the absence of people on board as well as the remoteness of aero-train aircraft from ATNPP.

In the ATNPP, the “propulsion function” is realized by means of air screws with turbine generators, rather than the conventional turbojet schemes. Here, the electric power of the ATNPP and entire NASK is provided by the onboard nuclear power plant. At the same time, the thermal power scheme of ATNPP differs significantly from the conventional schemes of NPPs due to the specific external conditions of the flight type. Namely, original air condensers with extreme subcooling effect are used here, and the thermal power scheme as a whole is represented by a hybrid combined cycle of the steam-water and organic-vapor parts.

In ATNPP, rejected heat from heat and power cycles of electric power generation is used to combat icing in flight of its glider.

As for the types of nuclear reactors used in ATNPP, the undercritical reactors on molten salts having unprecedented safety features are likely to be applied. By definition, the safety of such reactors is based on their deep subcriticality: 0.36 to 0.4. Here, the nuclear energy heat generation is conducted due to the fact that the accelerator carries out the nuclear cascade excitation with relativistic beam of protons directed from accelerator to the ablative target for neutron production that is the reactor fuel core, and as soon as the accelerator is switched off, the nuclear reaction is stopped immediately. And since the fuel substances do not form a critical mass, there is no need for traditional control and protection systems.

For on-board reactors, accelerators in which the accelerating structures are linked together by magnetic assemblies of proton beams rotating at angles of less than 180 degrees can be used here, these are also backward wave accelerators. The compactness of such accelerators (without optimization for aircraft applications) is estimated in dimensions 60×18×4 meters with areas of 50×8 sq. m, 60×15 sq. m, 15×35 sq. m and 15×15 sq. m.

When selecting the reactor type for the ATNPP, special emphasis is also likely to be given to HYBRID UNDERCRITICAL REACTORS, (see FIG. 8). In such reactors the nuclear energy heat is generated due to excitation of nuclear cascade fission processes in the fuel by means of neutrons of very high power up to 14.1 MeV, directed from the plasma source of deuterium-tritium fusion, based on the compact “TOKAMAK” into the fuel reactor core.

The applicability of the hybrid reactor in the ATNPP, e.g. on molten salts of uranium 238, or thorium 232 is determined by the compactness of the TNS that is estimated to have a plasma radius of just 400÷1400 mm, or even 360÷240 mm.

Another important problem for TNS is plasma confinement time, i.e., the “pulse” time of its operation to control the fission reactor for thermal power generation in ATNPP. Efficient solutions have already been worked out here. For example, the experimental time is 70 seconds, and even 1000 seconds!

Due to the limitations of the plasma confinement time in the TNS, two hybrid nuclear reactors with TNS are used on board of the ATNPP and, because of their alternate operation a continuous supply of thermal energy to the ATNPP Hybrid Thermal Power Cycle is ensured to generate mechanical and electrical energy.

Concerning tritium that is the most expensive part of the fuel in TNS, it seems to be already a “solved” problem by now. For example, to reproduce tritium burned out in a fusion reactor, an “active” blanket breeder containing lithium isotope components is used.

According to the inventive conception, to ensure the RELIABILITY of ATNPP ENERGY SUPPLY, it is assumed that in addition to accumulators, auxiliary power units (APUs), traditionally applied in modern aviation with JP fuel, will also be used on board of the ATNPP. However, ATNPP would use the heat from nuclear reactors for APUs. And the APUs themselves could be designed on steam turbines, or Stirling engines, or even Rayleigh engines.

In addition, the reactors will be equipped with battery breakers and their own mini-APUs for reactor shutdown cooling.

FIGS. 1 and 2 show:
at position 1—ATNPP itself;
at position 2—aircraft, cargo/transport aircraft with electric traction;
at position 3—aircraft, passenger airliner with electric traction;
at position 4—over-flight Electric Grid Module (EGM);
at position 5—Towed Electric Grid Glider (TEGG);
at positions 7 and 10—Lead-in Cables (LIC);
at positions 8 and 11—Split Feeders (SF);
at positions 9 and 12—Electrical Cable Bars (ECB);
at positions 21 and 25—confusors of vortex units for mass-temperature stratification of incoming airflow;
at positions 22 and 72—vortex units for mass-temperature stratification of incoming airflow;
at positions 23 and 24—Undercritical Nuclear Reactors;
at position 76—ATNPP traction air screws;
at position 183—block of take-off and booster and planned-landing accumulators;
at position 186—turbine-generator units of ATNPP air screws in power cycles of organic turbines.

In case of a severe incident at ATNPP, the targeted parachute and powered paraglider airdrop of nuclear reactors 23 and 24 is applied to a relatively long horizontal distance and to optimally safe landing sites for nuclear reactors in a soft manner and with deployment of special systems for reactor shutdown cooling.

### INDUSTRIAL APPLICABILITY OF THE ATNPP INVENTION

The claimed ATNPP construction method can be effectively applied for air high-speed large-capacity transportation of both cargo and passengers with highly flexible logistics in application in terms of NASK.

The majority of component units of ATNPP equipment with a high degree of technical proximity to it as well as those used for its construction according to the presented invention are either in successful experimental operation in a number of countries or projects aimed at their improvement are intensively conducted. The following non-complete list of references to sources of information is therefore provided: [6, 7, 8, 9, 12, 20, 32, 33, 35, 37, 39, 40, 41, 42, 43, 44, 45, 46, 47, 48, 49, 50, 52, 53, 54, 55, 56, 57, 58, 59, 60, 61, 62, 72, 73, 84, 85, 86, 87].

### FIELD OF INVENTION OF THE HYBRID THERMAL POWER CYCLE OF ATNPP (HTPC ATNPP

The HTPC ATNPP invention relates to the field of mechanical power generation technologies and further to electricity generation based on thermal power generated from nuclear reactors.

The APPLICATION of the HTPC ATNPP invention is conducted on board of the ATNPP according to the inventive conception to supply the traction power to ATNPP itself and electric aircraft of the aero-train in flight.

### BACKGROUND OF THE INVENTION RELATING TO THE HTPC ATNPP TECHNOLOGY

In terms of the application of the proposed invention of the HYBRID THERMAL POWER CYCLE OF ATNPP, (HTPC ATNPP), the invention is known, [89]. This invention presents a method of power generation in which the equipment operates in a binary cycle. This power generation system involves the use of three media:
The first medium is the one that transfers thermal energy from the heat source to the power generation system in a binary cycle;
The second medium, or a so-called intermediate medium, is heated by the first medium and is used in the first circuit of the binary cycle, where power is generated by a steam turbine and the first electric generator;
The third medium is an organic substance with a low boiling point of its fluid. This third medium is also the working medium used in the second circuit of the binary cycle, where power is generated by an organic turbine and a second electric generator.

From the intermediate medium vapor exhausted in the steam turbine, part of the rejected heat is recovered via the Rankine cycle in the following way. The vapors, with some energy withdrawn by the intermediate heat exchanger, are directed to the condenser of the first circuit of the binary cycle, which is also the evaporator of the organic fluid of the second circuit of the binary cycle—condenser/evaporator. Here these vapors are condensed and the condensate pump directs the intermediate medium fluid to the intermediate medium heat exchanger, where it is regenerated by the exhausted intermediate medium vapors. Here, the rejected heat of the exhaust vapors, with some energy withdrawn by the intermediate medium heat exchanger, is utilized in the condenser/evaporator. This causes the organic fluid to vaporize, so that its vapors are then processed by the organic turbine and the energy is generated, which in turn generates electrical power in the second power generator.

Part of the rejected heat of the first circuit of the binary cycle, by means of the FIRST PART of the INTERMEDIATE medium FLUID, after its condensation and its regenerative heating, is used for additional heating of the organic medium fluid, after its regenerative heating in its own second circuit of the binary cycle. Then, after giving up thermal energy, this FIRST PART of the intermediate medium fluid is directed to be evaporated from the heat source, by the heat from the first medium.

The SECOND part of the fluid medium, once condensed, is also directed to be evaporated from the heat source, by the heat of the first medium.

After regenerative heating of the organic medium in the second circuit of the binary cycle, this medium is condensed at the air condenser and the rejected heat is discharged to the external environment.

The working medium of the heat source that has given up thermal energy to the binary cycle is discharged from the cycle.

In the proposed binary cycle system, the intermediate medium can be water, or another fluid—preferably a synthetic alkylated aromatic coolant.

### The Common Features with the Proposed Invention Include

Construction of power generation systems on a binary cycle;
Application of three fluid media: a heat source medium and two different binary cycle media;
Part of the heat in the first circuit of the binary cycle is recovered via the Rankine cycle;
The rejected heat from the first circuit of the binary cycle is utilized for evaporation of the organic medium in the second circuit of the binary cycle;
In the second circuit of the binary cycle, the rejected heat is discharged to the external environment by an air condenser;
The rest of the thermal energy in the heat source working medium, after its utilization in a binary cycle, is removed from the cycle.

REASONS AND FEATURES PREVENTING THE PROPOSED INVENTION FROM OBTAINING A TECHNICAL RESULT, compared to the invention, described in [89]:
The equipment supporting the operation of the HTPC ATNPP, including nuclear reactors, is placed on board of the flying ATNPP glider;
Depending on the current maneuverability parameters, the thermal energy rejected from the first circuit of the binary cycle may not only be utilized in the second circuit of this cycle, but also partly discharged into the environment;
More than one undercritical hybrid nuclear reactor, or accelerator-driven undercritical nuclear reactors, is used as the primary source of thermal energy in the HTPC ATNPP;
The HTPC ATNPP is designed as a binary one with several and parallel working second circuits with low-boiling fluids;
The transmission of thermal energy to the HTPC ATNPP from the nuclear reactors is carried out both continuously and in an alternate mode;
In order to ensure the maneuverability of power generation in the HTPC ATNPP, the pulse ratio and duration of reactor operation are controlled with periods that ensure the maintenance of reasonable temperatures of the coolant transferring energy to the STC and to the OTC;
A thermal flywheel energy storage unit is used to smooth out pulses of supplying thermal energy to the STC and the OTC;
Thermal energy from the primary sources of the HTPC ATNPP is transferred both to the first binary cycle circuit, the STC, and in parallel to the second binary cycle circuit, the OTC; alternatively, several parallel operating second binary cycle circuits can be applied—the OTC;
In the reset conditions of the HTPC ATNPP, the primary heat source coolant is heated from external energy sources;
In the OTC, regenerative heating of the OTC fluid from the OTC cooler circuit is carried out;
STC and OTC are executed with quasi-intermediate vapor superheating to improve efficiency, due to elimination of considerable parts of intra-cycle thermal energy losses due to its intra-cycle recovery by means of heat exchange with superheated vapors obtained as exhaust vapors flowing from high pressure cylinders (HPC) of STC and OTC at their mass-temperature separation in the cascades of the corresponding adiabatic vortex units;
In order to achieve the highest cycle efficiency, the STC creates supercritical fluid parameters, from a heat source transferred to the STC superheater, and thereby carries out additional superheating of the fluid;
In order to improve the efficiency of the STC and ensure the maneuverability of the rejected heat transfer from the STC to the external environment and to the OTC, compression of the exhaust vapor from the low-pressure cylinder (LPC) and the cold part of the vapor from the adiabatic vortex units—superheater, is applied, thus improving also the operation of the condenser of the rejected heat to the external environment;
In order to improve the efficiency of the OTC, the vapors exhausted in the medium pressure cylinder (MPC) and the LPC are compressed, as well as the cold part of the vapors obtained from the separation of vapors in the cascade of adiabatic vortex units of the OTC from the vapors exhausted in the HPC and compressed after their discharge from the HPC; in addition, these combined vapors are supplemented (before their compression) with preheated vapors from the inter-cycle condenser of the STC, which are formed and flow out as overcooled from the adiabatic vortex cascade of the OTC mass-temperature stratification; this compression ensures that the condensation temperature of the OTC fluid vapors is increased;
The thermal energy is discharged by the vapors directed to the OTC from the STC, after their utilization in the OTC these fluid vapors of the first circuit of the binary cycle are condensed through the cold part of the vapors exhausted in the OTC turbine and obtained by the separation of the vapors exhausted in the OTC—in the cascade of the OTC adiabatic vortex units;
The efficiency of condensation of some vapors when discharging thermal energy from the STC to the external environment is ensured by using the incoming airflow in the ATNPP flight with its additional overcooling through a vortex mass-temperature stratification unit, or through a cascade of such units;
Condensation of the OTC fluid vapors is provided by an independent compression cooler refrigerant in the circuit, in which the refrigerant vapors are pre-cooled from the process heat recovery heater (for regenerative heating of the OTC) before the condenser of the cooler, as well as another effectively reinforced cooling of the OTC rejected heat (discharged into the external environment) by the air condenser operating from the unit or a cascade of vortex mass-temperature stratification units which, in turn, operate from the oncoming air flow in the ATNPP flight.
In order to improve the mass-dimensional parameters of the HTPC ATNPP equipment, the ATNPP on-board electric machines are used based on high-temperature superconductors.
The by-product heat generated by the applied mass-temperature stratification vortex units of the HTPC air condensers is used for technological combat against possible in-flight icing of the ATNPP glider.

As for the application of the proposed invention of the HYBRID THERMAL POWER CYCLE OF ATNPP (HTPC ATNPP), [90] shows the variants of constructing binary cycles with the nuclear reactor on molten salts with potassium and water-steam cycle with efficiency of 54.6% [90, p. 126, 127] and also with the water and freon cycle [90, p. 129, 130]. The following main essential features are considered here as comparatively relevant analogues to the invention of the HTPC ATNPP, in which the equipment operates according to a binary cycle:
The heat source is a nuclear reactor.
Construction of power generation systems on a binary cycle;
Three media are used in binary power generation cycles.
The first medium is the one that transfers thermal energy from the heat source to the power generation system in a binary cycle.
The second medium used in the upper cycles of the binary cycle is potassium or water.
The third medium used in the lower cycles of the binary cycle is water or freon.
The upper cycles are based on the Rankine cycle by using condensing turbines with vapor extraction to high-pressure heaters.
The lower cycles are constructed using condensing turbines.
In binary cycles, the condenser of the upper cycle turbine is replaced by a lower cycle steam generator.
Regenerative heating in the lower cycles is constructed by means of vapor extraction from the Ultra High-Pressure Cylinder, from the HPC and, from the MPC and the LPC, or by means of vapor extraction from the upper cycle.
The exhaust vapor in the lower cycle turbine is condensed with the rejected heat discharged to the external environment.

### The Common Features with the Proposed Invention Include

The heat source is a nuclear reactor.
Construction of power generation systems on a binary cycle;
Three media are used in binary power generation cycles.
The first medium is the one that transfers thermal energy from the heat source to the power generation system in a binary cycle.
The second medium used in the upper cycles is potassium or water.
The third medium used in the lower cycles is freon.
The first upper cycle is implemented by a Rankine cycle by means of a condensing turbine with vapor extraction for intermediate vapor heating for its operation in the MPC.
The lower cycle is constructed using a condensing turbine.
In binary cycles, the condenser of the upper cycle turbine is replaced by a lower cycle steam generator.
The exhaust vapor in the lower cycle turbine is condensed with the rejected heat discharged to the external environment.

REASONS AND FEATURES PREVENTING THE PROPOSED INVENTION FROM OBTAINING A TECHNICAL RESULT, compared to the solutions described in [90]:
The equipment supporting the operation of the HTPC ATNPP, including nuclear reactors, is placed on board of the flying ATNPP glider;
More than one undercritical hybrid nuclear reactor, or accelerator-driven undercritical nuclear reactors, is used as the primary source of thermal energy in the HTPC ATNPP;
The HTPC ATNPP is designed as a binary one with several and parallel working second circuits with low-boiling fluids;
The transmission of thermal energy to the HTPC ATNPP from the nuclear reactors is carried out both continuously and in an alternate mode;
In order to ensure the maneuverability of power generation in the HTPC ATNPP, the pulse ratio and duration of reactor operation are controlled with periods that ensure the maintenance of reasonable temperatures of the coolant transferring energy to the STC and to the Second Binary Cycle Circuit (OTC);
A thermal flywheel energy storage unit is used to smooth out pulses of supplying thermal energy to the STC and the OTC;
Thermal energy is transferred from the primary sources of the HTPC ATNPP both to the first binary cycle circuit, the STC, and in parallel to the second binary cycle circuit, the OTC; alternatively, several parallel operating second binary cycle circuits can be applied—the OTC;
In the reset conditions of the HTPC ATNPP, the primary heat source coolant is heated from external energy sources;
Depending on the current and required maneuverability parameters, the thermal energy rejected from the first circuit of the binary cycle may not only be utilized in the second circuit of this cycle, but also partly discharged into the environment;
STC and OTC are executed by Rankine cycle with quasi-intermediate vapor superheating to improve efficiency, due to elimination of considerable parts of intra-cycle thermal energy losses due to its intra-cycle recovery by means of heat exchange with superheated vapors obtained as exhaust vapors flowing from high pressure cylinders (HPC) of STC and OTC at their mass-temperature separation in the cascades of the corresponding adiabatic vortex units;
In the OTC, regenerative heating of the OTC fluid from the OTC cooler circuit is carried out;
In order to achieve the highest cycle efficiency, the STC creates supercritical fluid parameters, from a heat source transferred to the STC superheater, and thereby carries out additional superheating of the fluid;
In order to improve the efficiency of the STC and ensure the maneuverability of the rejected heat transfer from the STC to the external environment and to the OTC, compression of the exhaust vapor from the low-pressure cylinder (LPC) and the cold part of the vapor from the adiabatic vortex units—superheater, is applied, thus improving also the operation of the condenser of the rejected heat to the external environment;
In order to improve the efficiency of the OTC, the vapors exhausted in the medium pressure cylinder (MPC) and the LPC are compressed, as well as the cold part of the vapors obtained from the separation of vapors in the cascade of adiabatic vortex units of the OTC from the vapors exhausted in the HPC and compressed after their discharge from the HPC; in addition, these combined vapors are supplemented (before their compression) with preheated vapors from the inter-cycle condenser of the STC, which are formed and flow out as overcooled from the adiabatic vortex cascade of the OTC mass-temperature stratification; this compression ensures that the condensation temperature of the OTC fluid vapors is increased;
The thermal energy is discharged by the vapors directed to the OTC from the STC, after their utilization in the OTC these fluid vapors of the first circuit of the binary cycle are condensed through the cold part of the vapors exhausted in the OTC turbine and obtained by the separation of the vapors exhausted in the OTC—in the cascade of the OTC adiabatic vortex units;
The efficiency of condensation of some vapors when discharging thermal energy from the STC to the external environment is ensured by using the incoming airflow in the ATNPP flight with its additional overcooling through a vortex mass-temperature stratification unit, or through a cascade of such units;
Condensation of the OTC fluid vapors is provided by an independent compression cooler refrigerant in the circuit, in which the refrigerant vapors are pre-cooled from the process heat recovery heater (for regenerative heating of the OTC) before the condenser of the cooler, as well as another effectively reinforced cooling of the OTC rejected heat (discharged into the external environment) by the air condenser operating from the unit or a cascade of vortex mass-temperature stratification units which, in turn, operate from the oncoming air flow in the ATNPP flight.
In order to improve the mass-dimensional parameters of the HTPC ATNPP equipment, the ATNPP on-board electric machines are used based on high-temperature superconductors.
The by-product heat generated by the applied mass-temperature stratification vortex units of the HTPC air condensers is used for technological combat against possible in-flight icing of the ATNPP glider.

As for the application of the proposed invention of the HYBRID THERMAL POWER CYCLE OF ATNPP, (HTPC ATNPP), the invention [91] is known. Here, in view of the large number of common essential features with the proposed HTPC ATNPP invention, the invention [91] is taken as a PROTOTYPE.

This invention presents a method of power generation in which the equipment operates on a ternary cycle and the construction of the last two cycles is highly relevant to the proposed invention, so that in the following description the last two cycles of the invention [91] will be considered as the PROTOTYPE.
The prototype power generation system uses three fluid media, a heat source medium from the first circuit of the trinary cycle and two different “further binary cycle” media, where the first medium is the coolant by which thermal energy is transferred from the “conditionally external” heat source to the binary cycle, while the second and third media are water that is an organic liquid with a low boiling point;
The prototype technique with respect to the last two circuits of a trinary cycle is basically constructed as a binary cycle with a steam-water first circuit (steam-turbine cycle—STC) and with a low-boiling fluid in the second circuit (organic turbine cycle—OTC). Here, the thermal energy discharged from the STC is utilized mainly in the second circuit and can also be partially discharged to the external environment;
Thermal energy in the prototype from a “conditionally external” source—(from the first loop of the trinary cycle), is transferred both to the first circuit of the binary cycle—to the STC, and to the second circuit of the binary cycle—to the OTC;
The STC is carried out according to the Rankine cycle with intermediate superheating of vapor to improve efficiency by eliminating part of the intra-cycle thermal energy losses;
In the STC, regenerative heating of feed water by means of an independent coolant is carried out using heat from the LPC;
To achieve the highest efficiency of the STC, the supercritical parameters of the fluid are created from the “conditionally external” heat source—(from the first circuit of the trinary cycle), transmitted to the superheater of the STC and thus additional superheating of the fluid is carried out;
In order to improve the efficiency of the OTC, the vapors exhausted in the medium pressure cylinder (MPC) and the LPC are compressed, as well as the cold part of the vapors obtained from the separation of vapors in the cascade of adiabatic vortex units of the OTC from the vapors exhausted in the HPC and compressed after their discharge from the HPC; in addition, these combined vapors are supplemented (before their compression) with preheated vapors from the inter-cycle condenser of the STC, which are formed and flow out as overcooled from the adiabatic vortex cascade of the OTC mass-temperature stratification; this compression ensures that the condensation temperature of the OTC fluid vapors is increased;
The thermal energy is discharged by the vapors directed to the OTC from the STC, after their utilization in the OTC these fluid vapors of the first circuit of the binary cycle are condensed through the cold part of the vapors exhausted in the OTC turbine and obtained by the separation of the vapors exhausted in the OTC—in the cascade of the OTC adiabatic vortex units;
Condensation of the OTC fluid vapors is provided by an independent compression cooler refrigerant in the circuit, in which the refrigerant vapors are pre-cooled from the process heat recovery heater before the condenser of the cooler, and then another cooling of cooler condenser from the unit or a cascade of OTC vortex mass-temperature stratification as well as from external environment.

### The Common Essential Features with the Proposed Invention Include

The prototype power generation system uses three fluid media, a heat source medium from the first circuit of the trinary cycle and two different “further binary cycle” media, where the first medium is the coolant by which thermal energy is transferred from the “conditionally external” heat source to the binary cycle, while the second and third media are water that is an organic liquid with a low boiling point;
The prototype technique with respect to the last two circuits of a trinary cycle is basically constructed as a binary cycle with a steam-water first circuit (steam-turbine cycle—STC) and with a low-boiling fluid in the second circuit (organic turbine cycle—OTC). Here, the thermal energy discharged from the STC is utilized mainly in the second circuit and can also be partially discharged to the external environment;
Thermal energy in the prototype from a “conditionally external” source—(from the first loop of the trinary cycle), is transferred both to the first circuit of the binary cycle—to the STC, and to the second circuit of the binary cycle—to the OTC;
The STC is carried out according to the Rankine cycle with intermediate superheating of vapor to improve efficiency by eliminating part of the intra-cycle thermal energy losses;
In the STC, regenerative heating of feed water by means of an independent coolant is carried out using heat from the LPC;
To achieve the highest efficiency of the STC, the supercritical parameters of the fluid are created from the “conditionally external” heat source—(from the first circuit of the trinary cycle), transmitted to the superheater of the STC and thus additional superheating of the fluid is carried out;
In order to improve the efficiency of the OTC, the vapors exhausted in the medium pressure cylinder (MPC) and the LPC are compressed, as well as the cold part of the vapors obtained from the separation of vapors in the cascade of adiabatic vortex units of the OTC from the vapors exhausted in the HPC and compressed after their discharge from the HPC; in addition, these combined vapors are supplemented (before their compression) with preheated vapors from the inter-cycle condenser of the STC, which are formed and flow out as overcooled from the adiabatic vortex cascade of the OTC mass-temperature stratification; this compression ensures that the condensation temperature of the OTC fluid vapors is increased;
The thermal energy is discharged by the vapors directed to the OTC from the STC, after their utilization in the OTC these fluid vapors of the first circuit of the binary cycle are condensed through the cold part of the vapors exhausted in the OTC turbine and obtained by the separation of the vapors exhausted in the OTC—in the cascade of the OTC adiabatic vortex units;
Condensation of the OTC fluid vapors is provided by an independent compression cooler refrigerant in the circuit, in which the refrigerant vapors are pre-cooled from the process heat recovery heater before the condenser of the cooler, and then another cooling of cooler condenser from the unit or a cascade of OTC vortex mass-temperature stratification as well as from external environment.

Reasons and features DISTINCTIVE from the prototype PREVENTINGFROM obtaining a technical result compared to the proposed invention:
The equipment providing the operation of the HTPC ATNPP, including nuclear reactors, is placed on board of the flying ATNPP glider;
More than one undercritical hybrid nuclear reactor, or accelerator-driven undercritical nuclear reactors, is used as the primary source of thermal energy in the HTPC ATNPP;
The HTPC ATNPP is designed as a binary one with several and parallel working second circuits with low-boiling fluids;
The transmission of thermal energy to the HTPC ATNPP from the nuclear reactors is carried out both continuously and in an alternate mode;
In order to ensure the maneuverability of power generation in the HTPC ATNPP, the pulse ratio and duration of reactor operation are controlled with periods that ensure the maintenance of reasonable temperatures of the coolant transferring energy to the STC and to the OTC;
A thermal flywheel energy storage unit is used to smooth out pulses of supplying thermal energy from nuclear reactors to the STC and the OTC;
In the reset conditions of the HTPC ATNPP, the primary heat source coolant is heated from external energy sources;
In the OTC, regenerative heating of the OTC fluid from the OTC cooler circuit is carried out;
In order to improve the efficiency of the STC and ensure the maneuverability of the rejected heat transfer from the STC to the external environment and to the OTC, compression of the exhaust vapor from the low-pressure cylinder (LPC) and the cold part of the vapor from the adiabatic vortex units—superheater, is applied, thus improving also the operation of the condenser of the rejected heat to the external environment;
The efficiency of condensation of some vapors when discharging thermal energy from the STC to the external environment is ensured by using the incoming airflow in the ATNPP flight with its additional overcooling through a vortex mass-temperature stratification unit, or through a cascade of such units;
In order to improve the mass-dimensional parameters of the HTPC ATNPP equipment, the ATNPP on-board electric machines are used based on high-temperature superconductors.
The by-product heat generated by the applied mass-temperature stratification vortex units of the HTPC air condensers is used for technological combat against possible in-flight icing of the ATNPP glider.

### Disclosure of the Invention in the Part of the Hybrid Thermal Power Cycle of ATNPP (HTPC ATNPP)

The OBJECTIVE of the HTPC ATNPP PROPOSED INVENTION is to develop a highly efficient technology for mechanical power generation and electrical power generation based on the thermal power generation by means of nuclear reactors.

The objective of the invention of high efficiency of the HTPC ATNPP is determined by the requirements of minimum values of mass-dimensional indicators of on-board technological equipment with the highest possible value of power generation with high efficiency, which is the achievable technical result that ensures the invention.

Efficient conversion of thermal power into electrical power for ATNPP is particularly relevant in relation to the aircraft on-board placement of power units, with their minimum mass and dimensions. According to the proposed invention, in the ATNPP some not popular solutions can be applied, such as the use of electric machines on superconductors. Relevance of mass-dimensional parameters is also determined by the fact that the Efficiency of nuclear power units in the general traditional application is not relatively high due to the decreased temperatures of the coolant heating the fluid in thermal power cycles, if compared with the cycles of thermal power plants. In [92], it is mentioned concerning nuclear power plants that for initial cycle temperatures of below 650 degrees Celsius the use of water steam at supercritical initial parameters is practically feasible only in case of multiple FIRING STEAM OVERHEATING.

Thus, the invention [93] shows that in order to improve the capacity and efficiency of NPP by increasing the enthalpy drop for the whole steam turbine, while maintaining the existing nuclear reactor capacity, high-temperature superheating of steam from an external source of thermal energy is introduced, for example, during combustion of JP fuel. The invention [94], also aimed at obtaining additional NPP capacity and its maneuverability, shows the efficient use of a gas turbine power unit integrated into the heat grid of the NPP. In addition, for example, the inventions [95, 96] are aimed at increasing the efficiency of NPP by generating additional electrical power through the incorporation of a hydrogen oxy-combustion boiler as a steam superheater in the heat and power grid of the NPP.

In this regard, it should be mentioned that the increase in heat efficiency in cycles of mechanical power generation is related to raising the fluid average temperature at the heat supply and lowering the average temperature at the heat rejection. However, a disadvantage, for example, of the gas turbine cycle is the high average fluid temperature at the heat rejection, and this temperature grows as the maximum possible fluid temperature is increased.

In this regard, in order to reduce the fluid temperature in the gas turbine power unit at heat rejection, it would be necessary to increase the degree of regeneration to an economically unjustifiable value, [90].

According to the results of the analysis of thermodynamic cycles and the development of thermal power grids, an increase in the average fluid temperature at heat supply into the cycle and a decrease in the average fluid temperature at heat rejection for further increasing the efficiency of nuclear power units can be achieved by using low-boiling organic substances in addition to water, [90 p. 123]. The advantage of using different fluids is most fully realized in the so-called, and widely known combined heat and power cycles, in which the efficiency is improved.

Combined units are defined as a combination of two or several units having different fluids and exchanging heat. The main idea of the combined cycle concept is to combine a steam turbine with backward pressure and the Rankine organic cycle, [97].

Binary cycles are the most widespread ones representing a set of two thermodynamic cycles which are carried out by two fluids so that the heat rejected in one cycle is used in the other one [98, 99 p. 155]. Here the steam turbine condenser is replaced, for example, by a freon steam generating unit, [90 p. 129].

A combination of three or more cycles is also possible, in which the heat rejected from the upper cycles is used in the lower cycles, e.g., [90, 100, 101, 102].

The use of combined cycles enables the application of several fluids, each in its own (most beneficial) temperature range. In this case it is possible to increase the average temperature of heat supply and decrease the average temperature of heat rejection in the cycle and thereby to improve the thermal efficiency of the cycle, [99 p. 155]. For example, a binary water-freon cycle allows increasing the unit capacity of a steam power turbine by raising the pressure behind the steam-water turbine [90 p. 129]. What is important for aircraft based nuclear power plant. Although it is known that water-freon units have thermal efficiency lower than basic steam-turbine units at equal initial and final parameters, [90 p. 129+130]. Thermal efficiency of water-freon units is higher than that of corresponding steam-water units, when freon condensation temperature is lower than the one of water vapor condensation in the comparable units, [90 p. 129].

According to the inventive conception, the lower temperature of the cycle is very low due to the aircraft on-board placement of ATNPP power equipment, and because of the fact that the air temperature overboard of ATNPP will be from minus 30 to minus 55 degrees Celsius, the application of the water-freon cycle is expected to be very efficient.

In addition, the high efficiency of the “onboard water-freon cycle” is also determined by the fact that in accordance with the inventive conception, namely due to the application of vortex mass-temperature stratification from the incoming air flow in the ATNPP flight, the temperature of cooling air in the condensers of the ATNPP onboard power units will be in the range from minus 70 to minus 100 degrees Celsius. In this regard, the present invention introduces a special concept, a device—Air-cooled Vortex Mass-Temperature Stratification Condenser, (VMTSC).

To achieve the objective of high efficiency in ATNPP power plants in accordance with the inventive conception and by some analogy with combined cycles, ATNPP uses the Hybrid Thermal Power Cycle (HTPC), which applies the Steam Turbine Cycle (STC) with intermediate superheating of steam by vortex mass-temperature stratification and uses Organic Turbine Cycle (OTC) also with intermediate superheating of organic steam by vortex mass-temperature stratification, as it is partially shown in [91, 103]. Here intermediate superheating of steam (initial steam parameters of turbine units are meant), as is widely known, is necessary to reduce humidity in the last stages of the turbine and to increase thermal efficiency of the cycle, [104 p. 181].

Special-purpose turbines are used in HTPC, in which common features with condensing turbines are preserved, but there are also distinctive features in relation to turbines with backward pressure and vapor extraction. Their peculiarity is that the hot part of the fluid mass is transferred from the separators of this medium to the expansion, and the cold part of the fluid mass is transferred from the separators of this medium to the compressor wheels and returns to the HTPC thus closing the heat-engineering cycle, eliminating significant fluid heat losses in the process of converting thermal energy into mechanical work for power generation.

Increasing the efficiency of utilizing the energy of the rejected heat in the STC and in the OTC, as mentioned above, is carried out by applying the effect of vortex mass-temperature stratification, known from the inventions [103, 105] and described in detail in [106, 107]. In the proposed invention, this refers not only to the intermediate superheating of vapors in the “heat-engineering piping” of turbomachines, but also to the heat rejection from the STC and OTC. In this case, the necessary design calculations of the values of pressures, temperatures and mass flow rates of movements within the cyclic vapors and “incoming” air flows in the VMTSC can be determined by appropriate experts, and it is not reasonable to do so in the current description.

Taking into account the integrity of the group of inventions and in connection with the ATNPP concept presented in the disclosure of the invention in its part, the structural composition of the HTPC ATNPP onboard equipment is represented by sources of thermal energy—more than one nuclear reactor, facilities of one, or more steam turbine cycles and equipment of several parallel cycles of organic turbines, which drive the ATNPP glider traction air screws.

The equipment of the HTPC ATNPP includes an electric generator and electric machines used in propulsion and generator modes.

As for the efficiency of electric machines on superconductors, previously mentioned, for example in [108 p. 2], it is stated that they exceed by 2-3 times the corresponding indicators of electric machines of traditional design by their specific mass-energy parameters. Here in [108 p. 21], the data are given that TRD has developed a 50 MW electric motor with dimensions of 4 m×7 m.

In [109] information is given that the values of the upper critical field in the samples synthesized at the Physical Institute of the Russian Academy of Sciences are close to 100 tesla, and the transition temperature reaches 21 degrees Kelvin.

In [110] it is reported that in recent years several types of superconductors have been discovered, or created, capable of operating at very high temperatures, which in the best cases reach as low as minus 70 degrees Celsius that is already almost achievable in natural conditions. Using such results, according to the inventive conception, part of the output cold air flows from the aforementioned VMTSC, formed from the “incoming” air flows to the ATNPP glider, is optionally used to create working temperatures of superconductors in on-board electrical machines. In this regard, we can take into account the above-mentioned fact that the temperature of the cooling air in the condensers of the ATNPP onboard power units will be in the range from minus 70 to minus 100 degrees Celsius with the application of vortex mass-temperature stratification from the incoming air flow in the ATNPP flight.

In [111, 112 and 113] it is already reported about the aircraft application of electric machines on superconductors. Here, in terms of creating high-temperature superconductors, the focus is on the ability to increase the specific capacity of electric machines on superconductors from the current 5 kW/kg to 8÷12 kW/kg and even up to 30 kW/kg.

The HTPC ATNPP is also represented by accumulators: traction accumulators for ATNPP takeoffs and landings and SPAS parachute-landing units. By means of the above-mentioned electric machines, ATNPP takeoffs and landings are provided and, they can generate electrical power for the ATNPP onboard generating power grid. In addition, the HTPC ATNPP is represented by a booster battery block designed to increase the climbing speed of ATNPP takeoffs in order to reduce the time before launching the reactors. Such booster batteries, after ATNPP takeoffs and launching their reactors, are parachuted to special stationary landing sites provided in the vicinity of the ATNPP basing airfields.

FIG. 8 shows one of the possible technological schemes of mechanical and electrical energy generation—HTPC ATNPP. Here, positions 23 and 24 show, as an option, the onboard hybrid molten salt reactors, which supply thermal energy to the ATNPP.

For example, in the annular core 187 of reactor 23 molten uranium salt fuel produced from fertile thorium fuel is “treated” with 14.1 MeV neutrons from the Deuterium Tritium Fusion Plasma Source 26, based on a compact TOKAMAK 27. Here, the heat-releasing nuclear fuel, with a temperature of about 550÷600 degrees Celsius, is moved along the outer circuit of the primary heat exchanger 28 through the loop circulation line 29 and valve 30, by means of a circulation pump 31, made with inert blowdown and xenon extraction. And along the loop line 32 the molten salt/coolant is circulated, transferring heat to the STC at a temperature of about 500÷570 degrees Celsius. At the same time the circulation pump 33 of this line is equipped with salt cleaning components. Heat transfer to the STC along the line 32 is carried out by means of secondary heat exchangers, which are parts of the steam heater 34 and steam superheater 35.

At the same time, reactors 23 and 24 are used in “pulse” modes, alternately, providing the STC with a continuous supply of thermal energy to it. This is due to the achieved level of TOKAMAK technology regarding the plasma confinement time, i.e. the “pulse” time of their operation to control the fission reactor, [see 60, 72 and 73].

Thus, to generate electrical power in the STC, the molten salt in the steam superheater 35, which gave up the thermal energy, is sent to the steam heater 34 and after this, the part of the residual heat is utilized in the heater 36 of the independent coolant 37, further using this part of the residual heat to heat the organic fluid in the OTC.

The STC and OTC of the proposed method of HTPC implementation are performed as cycles with improved efficiency, due to the elimination of a significant part of the intracycle energy losses at the expense of its intracycle recovery using the effect of vortex mass-temperature stratification, similar to how it is performed in the invention [103]. In addition, in order to ensure supercritical parameters of the fluid in the STC with the aim of achieving maximum cycle efficiency, additional superheating of the fluid is carried out by a vortex superheater 172, or a cascade of such units. For this purpose, the exhausting steam 173 is supplied from the steam superheater to this unit and, according to the laws of physics relating to such units, superheated sharp steam 146 is obtained, and even at a higher pressure than the steam 173 incoming to the unit 172. Further, the superheated sharp steam 146 is processed in High Pressure Cylinder 42 (HPC) of the STC turbine. At the same time, the separated part of the fluid 177, obtained from the unit 172 in cold condition and with a lower pressure than the steam 173 incoming into the unit 172, is compressed by the compressor 178, aligning the pressure of the steam 179 flowing out from this compressor with the pressure of the steam 47 and 46 exhausted in the LPC 39. In this regard, compressor 178 also ensures that there is no significant backward pressure at the output of unit 172 of the cold part from the separated fluid and that is favorable for the operation of separating unit 172.

Before supplying feed water to the STC boiler, it is heated under pressure by means of an independent coolant 38, with the energy of the exhaust steam flowing out of the Low-Pressure Cylinder 39, (LPC) of the steam turbine.

Feed water evaporation is carried out in the steam generating unit 40 of the STC boiler 41 by means of the hot part of steam, obtained at separation of the exhaust steam from the HPC 42 of the steam turbine. In this case, the mass-temperature separation of the steam exhausted in the HPC is performed on two (or more) stages of the STC cascade of vortex units 43. In addition, the selection of the steam hot part directed to the steam generator 40 of boiler 41, which has the highest temperature, is carried out from the last stage of the cascade of vortex units 43. The mass of steam, from which some energy has been utilized in the steam generating unit 40 of boiler 41, is directed to the Medium Pressure Cylinder 44 (MPC) of the steam turbine, where the corresponding mechanical energy is generated.

From the MPC 44, the mass of the exhaust steam is in turn directed to energy generation in the LPC 39. Thus, all mechanical energy generated in the STC is converted into the energy of the ATNPP generating electric grid.

The steam, exhausted in the LPC 39, is cooled in the heater 45, directing part of the received heat, as mentioned earlier, to the heating of the STC feed water.

Then this steam 46, exhausted and cooled in the heater 45, is combined with the “cold” part of the steam obtained at the mass-temperature separation of the steam 129, exhausted in the HPC 42 of the steam turbine.

The mass of the combined steam is compressed by compressor 48 and, its first part 134 is directed (as STC rejected energy) to the Organic Turbine Cycles to generate energy in other internal cycles of the HTPC. For example, in the OTC 117 a part of the steam 134 is directed to the steam generating unit 49 of the organic fluid of the boiler 50 of the OTC 117 to generate the mechanical energy of the traction air screws 76. And in some ATNPP flight modes, electrical power is generated on electric machine 77, which in these cases is switched to generator mode. Other parts of steam 134, are distributed and directed to other OTCs, where mechanical energy is also generated for the ATNPP glider traction air screws and, in some modes, electrical energy is generated.

The other second part of the steam compressed in the compressor 48 is directed (as STC rejected energy) to the VMTSC 55.

The mass of steam, from which some energy is utilized in the steam generating unit 49 of the OTC boiler 50, is condensed in the inter-cycle condenser 51. Thus, obtaining condensing water 52, the energy of the cold part of the organic fluid steam received from the last stage of the cascade of vortex units 53 and 54 of the OTC is utilized. The condensing water 52 obtained in this way is directed to be used in the STC. Here it should be noted that cooling of inter-cycle condenser 51 is performed not from the external environment, but from the OTC due to the technology of mass-temperature stratification in units 53 and 54 of the OTC.

Thus, in the proposed HTPC a relatively in-depth integration of mass and heat-exchanging processes of the forward direction and reverse recovery direction is carried out.

Depending on the reasonable parameters of the required load maneuverability of the ATNPP, according to the inventive conception, the TOTAL OUTPUT HEAT CAPACITY of the REACTORS is REGULATED by controlling the duration of their operation pulses and, thus, providing further possibility to regulate the generated energy capacity on the steam turbine of the HTPC. CORRELATION OF SELECTION of the combined vapors from compressor 48, as described above, is also regulated in the direction of the OTC, as well as in the direction of their condensation in the VMTSC 55 of the STC. There, high-efficiency cooling of this VMTSC 55 is carried out by a flow 56 of “highly cold” air by means of a vortex unit 22 of mass-temperature stratification (or a cascade of these units), supplied from confusors 21, from the “incoming” air flow 57 in the ATNPP flight.

In addition, according to the inventive conception, the load MANEUVERABILITY of ATNPP in general and the LOCAL load MANEUVERABILITY in the Organic Turbine Cycles “inside” this maneuverability are distinguished. So, these two maneuverabilities are dependent on the load value in the ATNPP generating power grid as a whole and on the load on the traction air screws of the ATNPP glider and the aircraft of the whole aero-train that is determined by the current weather conditions of the flight, the processes of charging the accumulators batteries of the aero-train aircraft and the operational logistics of the change in the composition of the aircraft in the aero-train.

In this regard, according to the inventive conception, a system-related power regulation of the energy generated in the STC and OTC is carried out in the HTPC. This system-related power regulation is performed by controlling the capacity in the STC and the REGULATION of the SELECTION CORRELATION OF THE REJECTED HEAT from the STC to the OTC and to the VMTSC of the STC.

Mathematical model of the HTPC control system in relation to the above-described processes in the ATNPP MANEUVERABILITY PART is not reasonable to be presented in the current invention, which can be done by specialists of the relevant profile ON THE BASIS OF THE TASK ASSIGNMENT to develop this model in accordance with the inventive conception.

Thus, for example, the resulting effects of the HTPC control system on the operation of hybrid reactors can be the dynamics of changes in the duration of pulse periods of active operation of reactors and alterations in the pulse rate. In turn, the “maneuverable statics” and dynamics of STC equipment control is realized (among other things) due to the introduction into its heat grid of the inertial link “coordinating” thermal energy flows to boiler 41 and then to the turbine unit of the STC from alternately operating reactors.

Such thermal inertial link is introduced in the line 32 of the molten salt, at its entrance to the steam superheater 35 of boiler 41 and represents a buffer capacity 171 of the molten salt.

For ensuring a probable ability (as an option) to apply supercritical parameters of the fluid in the first circuit of the binary cycle, as well as for achieving maximum cycle efficiency, including efficient operation of STC condensers, the proposed invention uses as a working fluid a mixture composed of a small amount of helium with titanium tetrachloride, [91]. With a boiling point of 135.9 degrees Celsius, titanium tetrachloride shows stable properties up to 1727 degrees Celsius, and its critical temperature is 357.9 degrees Celsius.

In addition, given the high thermal factor of nuclear reactors and heat-exchanging units in the first circuit of the binary cycle, the use of metal vapors would be beneficial, e.g., potassium, which has good compliance with iron-chromium-nickel alloys, or niobium alloys, [90].

Organic turbine cycles are realized by using a fluid with the property of low-temperature boiling. Ozone-safe freons R23, R32, R125, R134a, R152a, freon mixtures such as R407c, R507, R508 and low-temperature mixture R404A can be used for this purpose. Azeotropic mixture of freons R507c can be effectively used, as well as high-density mixture of R410A, which has practically no glide and high thermal conductivity, combined with a relatively low viscosity. In specific projects of the HTPC, it is also possible to use known hydrocarbon fluids, alkanes such as butane (R600 with a boiling point of −0.5 degrees Celsius), or its isomer (Isobutane R600a with a boiling point of −11.7 degrees Celsius) in the OTC. Isobutane application in OTC is justified due to its ozone safety and its thermodynamic properties in relation to probably possible application of supercritical parameters in the proposed invention, which are realized due to mass-temperature separation of the fluid. Thus, the critical temperature of isobutane is 134.69 degrees Celsius, and the critical pressure is 3.629 MPa, with a density of 225.5 kg/m³. In view of these parameters, according to the proposed invention, it seems possible to use isobutane with initial pressure in the cycle up to 5 MPa in order to obtain maximum efficiency of the OTC. A two-component water-ammonia mixture according to Kalina cycles can also be applied as an organic fluid in the HTPC. The equilibrium state between the liquid and gaseous phases for each component of this mixture is reached at different temperatures. The cycle provides a highly efficient, optimized process of thermal energy conversion during evaporation and condensation of the fluid in a sufficiently wide temperature range, up to a mixture dissociation temperature of 550÷600 degrees Celsius.

Here, the use of saturated fluorocarbons with unique characteristics is not excluded to be used as fluid (in OTC).

Saturated fluorocarbons have low boiling points, e.g., in the range of (−128)÷(−2.0) degrees Celsius, and high density. They are chemically inert, resistant to acids, alkalis and oxidants, hardly flammable, not explosive and slightly toxic. They have a high heat of vaporization and are easily liquefied under pressure, that is relevant to the efficiency of the OTC presented by the current invention, in which, according to the inventive conception, the vapors exhausted in the organic turbine are compressed by the compressor, raising their condensing temperature, which provides increased efficiency of the OTC condenser and, as a result, the mass-dimensional characteristics of this condenser are reduced.

To implement OTC in the proposed invention, the vapors of the organic fluid are directed from the steam generating unit 49 of the boiler 50 of the OTC to the steam heater 58 of this boiler, where these vapors are heated to OVERCRITICAL parameters due to regenerative heat exchange with superheated vapors of the same fluid, which are received as exhaust vapors 175 in the HPC of the organic turbine, at their mass-temperature separation in the cascade of vortex units 53 and 54 of the OTC. Having received the cold parts of organic vapors at the cascade of vortex units, in turn, they are used, as shown earlier, to condense the vapors in the STC and in the OTC, returning the energy of these vapors to the common HTPC. Thus, one part of the cold vapor 59 is heated with water vapor 60 in the intercycle condenser 51 (STC condenser) using this part of the vapor as a cooling agent. The other coldest part of the vapors 61 of the organic fluid obtained from the first stage of the cascade of vortex units 54 of the OTC is compressed by the compressor 62, aligning its pressure with a part of the cold vapors 63 of the organic fluid, used as a cooling agent and heated in the inter-cycle condenser 51 of the STC and, after removing this part of vapors 63 from the condenser 51, these two parts of cold vapors are also combined with the vapors exhausted sequentially in the Middle Pressure Cylinder 64 (MPC) and Low Pressure Cylinder 65 (LPC) of the organic turbine. Then to increase the condensation temperature the whole mass of the three combined vapor parts of the organic fluid is compressed by the compressor 66 and condensed into a liquid of the working fluid in the OTC condenser 67, which is an organic cycle cooler evaporator. This OTC cooler operates on its own independent refrigerant by means of a compressor 68 driven by an organic cycle turbine.

Compressor 68 compresses the vapors of refrigerant 152 flowing from the condenser/evaporator 67 raising their condensation temperature, increasing the efficiency of VMTSC 70. The OTC cooler also operates by means of a battery block of thermostatic expansion valves 69 and through the VMTSC 70 cooler, which, in turn, is highly effectively cooled by the flow 71 of “high cold” air through the vortex unit 72 of mass-temperature stratification (or cascade of these units), supplied from confuser 25 from the “incoming” air stream 73 in the ATNPP flight.

From the OTC condenser 67 the organic liquid of the working fluid is supplied into the feed tank 74 from which this liquid is pumped by the feeding pump into the steam generating unit 49 of the boiler 50 heating it previously and sequentially through the “autonomous” independent coolants 180 and 37 by the heat of the compressed steam of the refrigerant 152 directed for condensation and the heat of the molten salts returned to reactors 23 and 24 after heat utilization of these salts in the STC. Thus, part of the rejected heat of the OTC cooler is recovered in the OTC, increasing the efficiency of this cycle.

Organic vapors of supercritical parameters from the steam heater 58 of boiler 50 are operated in the High-Pressure Cylinder 75 (HPC) of the organic turbine, and then “these” (exhaust) vapors are subjected to mass-temperature separation in a cascade of vortex units 53 and 54 of the OTC, as it was previously mentioned. Vapors, with the removed part of the energy in the steam heater 58 of the boiler 50, are directed to the MPC 64 and then to the LPC 65 of the organic turbine to produce mechanical energy.

In some cruising flight modes, depending on reasonable parameters of the required load maneuverability of ATNPP and according to the inventive concept, THE SELECTION CORRELATION OF mechanical energy is REGULATED from organic turbines in “directions” of the ATNPP glider traction air screws and in “direction” of power generation for the aero-train, that is, in the generating electric grid of ATNPP. Here the possible “generated excess” of mechanical energy on the shafts of organic and steam-turbine units, is transferred to electric machines, (for example, to the machine 77 in the OTC 117), which are put into generator modes.

The peculiarity of the OTC in the presented HTPC is the necessity of its forced launch. So, for example, the electric machine 77 of the OTC and the control equipment of this machine provide the capability of its operation in the propulsion mode, as at takeoffs and landings of the ATNPP.

As a result, the structural and functional construction of the proposed HTPC provides a highly efficient conversion of the thermal energy of the onboard nuclear reactors into mechanical one. Relatively small share of thermal energy, discharged into the external environment from the HTPC, is determined by the rejected heat, removed from air condensers of mass-temperature stratification 55 of the STC and the 70 OTC cooler.

In addition, the HTPC presented in the current invention provides an “external by-product” generation of thermal energy, which is directed to the technical combat against possible icing of the ATNPP glider in flight. This thermal energy is represented by rejected heat—the hot parts of air 164 and 165 flowing out of units 22 and 72 of mass-temperature stratification of incoming air flows 57 and 73.

### The Essential Features which are Sufficient to Achieve the Technical Result Supporting the HTPC ATNPP Invention

The equipment supporting the operation of the HTPC ATNPP, including nuclear reactors, is placed on board of the flying ATNPP glider;
HTPC ATNPP in its basis is built as a binary cycle with a steam-water first circuit (steam-turbine cycle—STC) and with a light-boiling fluid in the second circuit (organic turbine cycle—OTC). Here the thermal power discharged from the first circuit is utilized mainly in the second circuit and can also be partially discharged into the external environment;
The power generation system at ATNPP uses three fluid media, the heat source medium and two different binary cycle mediums, it is the molten salt coolant by which thermal energy is transferred from the nuclear reactor/reactors to the binary cycles, that is water and an organic liquid with a low boiling point;
More than one undercritical hybrid nuclear reactor, or accelerator-driven undercritical nuclear reactors, is used as the primary source of thermal energy in the HTPC ATNPP;
The HTPC ATNPP is designed as a binary cycle with several and parallel working second circuits with low-boiling fluids;
The transmission of thermal energy to the HTPC ATNPP from the nuclear reactors is carried out both continuously and in an alternate mode;
In order to ensure the maneuverability of power generation in the HTPC ATNPP, the pulse ratio and duration of reactor operation are controlled with periods that ensure the maintenance of reasonable temperatures of the coolant transferring energy to the STC and to the OTC;
A thermal flywheel energy storage unit is used to smooth out pulses of supplying thermal energy from nuclear reactors to the STC and the OTC;
Thermal energy is transferred from the primary sources of the HTPC ATNPP both to the first binary cycle circuit, the STC, and to the second binary cycle circuit, the OTC; alternatively, several parallel operating second binary cycle circuits can be applied—the OTC;
In the reset conditions of the HTPC ATNPP, the primary heat source coolant is heated from external energy sources;
STC and OTC are executed by Rankine cycle with quasi-intermediate vapor superheating to improve efficiency, due to elimination of considerable parts of intra-cycle thermal energy losses due to its intra-cycle recovery by means of heat exchange with superheated vapors obtained as exhaust vapors flowing from high pressure cylinders (HPC) of STC and OTC at their mass-temperature separation in the cascades of the corresponding adiabatic vortex units;
In the STC, regenerative heating of feed water by means of an independent coolant is carried out using heat from the LPC;
In the OTC, regenerative heating of the OTC fluid from the OTC cooler circuit is carried out;
To achieve the highest efficiency of the STC, the supercritical parameters of the fluid are created from the heat source transmitted to the superheater of the STC and thus additional superheating of the fluid is carried out;
In order to improve the efficiency of the STC and ensure the maneuverability of the rejected heat transfer from the STC to the external environment and to the OTC, compression of the exhaust vapor from the low-pressure cylinder (LPC) and the cold part of the vapor from the adiabatic vortex units—superheater, is applied, thus improving also the operation of the condenser of the rejected heat to the external environment;
In order to improve the efficiency of the OTC, the vapors exhausted in the medium pressure cylinder (MPC) and the LPC are compressed, as well as the cold part of the vapors obtained from the separation of vapors in the cascade of adiabatic vortex units of the OTC from the vapors exhausted in the HPC and compressed after their discharge from the HPC; in addition, these combined vapors are supplemented (before their compression) with preheated vapors from the inter-cycle condenser of the STC, which are formed and flow out as overcooled from the adiabatic vortex cascade of the OTC mass-temperature stratification; this compression ensures that the condensation temperature of the OTC fluid vapors is increased;
The thermal energy is discharged by the vapors directed to the OTC from the STC, after their utilization in the OTC these fluid vapors of the first circuit of the binary cycle are condensed through the cold part of the vapors exhausted in the OTC turbine and obtained by the separation of the vapors exhausted in the OTC—in the cascade of the OTC adiabatic vortex units;
The efficiency of condensation of some vapors when discharging thermal energy from the STC to the external environment is ensured by using the incoming airflow in the ATNPP flight with its additional overcooling through a vortex mass-temperature stratification unit, or through a cascade of such units;
Condensation of the OTC fluid vapors is provided by an independent compression cooler refrigerant in the circuit, in which the refrigerant vapors are pre-cooled from the process heat recovery heater (for regenerative heating of the OTC) before the condenser of the cooler, as well as another effectively reinforced cooling of the OTC rejected heat (discharged into the external environment) by the air condenser operating from the unit or a cascade of vortex mass-temperature stratification units which, in turn, operate from the oncoming air flow in the ATNPP flight;
In order to improve the mass-dimensional parameters of the HTPC ATNPP equipment, the ATNPP on-board electric machines are used based on high-temperature superconductors.

### All Essential Features of the Htpc Atnpp Invention

The equipment supporting the operation of the HTPC ATNPP, including nuclear reactors, is placed on board of the flying ATNPP glider;
HTPC ATNPP in its basis is built as a binary cycle with a steam-water first circuit (steam-turbine cycle—STC) and with a light-boiling fluid in the second circuit (organic turbine cycle—OTC). Here the thermal power discharged from the first circuit is utilized mainly in the second circuit and can also be partially discharged into the external environment;
The power generation system at ATNPP uses three fluid media, the heat source medium and two different binary cycle mediums, it is the molten salt coolant by which thermal energy is transferred from the nuclear reactor/reactors to the binary cycles, that is water and an organic liquid with a low boiling point;
More than one undercritical hybrid nuclear reactor, or accelerator-driven undercritical nuclear reactors, is used as the primary source of thermal energy in the HTPC ATNPP;
The HTPC ATNPP is designed as a binary cycle with several and parallel working second circuits with low-boiling fluids;
The transmission of thermal energy to the HTPC ATNPP from the nuclear reactors is carried out both continuously and in an alternate mode;
In order to ensure the maneuverability of power generation in the HTPC ATNPP, the pulse ratio and duration of reactor operation are controlled with periods that ensure the maintenance of reasonable temperatures of the coolant transferring energy to the STC and to the OTC;
A thermal flywheel energy storage unit is used to smooth out pulses of supplying thermal energy from nuclear reactors to the STC and the OTC;
Thermal energy is transferred from the primary sources of the HTPC ATNPP both to the first binary cycle circuit, the STC, and to the second binary cycle circuit, the OTC; alternatively, several parallel operating second binary cycle circuits can be applied—the OTC;
In the reset conditions of the HTPC ATNPP, the primary heat source coolant is heated from external energy sources;
STC and OTC are executed by Rankine cycle with quasi-intermediate vapor superheating to improve efficiency, due to elimination of considerable parts of intra-cycle thermal energy losses due to its intra-cycle recovery by means of heat exchange with superheated vapors obtained as exhaust vapors flowing from high pressure cylinders (HPC) of STC and OTC at their mass-temperature separation in the cascades of the corresponding adiabatic vortex units;
In the STC, regenerative heating of feed water by means of an independent coolant is carried out using heat from the LPC;
In the OTC, regenerative heating of the OTC fluid from the OTC cooler circuit is carried out;
To achieve the highest efficiency of the STC, the supercritical parameters of the fluid are created from the heat source transmitted to the superheater of the STC and thus additional superheating of the fluid is carried out;
In order to improve the efficiency of the STC and ensure the maneuverability of the rejected heat transfer from the STC to the external environment and to the OTC, compression of the exhaust vapor from the low-pressure cylinder (LPC) and the cold part of the vapor from the adiabatic vortex units—superheater, is applied, thus improving also the operation of the condenser of the rejected heat to the external environment;
In order to improve the efficiency of the OTC, the vapors exhausted in the medium pressure cylinder (MPC) and the LPC are compressed, as well as the cold part of the vapors obtained from the separation of vapors in the cascade of adiabatic vortex units of the OTC from the vapors exhausted in the HPC and compressed after their discharge from the HPC; in addition, these combined vapors are supplemented (before their compression) with preheated vapors from the inter-cycle condenser of the STC, which are formed and flow out as overcooled from the adiabatic vortex cascade of the OTC mass-temperature stratification; this compression ensures that the condensation temperature of the OTC fluid vapors is increased;
The thermal energy is discharged by the vapors directed to the OTC from the STC, after their utilization in the OTC these fluid vapors of the first circuit of the binary cycle are condensed through the cold part of the vapors exhausted in the OTC turbine and obtained by the separation of the vapors exhausted in the OTC—in the cascade of the OTC adiabatic vortex units;
The efficiency of condensation of some vapors when discharging thermal energy from the STC to the external environment is ensured by using the incoming airflow in the ATNPP flight with its additional overcooling through a vortex mass-temperature stratification unit, or through a cascade of such units;
Condensation of the OTC fluid vapors is provided by an independent compression cooler refrigerant in the circuit, in which the refrigerant vapors are pre-cooled from the process heat recovery heater (for regenerative heating of the OTC) before the condenser of the cooler, as well as another effectively reinforced cooling of the OTC rejected heat (discharged into the external environment) by the air condenser operating from the unit or a cascade of vortex mass-temperature stratification units which, in turn, operate from the oncoming air flow in the ATNPP flight;
In order to improve the mass-dimensional parameters of the HTPC ATNPP equipment, the ATNPP on-board electric machines are used based on high-temperature superconductors;
The by-product heat generated by the applied mass-temperature stratification vortex units of the HTPC air condensers is used for technological combat against possible in-flight icing of the ATNPP glider.

### Essential Features of the HTPC ATNPP Invention Distinctive from Those of the Prototype—[91]

The equipment supporting the operation of the HTPC ATNPP, including nuclear reactors, is placed on board of the flying ATNPP glider;
More than one undercritical hybrid nuclear reactor, or accelerator-driven undercritical nuclear reactors, is used as the primary source of thermal energy in the HTPC ATNPP;
The HTPC ATNPP is designed as a binary cycle with several and parallel working second circuits with low-boiling fluids;
The transmission of thermal energy to the HTPC ATNPP from the nuclear reactors is carried out both continuously and in an alternate mode;
In order to ensure the maneuverability of power generation in the HTPC ATNPP, the pulse ratio and duration of reactor operation are controlled with periods that ensure the maintenance of reasonable temperatures of the coolant transferring energy to the STC and to the OTC;
A thermal flywheel energy storage unit is used to smooth out pulses of supplying thermal energy from nuclear reactors to the STC and the OTC;
In the reset conditions of the HTPC ATNPP, the primary heat source coolant is heated from external energy sources;
In the OTC, regenerative heating of the OTC fluid from the OTC cooler circuit is carried out;
In order to improve the efficiency of the STC and ensure the maneuverability of the rejected heat transfer from the STC to the external environment and to the OTC, compression of the exhaust vapor from the low pressure cylinder (LPC) and the cold part of the vapor from the adiabatic vortex units—superheater, is applied, thus improving also the operation of the condenser of the rejected heat to the external environment;
The efficiency of condensation of some vapors when discharging thermal energy from the STC to the external environment is ensured by using the incoming airflow in the ATNPP flight with its additional overcooling through a vortex mass-temperature stratification unit, or through a cascade of such units;
In order to improve the mass-dimensional parameters of the HTPC ATNPP equipment, the ATNPP on-board electric machines are used based on high-temperature superconductors;
The by-product heat generated by the applied mass-temperature stratification vortex units of the HTPC air condensers is used for technological combat against possible in-flight icing of the ATNPP glider.

### BRIEF DESCRIPTION OF THE DRAWINGS ILLUSTRATING THE HTPC ATNPP TECHNOLOGY

FIG. 8 shows one of the possible technological schemes of mechanical and electrical energy generation—HTPC ATNPP. It demonstrates the use of the generated mechanical and electrical energy to drive the traction air screws of the ATNPP glider itself. It also shows the use of electrical power to charge the ATNPP's own traction accumulators as well as to charge the traction accumulators of the Emergency Response System, which includes the Emergency Parachute System of Nuclear Reactors with a propulsion system. In addition, the use of electrical power for charging the battery circuit breakers of the heat removal systems of the ATNPP onboard nuclear reactors is illustrated here.

### Embodiment of the Invention—Hybrid Thermal Power Cycle of ATNPP (HTPC ATNPP)

FIG. 8 shows one of the possible technological schemes of mechanical and electrical energy generation—ATNPP HYBRID THERMAL POWER CYCLE—the schemes of its internal cycles and the connections between them are shown. It demonstrates the use of the generated mechanical and electrical energy to drive the traction air screws of the ATNPP glider itself. It also shows the use of electrical power to charge the ATNPP's own traction accumulators as well as to charge the traction accumulators of the Emergency Response System.

In FIG. 8, positions 23 and 24 show the onboard hybrid molten salt reactors, which supply thermal energy to the STC and OTC.

In the annular core 187 of reactor 23 molten uranium salt fuel produced from fertile thorium fuel is “treated” with 14.1 MeV neutrons from the Deuterium Tritium Fusion Plasma Source 26, based on a compact TOKAMAK 27. Here, the heat-releasing nuclear fuel, with a temperature of about 550-600 degrees Celsius, is moved along the outer circuit of the primary heat exchanger 28 through the loop circulation line 29 and valve 30, by means of a circulation pump 31, made with inert blowdown and xenon extraction. And along the loop line 32 the molten salt/coolant is circulated through valve 78 and quick-opening gate valves 79 and 80, transferring heat to the STC at a temperature of about 500÷570 degrees Celsius. At the same time the circulation pump 33 of this line is equipped with salt cleaning components as well as the circulation pump 87 or reactor 24.

At the output of the coolant molten salt from the reactor, a pressure compensation valve 141 is shown in line 32, which can, if required, be equipped with a device for cleaning the molten salt from gases.

From the reactor 24, heat transfer to the STC is carried out by circulation of the molten salt/coolant through the valve 82 and quick-opening gate valves 83 and 84, through the loop lines 85 and 32. The check valves 86÷90 provide decoupling of the directions of the molten salt flows from reactors 23 and 24. At the same time, by switching the valves 78 and 82, the thermal energy is alternately supplied to the STC from the reactors 23 and 24, to provide “pulsed” operation of these reactors, as described above in the disclosure of the invention.

The diagram of FIG. 8 shows elements of the “ground” preparation of reactors 23 and 24 for their launches. Positions 91 and 92 here indicate heat-insulated storage facilities for the coolant salt, equipped with electric heaters powered from the ground power grids, which are switched on before ATNPP takeoffs to provide heating for non-operating reactors 23 and 24. After heating the salts in the storages 91 and 92, valves 78 and 82 are fixed closed, and valves 93÷96 are opened and then the circulation pumps 97 and 98 are switched on, filling the primary heat exchanger 28 of reactor 23 (and its analog in reactor 24) with molten salts and filling lines 99 and 100 and corresponding parts of lines 32 and 85. Pumps 33 and 81 are launched after fixing the temperature on them by built-in temperature sensors—the temperature should exceed the temperature of molten salts, thus heating the steam heater 34 and steam superheater 35 of the STC boiler 41.

After that, the ATNPP takes off by driving the air screw 76 from the electric machine 77 of the OTC turbine unit 186 and their analogs in other drives of the ATNPP glider air screws, spinning the OTC turbine unit 186 itself and the corresponding turbine units of other OTC by means of the mechanical reduction gear 6.

The electric machine 77 and its analogues in other drives of ATNPP glider air screws are supplied from the block of traction battery accumulators 101 and from the block of take-off and booster accumulators 183.

At the same time, the processes of forced launches of OTC turbine units are also carried out, as indicated in the disclosure of the invention.

The diagram in FIG. 8 also shows the parachute-landing battery breakers 170 of the Emergency Response System, which are charged on the ground before the ATNPP takes off and, in the ATNPP flight they are kept fully charged from the ATNPP onboard generating power grid.

In the diagram of FIG. 8, these battery breakers are shown conditionally not within the possibly landing reactors 23 and 24, but only to indicate them as technical parts, along with other technical parts constituting the HTPC ATNPP.

When the ATNPP reaches the proper altitude AT ACCELERATED TAKE-OFF, thanks to the booster accumulators 183 and with all the equipment heated up in the filled circulation loop lines 32 and 85, valves 93÷96 are closed, valves 78 and 82 are opened and reactors 23 and 24 are launched one by one. Thus, the power from the block of traction batteries 101 and the power from the block of booster batteries 183 are used.

Then, after the STC and OTC are launched, the block of takeoff and booster batteries 183 is parachuted to special stationary landing sites provided in the vicinity of the ATNPP basing airfields.

The diagram of FIG. 8 illustrates some selected, important “engineering dressing” units for reactors 23 and 24.

Here, position 102 indicates an on-board continuous chemical processing unit for blanket salts. Position 103 denotes “conditionally emergency” storage tanks of fuel salts blocked with a “frozen” plug 104. If the reactor becomes emergency-hot, the plug 104 will melt and the fuel salts will be drained through line 105 into these tanks 103, where the fuel “split” into several parts cannot fission and eventually cools down. In order to ensure launching of reactor 23 after its scheduled shutdowns or emergency recovery of reactor 23, these “conditionally emergency” fuel tanks 103 are equipped with electric heaters for melting salts. And these fuel salts can be supplied to the core 187 of the reactor 23 by means of a pump 31 via the line 106 through the valve 30 and through the part of the line 29 entering the reactor. The electric heaters of the same tanks 103 can be used as boosters for heating fuel salts in the starting modes of reactor 23, or for keeping the salts in a molten state in the reset conditions of this reactor. This is accomplished by arranging the movement of fuel salts through the circulation circuit: by means of pump 31 from tanks 103 along line 106 through valve 30, along the part of line 29 entering the reactor, into the core of the reactor 187 and from there along the outgoing part of line 29, through valve 107 into tanks 103.

The position 108 in FIG. 8 indicates the onboard radiation neutron protection and gamma shielding of the reactor 23.

In a severe emergency situation, when the emergency response system is activated in ATNPP and the emergency reactor is dropped by a special parachute system, the quick-opening valves 79, 80 and 109 are locked before the drop, thereby preventing the molten salt coolant from leaking out. The same quick-opening valves 83 and 84 can be used in an emergency situation in relation to the second reactor 24.

The mechanical quick-release couplings 110÷112 for reactor 23 and couplings 113÷115 for reactor 24 are applied as well. As part of the reactor 23 equipment, the position 116 indicates and shows a check valve, which also ensures that the molten salt/coolant does not leak out during an emergency drop of this reactor 23.

Transmission of heat in the STC is carried out by means of the molten salt—coolant from the primary heat exchanger 28 to the secondary heat exchangers of the boiler 41, which represent a steam heater 34 and a steam superheater 35. This heat transfer is carried out from reactor 23 via line 32 and from reactor 24 via line 85. At the same time, reactors 23 and 24 are used in “pulse” modes, alternately, providing the STC with a CONTINUOUS supply of thermal energy. This is related to the achieved level of TOKAMAK technology with respect to the plasma confinement time, i.e. the “pulse” time of its operation to control the fission reactors. The experimentally achieved time is already defined by a range of 70÷1000 seconds.

Here, the CONTINUITY of heat supply to the STC and its “maneuverable” static value are ensured by the parameters of the dynamics of pulse operation of reactors 23 and 24 and due to the intermediate (between the reactors and the STC turbine unit) thermal inertial link—buffer capacity 171 of the molten salt.

To generate electrical power in the STC, the molten salt in the steam superheater 35, which gave up the thermal energy, is sent to the steam heater 34 and after this, the part of the residual heat is utilized in the heater 36 of the independent coolant 37, further using this part of the residual heat to heat the organic fluid in the OTC 117÷120.

The STC and OTC of the proposed method of HTPC implementation are performed as cycles with improved efficiency, due to the elimination of a significant part of the intracycle thermal energy losses at the expense of its intracycle recovery using the effect of vortex mass-temperature stratification.

In addition, in order to ensure supercritical parameters of the fluid in the STC with the aim of achieving maximum cycle efficiency, additional superheating of the fluid—steam 173 is carried out by a vortex superheater 172, or a cascade of such units. For this purpose, the exhausting steam 173 is supplied from the steam superheater 35 to the unit 172 and, according to the laws of physics relating to such units, superheated sharp steam 146 is obtained, and even at a higher pressure than the steam 173 incoming to the unit 172. Further, the superheated sharp steam 146 is extended in HPC 42 of the STC turbine. At the same time, the cold part of the fluid 177, obtained from the unit 172 with a lower pressure than the steam 173 incoming into the unit 172, is compressed by the compressor 178, aligning the pressure of the steam 179 flowing out from this compressor with the pressure of the steam 47 and 46 exhausted in the LPC 39. In this regard, compressor 178 also ensures that there is no significant backward pressure at the output of unit 172 of the fluid cold part.

Before supplying feed water 125 to the STC boiler 41, it is heated under pressure of a pump 121 in the economizer 122 by means of independent coolant 38, driven by a pump 123, and through the heater 45 with the energy of the exhaust steam 47 flowing out of the LPC 39 of the steam turbine.

Feed water 126 evaporation is carried out in the steam generating unit 40 of the STC boiler 41 by means of the hot part of steam 124, obtained at mass-temperature separation of the exhaust steam from the HPC 42 of the steam turbine. In this case, the mass-temperature separation of the steam 129 exhausted in the HPC 42 is performed on two (or more) stages of the STC cascade of vortex units 43. In addition, the selection of the steam 124 hot part directed to the steam generator 40 of boiler 41, which has the highest temperature, is carried out from the last stage of the cascade of vortex units 43. The mass of steam 127, from which some energy has been utilized in the steam generating unit 40 of boiler 41, is directed through the control valve 128 to the MPC 44 of the steam turbine, where the corresponding mechanical energy is generated.

From the MPC 44, the mass of the exhaust steam 130 is in turn directed to mechanical energy generation in the LPC 39. Thus, all mechanical energy generated in the STC is converted into the energy of the ATNPP generating electric grid by means of electric generating unit 131 based on the high-temperature superconductors. Here, part of the supercooled air 184 coming out of the unit or cascade of mass-temperature stratification units 22 is used for preliminary or required complete cooling of the cryostat unit (it is not shown in the diagram of FIG. 8).

The steam 47, exhausted in the LPC 39, is cooled in the heater 45, directing part of the received heat, as mentioned earlier, to the heating of the feed water.

Then this steam 46, exhausted and cooled in the heater 45, is combined with the “cold” part of the steam 132 obtained at the mass-temperature separation of the steam 129, exhausted in the HPC 42 of the steam 129 turbine. The mass of the combined steam is compressed by compressor 48 and, its first part 134 is directed (as STC rejected energy) to the OTC 117÷120 to generate energy in other internal cycles of the HTPC. For example, in the OTC 117 the steam 135 (a part of the steam 134) is directed to the steam generating unit 49 of the organic fluid of the boiler 50 of the OTC 117 to generate the mechanical energy for the traction air screws 76. And in some ATNPP flight modes, electrical power is generated on electric machine 77, which in these cases is switched to generator mode.

For preliminary or required complete cooling of the cryostat unit (it is not shown in the diagram of FIG. 8) of this machine 77, a part of supercooled air 185 coming out of the unit or cascade of mass-temperature stratification units 72 is used.

The second part of the steam 134, is distributed into parts and directed to other OTCs 118÷120. These distributed parts of steam 134 are shown in the FIG. 8 and marked by positions 137÷139. In this regard, in the OTC 118÷120 mechanical power is also generated for the ATNPP glider traction airs crews and, in some modes electrical power is generated.

The other second part of the steam 136 compressed in the compressor 48 is directed (as STC rejected energy) to the VMTSC 55, from which the condensing water 166 is directed through the decoupling check valve 167 to the feed tank 145 by means of the condensing pump 168.

The mass of steam 60, from which some energy is utilized in the steam generating unit 49 of the boiler 50, is condensed in the inter-cycle condenser 51. Thus, obtaining condensing water 52, the energy of the cold part of the organic fluid steam 59 received from the last stage of the cascade of vortex units 53 and 54 of the OTC is utilized. The condensing water 52 obtained in this way is directed through the condensing pump 142, through the check valve 143 to be used in the STC via the line 144 to the feed tank 145.

Here it should be noted that cooling of inter-cycle condenser 51 is performed locally without heat exchange not with external environment, but from the OTC due to the technology of mass-temperature stratification in units 53 and 54.

Thus, in the proposed HTPC a relatively in-depth integration of mass and heat-exchanging processes of the forward direction and reverse recovery direction is carried out.

Depending on the reasonable parameters of the required load maneuverability of the ATNPP, the duration of operating the plasma neutron source Deuterium Tritium Fusion 26 is regulated by adjusting the duration of reactor 23 operation pulses. Similarly, the operation of reactor 24 is regulated that provides the necessary “maneuverable” value of the output thermal power of reactors 23 and 24. Accordingly, there is a regulation of the steam 146 supply and, by means of the regulating valve 147, its supply to the steam turbine of the STC. In this way the thermal power supplied to the HTPC ATNPP from reactors 23 and 24 is partially regulated. Here, CORRELATION OF SELECTION of the combined vapors 133 from compressor 48, as described above in the disclosure of the invention, is also regulated by means of the regulating valve 140 in the direction of the OTC 117÷120, as well as in the direction of their condensation in the VMTSC 55 of the STC. There, high-efficiency cooling of this VMTSC 55 is carried out by a flow 56 of “highly cold” air by means of a vortex unit 22 of mass-temperature stratification (or a cascade of these units), supplied from confusors 21, from the “incoming” air flow 57 in the ATNPP flight.

In view of the above-described processes, the control system of the HTPC can be “constructed” as a whole and, on the basis of the mathematical model of the system-linked regulation of the energy capacities generated in the STC and OTC.

Organic turbine cycles are realized by using a fluid with the property of low-temperature boiling. In view of the high requirements for aviation technology and on-board nuclear power engineering, here it is advisable to use saturated FLUOROCARBONS, due to their unique physical and chemical properties, despite their relatively high prices. Here, for example, it is appropriate to use PERFLUOROHEPTANE, which has a boiling point of 82.5 degrees Celsius, a critical temperature of 202.5 degrees Celsius and a critical pressure of only 19 atmospheres. In addition, it has a decomposition temperature of over 700 degrees Celsius.

To implement OTC in the proposed invention, the vapors of the organic fluid are directed from the steam generating unit 49 of the boiler 50 of the OTC to the steam heater 58 of this boiler, where these vapors are heated to OVERCRITICAL parameters due to regenerative heat exchange with superheated vapors 174 of the same fluid, which are received as exhaust vapors 175 in the HPC 75 of the organic turbine, at their mass-temperature separation in the cascade of vortex units 53 and 54 of the OTC. Having received the cold parts of organic vapors 59 at the cascade of vortex units 53 and 54, in turn, they are used to condense the vapors in the STC and in the OTC, returning the energy of these vapors to the common HTPC. Thus, one part of the cold vapor 59 is heated with water vapor 60 in the intercycle condenser 51 (STC condenser) using this part of the vapor as a cooling agent. The other coldest part of the vapors 61 of the organic fluid obtained from the first stage of the cascade of vortex units 54 of the OTC is compressed by the compressor 62, aligning its pressure with a part of the cold vapors 63 of the organic fluid, used as a cooling agent and heated in the inter-cycle condenser 51 of the STC. After removing this part of vapors 63 from the condenser 51 through the “decoupling” check valve 148, these two parts of cold vapors are also combined with the vapors 149 exhausted sequentially in the Middle Pressure Cylinder 64 (MPC) and Low-Pressure Cylinder 65 (LPC) of the organic turbine. Then to increase the condensation temperature the whole mass of the three combined vapor parts of the organic fluid is compressed by the compressor 66, and this mass 150 is condensed into a liquid 151 of the working fluid in the OTC condenser 67. This condenser 67 represents an organic cycle cooler evaporator. The OTC cooler operates typically on its own independent refrigerant by means of a compressor 68 driven by an organic cycle turbine and used to compress the vapors 152 of the refrigerant. In this regard, the vapors 152 are compressed to raise their condensation temperature, increasing the efficiency of VMTSC 70. The cooler operates by means of a battery block of thermostatic expansion valves 69 throttling the liquid refrigerant 153 into its gas-droplet 154 cold state and works by means of the VMTSC 70 of the cooler. In turn, it is highly effectively cooled by the flow 71 of “high cold” air through the vortex unit 72 of mass-temperature stratification (or cascade of these units), supplied from confusor 25 from the “incoming” air stream 73 in the ATNPP flight.

From the condenser 67 of the OTC, the organic fluid 151 of the fluid is supplied, by means of the condensing pump 155, to the feed tank 74, from which this fluid, by means of the feed pump 156, is pumped under pressure to the steam generating unit 49 of the boiler 50, heating it up preliminary and sequentially in the preheater/economizer 182 and heater 157 by means of “autonomous” independent coolants 180 and 37, by heat of the vapor 68 of the refrigerant 152 compressed by the compressor 68 and directed for condensation and by heat of the molten salts returned to the reactors 23 and 24 after utilization of the heat of these molten salts in the STC.

Thus, in the OTC from the heat discharged through the cooler to the VMTSC 70, part of this heat is recovered through the cooler 181 and the heater/economizer 182 is recycled back into the cycle, increasing its efficiency. In this case, the degree of heating of the organic liquid 158 in the heater 157 is regulated before supplying it to the steam generating unit 49 by dosing controller 159, in which the independent coolant 37 is supplied by the circulating pump 169.

Organic vapors 160 of supercritical parameters from the steam heater 58 of boiler 50 are operated in the HPC 75 of the organic turbine, regulating their supply to the turbine with the valve 161, and then “these” (exhaust) vapors 175 are subjected to mass-temperature separation in a cascade of vortex units 53 and 54 of the OTC, as it was previously mentioned. Vapors 162, with the removed part of the energy in the steam heater 58 of the boiler 50, are directed to the MPC 64, regulating their supply with the valve 163. Then the vapors 149 exhausted in the LPC 64 are directed for operation in the LPC 65. Thus, the mechanical power is produced on the organic turbine in its cycle.

In some cruising flight modes, depending on reasonable parameters of the required load maneuverability of ATNPP and according to the inventive concept, THE SELECTION CORRELATION OF mechanical energy is REGULATED from organic turbines in “directions” of the ATNPP traction air screws (for example, on the screws 76 in the OTC 117) and in “direction” of power generation for the aero-train, that is, in the generating electric grid of ATNPP. Here the possible “generated excess” of mechanical energy on the shaft of organic turbine of OTC 117 is transferred to the electric machine 77, which is put into generator mode.

The peculiarity of the OTC presented in the HTPC is the necessity of its forced launch. So, for example, the control equipment of the electric machine 77 in the OTC 117 provides the capability of its operation in the propulsion mode, as well as at takeoffs and landings of the ATNPP.

As a result, the structural and functional construction of the proposed HTPC provides a highly efficient conversion of the thermal energy of the onboard nuclear reactors into mechanical one. Relatively small share of thermal energy, discharged into the external environment from the HTPC, is determined by the rejected heat, removed from air condensers of mass-temperature stratification 55 of the STC and the 70 OTC cooler into the environment.

In addition, the HTPC presented in the current invention provides an “external by-product” generation of thermal energy, which is directed to the technical combat against possible icing of the ATNPP glider in flight. This thermal energy is represented by rejected heat—the hot parts of air 164 and 165 flowing out of units 22 and 72 of mass-temperature stratification of incoming air flows 57 and 73.

### INDUSTRIAL APPLICABILITY OF THE HTPC ATNPP INVENTION

The proposed method of constructing the HTPC ATNPP can be effectively applied on board of the ATNPP to provide traction of the ATNPP glider and for power supply of the traction of electrically towed aircraft of the aero-train.

The majority of component units of HTPC ATNPP equipment with a high degree of technical proximity to it as well as those used for its construction according to the presented invention are either already experimentally proven in a number of countries or projects aimed at their improvement are being conducted.

Here one example from [103] is an experimental unit illustrating the application of vortex mass-temperature stratification units as regenerator heaters in the heat-power cycle with intermediate steam superheating.

Another example from [6, No. 3, p. 33 and 12, p. 27] is the use of molten salt nuclear reactors on board of the nuclear-powered aircraft.

### Field of Invention of the ATNPP Maintenance System Originates from its Name and Maintenance there is Performed by Such Technical Component Means as

runway subsystem;
ATNPP positioning subsystem to its point of maintenance;
means of biological radiation protection;
diagnostic control tools;
technologies and equipment for preventive measures and recharging of nuclear reactors with consumable materials and fuel, including their testing and performing preventive and predictive maintenance of the thermal parts of nuclear reactors, incorporating their safety systems;
a subsystem for scheduled heat rejection from non-operating reactors;
subsystems and equipment for preventive measures and preventive and predictive maintenance of onboard thermal power equipment, such as steam generators, turbines, condensers, electrical machines, etc.;
ATNPP on-board battery charging subsystems;
storage facilities for consumables, spare parts and units;
Means of providing maintenance, adjustments and calibrations of ATNPP onboard equipment, including equipment and technologies in terms of preventive procedures, parachute drop component, take-off and booster batteries, and landing of nuclear reactors in severe emergencies;
vehicles for the station maintenance supply and disposal of ATNPP consumables, spare parts and units;
subsystem of organizational and management provision of work flow at the station.

BACKGROUND OF THE INVENTION OF THE ATNPP MAINTENANCE SYSTEMS is determined by their purpose—for maintenance of ATNPP at its takeoff and landing sites both at BASE STATIONS and at LINE/TRANSIT STATIONS, at the latter of which minimal technical maintenance, mainly control and diagnostic, is carried out.

### BACKGROUND OF THE INVENTION

Concerning the application of the proposed invention of the ATNPP MAINTENANCE SYSTEM, it is known from [6, No. 3, p. 34] that a giant hangar for maintenance of nuclear aircraft was built in the state of Idaho, USA.

### Main Essential Features of this Solution

The maintenance station for nuclear aircraft was located on the ground;
A giant hangar was constructed with abnormally thick walls and roof slabs to prevent radioactive radiation from being released outside;
The television systems and remote manipulator systems were to be installed in the hangar in order not to expose the maintenance personnel to intensive radiation, the danger of which would persist even after the reactor was turned off, also because of the delayed neutrons.

Other features of this solution are not known to the authors of the invention.

COMMON FEATURES of [6, No. 3, p. 34] with the proposed invention—MS ATNPP, are all the above-described essential features of the solution [6, No 3, p. 34].

REASONS AND FEATURES PREVENTING from obtaining a technical result in the solution [6, No. 3, p. 34] compared to the invention of the MS ATNPP:
The MS has a loading dock section with a floating pontoon hoist for ATNPP, which is installed on the pontoon platform of this hoist;
The ATNPP after its landing is moved from the runway to the MS by means of transportation on a special running robotic slipway conveyor and the same slipway conveyor is used to transport the ATNPP from the lower level of the loading dock section to the maintenance workshop premises of the ATNPP;
The running robotic slipway conveyor, as a MS component transporting the ATNPP, is equipped with upper side shields and a lower center radiation shield; these shields can be switched by drives to the ATNPP protection positions and to the radiation shield removal positions, for example for extracting nuclear reactors from the ATNPP glider or before the ATNPP takeoff,
To install the ATNPP on or to remove it from its slipway conveyor, there is a hoist for running robotic slipway conveyor on the MS above-ground slipway site;
The enclosing structures of the underground MS slipway site and its reactor rooms are equipped with enhanced radiation protection, including the extendable lock gates of the loading dock section.

From [6, 7, 8, 12, 20, 43] we know the solution for the construction of a nuclear aircraft maintenance station.

### Main Essential Features of this Solution

Subsystems of the Maintenance Station (MS) for nuclear aircraft which are especially dangerous from the point of view of biological radiation protection were located underground;
The reactor of a landing nuclear aircraft was shut down;
The aircraft with the shutdown reactor was towed to the MS, a special base with existing underground facilities;
MS was equipped with a stationary workshop with remote manipulators for maintenance of aircraft reactors and engines;
On the ground part of the MS, the nuclear power system was removed from the aircraft and put down into a deep mine and placed in a room equipped with radiation protection, where it was kept for some time to reduce radiation levels, and then the nuclear unit was technically maintained.

COMMON FEATURES known from [6, 7, 8, 12, 20, 43] with the proposed invention—MS ATNPP, are all the above-described essential features of the solution mentioned [6, 7, 8, 12, 20, 43].

REASONS AND FEATURES PREVENTING from obtaining a technical result in the solution [6, 7, 8, 12, 20, 43] compared to the invention of the MS ATNPP:
The MS has a loading dock section with a floating pontoon hoist for ATNPP, which is installed on the pontoon platform of this hoist;
The ATNPP after its landing is moved from the runway to the MS by means of transportation on a special running robotic slipway conveyor and the same slipway conveyor is used to transport the ATNPP from the lower level of the loading dock section to the maintenance workshop premises of the ATNPP;
The running robotic slipway conveyor, as a MS component transporting the ATNPP, is equipped with upper side shields and a lower center radiation shield; these shields can be switched by drives to the ATNPP protection positions and to the radiation shield removal positions, for example for extracting nuclear reactors from the ATNPP glider or before the ATNPP takeoff,
To install the ATNPP on or to remove it from its slipway conveyor, there is a hoist for running robotic slipway conveyor on the MS above-ground slipway site;
The enclosing structures of the underground MS slipway site and its reactor rooms are equipped with enhanced radiation protection, including the extendable lock gates of the loading dock section.

From [9, p. 70], the solutions for constructing MS of nuclear hydro-airplanes of M-60M type are known. Due to the greatest number of common features of the MS ATNPP invention in comparison with other analogues known to the authors of the invention, the solutions shown in [9, p. 70] are taken as a PROTOTYPE.

### Main Essential Features of this Solution

In general, the location of the MS for M-60M hydro-airplanes is onshore/underground;
Subsystems and units of the MS for nuclear aircraft which are especially dangerous from the point of view of biological radiation protection were located underground;
The M-60M hydro-airplane was landed on the MS takeoff and landing area with already shutdown reactor;
The hydro-airplane was transported by the tow aircraft to the maintenance stations where the nuclear aircraft and its units and reactors were serviced;
Maintenance stations for nuclear aircraft were equipped with remote manipulators;
On the ground part of the MS, the nuclear power system was removed from the aircraft and put down into a deep mine and placed in a quarantine facility that was a room equipped with radiation protection, where it was kept for some time to reduce radiation levels, and then the nuclear unit was technically maintained;
The maintenance station had a quarantine facility that was a place for reducing the radiation activation of turbines and compressors;
The MS included the HYDRAULIC JACK for the M60-M nuclear hydro-airplane;
The MS contained above-ground railroad tracks to a mine with a hoist, which was designed to move the units of the aircraft;
The MS contained an internal transportation subsystem for moving aircraft units to their maintenance facilities and storage rooms;
The MS maintained a warehouse for the safe storage of spare nuclear reactors;
The MS included the checkout stations for aircraft units;
The MS was equipped with test equipment for nuclear engines;
The MS had a warehouse of compressors and turbines to be sent for repair;
The MS had a warehouse of backup nuclear engines.

COMMON FEATURES described in [9, p. 70], that is a prototype, with the proposed invention—MS ATNPP include:
In general, the location of the MS ATNPP is underground;
The ATNPP was moved after landing to the MS with reactors which were already shut down before landing;
The MS ATNPP units, where ATNPP itself, its units and reactors are serviced, are equipped with remote manipulators;
Nuclear reactors were removed from the ATNPP and placed in a quarantine facility that was a room equipped with radiation protection, where it was kept for some time to reduce radiation levels, and then the reactors were technically maintained;
The MS has a loading dock section with the HYDRAULIC JACK for nuclear aircraft;
The MS had a mine with a hoist, which was designed to move the ATNPP units and its nuclear reactors between the MS above-ground and underground parts;
On the above-ground part of the MS ATNPP, the access railroads and roads were arranged to the mine with a hoist, which was designed to move the ATNPP units to and from remote external maintenance services of the ATNPP units and reactors, as well as to supply the MS with new units and reactors instead of the ones that have expired their service life;
The MS contained an internal transportation subsystem for moving ATNPP reactors and units to their maintenance facilities and storage rooms;
The MS had a quarantine facility for the safe storage of the ATNPP spare nuclear reactors and reactors intended to be sent for repair;
The MS has a warehouse of ATNPP units and spare parts, both new and intended to be sent for repair;
The MS is supplied with a set composed of all the checkout stations necessary for the maintenance of ATNPP reactors and units, and of the ATNPP itself as a whole;
The MS was equipped with test equipment for nuclear reactors.

REASONS AND FEATURES PREVENTING from obtaining a technical result in the PROTOTYPE solution [9, p. 70], compared to the invention of the MS ATNPP:
The MS has a loading dock section with a floating pontoon hoist for ATNPP, which is installed on the pontoon platform of this hoist;
The ATNPP after its landing is moved from the runway to the MS by means of transportation on a special running robotic slipway conveyor and the same slipway conveyor is used to transport the ATNPP from the lower level of the loading dock section to the maintenance workshop premises of the ATNPP;
The running robotic slipway conveyor, as a MS component transporting the ATNPP, is equipped with upper side shields and a lower center radiation shield; these shields can be switched by drives to the ATNPP protection positions and to the radiation shield removal positions, for example for extracting nuclear reactors from the ATNPP glider or before the ATNPP takeoff;
To install the ATNPP on or to remove it from its slipway conveyor, there is a hoist for running robotic slipway conveyor on the MS above-ground slipway site;
The enclosing structures of the underground MS slipway site and its reactor rooms are equipped with enhanced radiation protection, including the extendable lock gates of the loading dock section.

### Disclosure of the Invention in the Part of the ATNPP Maintenance System, (MS ATNPP)

The objective to be solved by the invention should be a set of technical means to quickly provide full maintenance of ATNPP after its landing on the ground runway of the airfield and at the same time it should provide complete radiation safety both for the environment surrounding the MS and maximum safety of the infrastructure components of the MS.

The objective of the invention is to build a set of engineering and technical solutions to ensure the implementation of the above-described statement of this objective, while the general direction of this objective is technical safety of ATNPP flights with minimal downtime of ATNPP relative to the flight time of the Nuclear Aircraft Systems of the “Karavan” type.

The technical result of the invention is to ensure a high level of safety of ATNPP maintenance in conjunction with the implementation of all technical maintenance and preventive procedures of ATNPP onboard equipment, including nuclear reactors and ATNPP as a whole, with a minimum ATNPP out-of-flight time.

The proposed solution/invention of the MS ATNPP assumes, as in the prototype, the underground placement of its main components. It also implies an analogy with underground nuclear power plants, where, according to scientific estimates, high radiation safety will be ensured. Thus, nuclear underground tests conducted in the Soviet Union back in the Soviet period showed that ground with reinforced concrete interlocks is a good barrier to penetrating radiation and aerosol dust, [114].

The MS ATNPP is equipped with an above-ground slipway site adjacent to the runway taxiways, and there is a hoist of the ATNPP running robotic slipway conveyor on this site, which is positioned on this hoist and put down to its supporting area to the level of the above-ground slipway site. Afterwards, the landed ATNPP with its shutdown reactors is positioned by an unmanned robotic tow aircraft with its landing gear on the supporting area of the slipway conveyor. Then, the slipway conveyor with the ATNPP installed on it is lifted to the level of the above-ground slipway site using the above-mentioned hoist. At the same time, radiation shields, which are used in the slipway conveyor, are shifted from the horizontal position to the vertical one, thus covering the part of the ATNPP fuselage where the nuclear reactors are located so that the environment around ATNPP is protected from the residual radiation.

Then the slipway conveyor moves the ATNPP installed on it to the pontoon platform of the ATNPP vertical hoist. The ATNPP vertical hoist is an analogue of the floating vertical ship-lift with a loading dock section. In addition, the ATNPP dry hoist can be applied as an option by design analogy as a SYNCROLIFT rope vertical ship-lift, for example [115].

The pontoon platform is pre-installed vertically to the level of the above-ground slipway site by filling the dock section with water by a pump supplying water from the process pool. After that, the water from the loading dock section is pumped into the process pool, and in doing so, the pontoon platform together with the slipway/conveyor and the ATNPP are put down to the level of the underground slipway site.

Then, the extendable lock gates of the dock section are opened, and the ATNPP is moved to the parking position of the ATNPP maintenance workshop by means of the slipway conveyor. The lock gates of the dock section, in which radiation shields are installed, are closed; this also protects the surrounding area of the ATNPP maintenance workshop from residual radiation.

The lower central radiation shield built into the slipway conveyor moves out horizontally, creating openings in the bottom of the ATNPP fuselage for removing the nuclear reactors. Then, these reactors are put down through vertical openings of the slipway conveyor by means of reactor hoists to the level of the reactor rooms of the ATNPP maintenance workshop. And reactors are placed in the quarantine facility by means of reactor conveyors pre-installed on these reactor hoists.

Such a quarantine station is also designed for storing reactors intended to be sent for repair to remote external maintenance services.

After the specified time has expired, the nuclear reactors are moved by means of robotic reactor conveyors to their maintenance stations, including the test equipment for nuclear reactors, where their operation is also checked.

In this case, remote manipulators are used at maintenance stations.

Using the internal MS transportation subsystem, ATNPP units, including onboard power generation equipment, are moved through their test, control and maintenance sites, as well as through storage facilities. At the same time the batteries of the reactor breakers are charged by the EMERGENCY RESPONSE SYSTEM, which can be parachuted along with the reactors.

If required and in accordance with the terms of the technical regulations, the ATNPP onboard equipment, including its reactors and equipment expired of its full-service life, is moved to the MS surface to be sent for repairs to remote external stations and for replacement with new equipment.

For this purpose, a special mine with a load hoist is used, and these reactors and units are sent to remote maintenance stations via the adjacent access railroad tracks and roads. The units and reactors repaired there, as well as new units and reactors and spare parts, are transported along these routes and through the aforementioned mine to the appropriate stations and storage facilities of MS ATNPP.

At the parking position, the ATNPP maintenance workshop rooms charge its onboard batteries to ensure the ATNPP takeoff and possible emergency landing before the launch of the nuclear reactors.

Installing nuclear reactors on the ATNPP and moving the ATNPP to the level of above-ground slipway site is carried out in reverse order to the actions described above.

All technological processes at the MS are controlled remotely from a distant ground control and operation center.

### Essential Features Required to Achieve the Technical Result Providing the Invention

In general, the location of the MS ATNPP is underground;
The ATNPP is landed on the ground MS runway with reactors which were already shut down;
The MS has a loading dock section with a floating pontoon hoist for ATNPP, which is installed on the pontoon platform of this hoist;
The ATNPP after its landing is moved from the runway to the MS by means of transportation on a special running robotic slipway conveyor and the same slipway conveyor is used to transport the ATNPP from the lower level of the loading dock section to the maintenance workshop premises of the ATNPP;
The running robotic slipway conveyor, as a MS component transporting the ATNPP, is equipped with upper side shields and a lower center radiation shield; these shields can be switched by drives to the ATNPP protection positions and to the radiation shield removal positions, for example for extracting nuclear reactors from the ATNPP glider or before the ATNPP takeoff,
To install the ATNPP on or to remove it from its slipway conveyor, there is a hoist for running robotic slipway conveyor on the MS above-ground slipway site;
The MS contained an internal transportation subsystem for moving ATNPP reactors and units to their maintenance facilities and storage rooms;
The MS is equipped with test equipment for nuclear engines.

### All Essential Features of the Invention

In general, the location of the MS ATNPP is underground;
The ATNPP is landed on the ground MS runway with reactors which were already shut down;
The MS has a loading dock section with a floating pontoon hoist for ATNPP, which is installed on the pontoon platform of this hoist;
The ATNPP after its landing is moved from the runway to the MS by means of transportation on a special running robotic slipway conveyor and the same slipway conveyor is used to transport the ATNPP from the lower level of the loading dock section to the maintenance workshop premises of the ATNPP;
The running robotic slipway conveyor, as a MS component transporting the ATNPP, is equipped with upper side shields and a lower center radiation shield; these shields can be switched by drives to the ATNPP protection positions and to the radiation shield removal positions, for example for extracting nuclear reactors from the ATNPP glider or before the ATNPP takeoff,
To install the ATNPP on or to remove it from its slipway conveyor, there is a hoist for running robotic slipway conveyor on the MS above-ground slipway site;
The enclosing structures of the underground MS slipway site and its reactor rooms are equipped with enhanced radiation protection, including the extendable lock gates of the loading dock section;
The MS ATNPP units, where ATNPP itself, its units and reactors are serviced, are equipped with remote manipulators;
Nuclear reactors are removed from the ATNPP and placed in a quarantine facility that is a room equipped with radiation protection, where it was kept for some time to reduce radiation levels, and then the reactors were technically maintained;
The MS has a mine with a hoist, which was designed to move the ATNPP units and its nuclear reactors between the MS above-ground and underground parts;
On the above-ground part of the MS ATNPP, the access railroads and roads are arranged to the mine with a hoist, which are designed to move the ATNPP units to and from remote external maintenance services of the ATNPP units and reactors, as well as to supply the MS with new units and reactors instead of the ones that have expired their service life;
The MS contains an internal transportation subsystem for moving ATNPP reactors and units to their maintenance facilities and storage rooms;
The MS has a quarantine facility for the safe storage of the ATNPP spare nuclear reactors and reactors intended to be sent for repair;
The MS has a warehouse of ATNPP units and spare parts, both new and intended to be sent for repair;
The MS is supplied with a set composed of all the checkout stations necessary for the maintenance of ATNPP reactors and units, and of the ATNPP itself as a whole;
The MS is equipped with test equipment for nuclear reactors.

### Essential Features of the Invention Distinctive from Those of the Prototype

The MS has a loading dock section with a floating pontoon hoist for ATNPP, which is installed on the pontoon platform of this hoist;
The ATNPP after its landing is moved from the runway to the MS by means of transportation on a special running robotic slipway conveyor and the same slipway conveyor is used to transport the ATNPP from the lower level of the loading dock section to the maintenance workshop premises of the ATNPP;
The running robotic slipway conveyor, as a MS component transporting the ATNPP, is equipped with upper side shields and a lower center radiation shield; these shields can be switched by drives to the ATNPP protection positions and to the radiation shield removal positions, for example for extracting nuclear reactors from the ATNPP glider or before the ATNPP takeoff,
To install the ATNPP on or to remove it from its slipway conveyor, there is a hoist for running robotic slipway conveyor on the MS above-ground slipway site;
The enclosing structures of the underground MS slipway site and its reactor rooms are equipped with enhanced radiation protection, including the extendable lock gates of the loading dock section.

### BRIEF DESCRIPTION OF THE DRAWINGS AS APPLIED TO THE DESCRIPTION OF THE MS ATNPP

FIG. 9 shows an enlarged version of a possible configuration of the BASIC MS ATNPP with an underground ATNPP parking area equipped with a built-in hydraulic hoist and a movement subsystem.

### The Best Options for Embodiment of the Invention

The main infrastructure components of the GROUND part of the basic MS ATNPP in FIG. 9 are shown by the positions:
188—above-ground slipway site.
189—Hoist of the running robotic slipway conveyor.
220—Ground remote control and operation center for remote control of ATNPP maintenance processes at the MS.
222—Storage unit for ATNPP slipway conveyors.

The main infrastructural components of the COMMON PURPOSE for the ground and underground parts of the MS ATNPP base in FIG. 9 are shown by the positions:
190—ATNPP slipway conveyor.
191—Passenger hoist of movements between the above-ground and underground parts of the MS.
192—Upper side radiation shields.
193—The pontoon platform of the ATNPP vertical hoist.
194—ATNPP floating pontoon hoist.
195—Dock section water.
196—Loading dock section.
197—Pump.
198—Process pool water.
199—Process pool.
200—Process pool water intake/inlet.
201, 202, 203, 204, 209, 210—Water supply lines from the process pool to the dock section and back.
205, 206, 207, 208—Guide valves for water supply from the process pool to the dock section and back.
212—Extendable lock gates of the loading dock section with installed radiation shields.
214—Lower central radiation shield of slipway conveyor.
221—Soil with radiation protection additives.
223—Passenger hoist shaft of the movement between the above-ground and underground parts of the MS.
226—Dock section water intake/inlet.

The main infrastructure components of the underground part of the basic MS ATNPP in FIG. 9 are shown by the positions:
211—Underground slipway site and its level.
213—ATNPP maintenance workshop rooms.
215—Reactor hoist.
216—Level of the ATNPP maintenance workshop reactor rooms.
217—Reactor conveyor.
218—Quarantine facility for nuclear reactors.
219—Test equipment for nuclear engines.
224—Reinforced radiation shields.
225—Gates with reinforced radiation shields.

In the proposed MS ATNPP solution/invention, the placement of its main components is performed underground. FIG. 9, position 221, shows the soil with radiation protection additives.

The MS ATNPP is equipped with an above-ground slipway site 188 adjacent to the runway taxiways, and there is a hoist 189 of the ATNPP running robotic slipway conveyor 190 on this site, which is positioned on this hoist 189 and put down to its supporting area to the level of the above-ground slipway site 188. Afterwards, the landed ATNPP 1 with its shutdown reactors 23 and 24 is positioned by an unmanned robotic tow aircraft (it is not shown in FIG. 9) with its landing gear on the supporting area of the slipway conveyor 190. Then, the slipway conveyor 190 with the ATNPP 1 installed on it is lifted to the level of the above-ground slipway site 188 using the above-mentioned hoist 189. At the same time, radiation shields 192, which are used in the slipway conveyor 190, are shifted from the horizontal position to the vertical one, thus covering the part of the ATNPP 1 fuselage where the nuclear reactors 23 and 24 are located so that the environment around ATNPP 1 is protected from the residual radiation.

Then the slipway conveyor 190 moves the ATNPP 1 installed on it to the pontoon platform 193 of the ATNPP 1 vertical hoist 194. This vertical hoist 194 is an analogue of the floating vertical ship-lift with a loading dock section.

The pontoon platform 193 is pre-installed vertically to the level of the above-ground slipway site 188 by filling the dock section 196 with water 195 by a pump 197 supplying water 198 from the process pool 199 by means of water intake/inlet 200 and 206 through water lines 201, 202, 203 and 204, through check valves 205 and 206 as well as through three-way valves 207 and 208. After that, the water 195 from the loading dock section 196 is pumped into the process pool 199 by the pump 197 by means of water intake/inlet 226 and 200 through water lines 204, 209, 210 and 201, through check valves 209 and 205 as well as through three-way valves 207 and 208.

And in doing so, the pontoon platform 193 together with the slipway/conveyor 190 and the ATNPP 1 are put down to the level of the underground slipway site 211.

Then, the extendable lock gates 212 of the dock section 196 are opened, and the ATNPP 1 is moved to the parking position of the ATNPP maintenance workshop 213 by means of the slipway conveyor 190. The lock gates 212 of the dock section 196, in which radiation shields are installed, are closed; this also protects the surrounding area of the ATNPP maintenance workshop 213 from residual radiation.

The lower central radiation shield 214 built into the slipway conveyor 190 moves out horizontally, creating openings in the bottom of the ATNPP 1 fuselage for removing the nuclear reactors 23 and 24. Then, these reactors are put down through vertical openings of the slipway conveyor 190 by means of reactor hoists 215 to the level 216 of the reactor rooms 213 of the ATNPP maintenance workshop. And reactors are placed in the quarantine facility 218 by means of reactor conveyors 217 pre-installed on these reactor hoists 215.

Such a quarantine facility 218 is also designed for storing reactors intended to be sent for repair to remote external maintenance services.

After the specified time has expired, the nuclear reactors 23 and 24 are moved by means of robotic reactor conveyors 217 to their maintenance stations, including the test equipment 219 for nuclear reactors 23 and 24, where their operation is also checked.

In this case, remote manipulators are used at maintenance stations.

Using the internal MS transportation subsystem, ATNPP units, including onboard power generation equipment, are moved through their test, control and maintenance sites, as well as through storage facilities (In FIG. 9 the transport subsystem and the mentioned sites and storage facilities are not shown).

If required and in accordance with the terms of the technical regulations, the ATNPP onboard equipment, including its reactors and equipment expired of its full-service life, is moved to the MS surface to be sent for repairs to remote external stations and for replacement with new equipment.

For this purpose, a special mine with a load hoist is used (they are not shown in FIG. 9), and these reactors and units are sent to remote maintenance stations via the adjacent access railroad tracks and roads. The units and reactors repaired there, as well as new units and reactors and spare parts, are transported along these routes and through the aforementioned mine to the appropriate stations and storage facilities of MS ATNPP.

At the parking position, the ATNPP 1 maintenance workshop rooms 213 charge its onboard batteries (they are shown in FIG. 9 by positions 101, 170 and 183).

Installing nuclear reactors 23 and 24 on the ATNPP 1 and moving the ATNPP 1 to the level of above-ground slipway site 188 is carried out in reverse order to the actions described above.

All technological processes at the MS are controlled remotely from a distant ground control and operation center 220.

### INDUSTRIAL APPLICABILITY OF THE MS ATNPP INVENTION

The proposed MS ATNPP construction method can be effectively applied for air high-speed large-capacity transportation of both cargo and passengers with highly flexible logistics.

The majority of component units of MS ATNPP equipment with a high degree of technical proximity to it as well as those used for its construction according to the presented invention are either in operation in a number of countries or projects aimed at their improvement are intensively conducted.

### Field of Invention of the NASK Emergency Response System, (NASK ERS)

The NASK ERS invention relates to the field of aviation with nuclear engines. Application of the NASK ERS invention according to the inventive conception ensures safety of ATNPP and its nuclear reactors in case of severe incidents in the ATNPP flight.

### Background of the Invention Relating to the NASK ERS Invention

Concerning the application of NASK ERS as a part of the proposed invention, the solution described in [6] is known. Here the found solution guarantees a sufficient level of nuclear safety in case of a flight accident. Thus, the reactor together with the primary circuit of the heat exchanger was designed as a separate unit equipped with a parachute system and capable of decoupling from the aircraft at a critical moment and performing a soft landing.

Therefore, even if the aircraft crashed, the danger of radioactive contamination of the area would be negligible, [6].

This developed basic technical solution is accepted as a PROTOTYPE.

The essential FEATURES OF THE PROTOTYPE and, at the same time, the COMMON essential features of the invention with the PROTOTYPE FEATURES:
Availability of heavy radiation protection—nuclear reactor capsule envelope and additional shadow protection;
The reactor together with the primary circuit of the heat exchanger was designed as a separate unit equipped with a parachute system and capable of decoupling from the aircraft at a critical moment and performing a soft landing.

REASONS AND FEATURES PREVENTING from obtaining technical results in the proposed NASK ERS, COMPARED TO THE PROTOTYPE—with the project of the M-60M nuclear aircraft, [9] and, compared to the Flying Nuclear Laboratories designed on the basis of the AN22 Antey aircraft, (No. 01-06 and No. 01-07) and tested under the Aist program”, [6]:
The use of totally safe nuclear reactors on molten salts of an undercritical type in ATNPP;
In case of a severe incident in the ATNPP flight, the NASK Emergency Response System automatically and directively controls the undocking of the NASK aircraft and the ERS “STURMAN” subsystem generates and delivers navigation data to the undocked aircraft to the optimal landing sites on the airfields;
In case of a severe incident in the ATNPP flight, the NASK Emergency Response System controls the targeted parachute and powered paraglider airdrop of nuclear reactors to a relatively long horizontal distance and to optimally safe landing sites for nuclear reactors in a soft manner and with deployment of special systems for reactor shutdown cooling;
The electric power of the ATNPP during the flight provides charging of the onboard accumulators of the ERS BREAKERS built into the engineering dressing of the nuclear reactor structures and, through these breakers the targeted parachute and powered paraglider airdrop of nuclear reactors can be performed, the deployment and reactor shutdown cooling can be carried out, as well as the operation of radio navigation beacons can be realized;
The electric power of the parachute solenoid electric generators, operating from the mechanical energy of the external environment, recharges the onboard accumulators of the ERS BREAKERS during the parachute powered paraglider flight, when the reactors are on the ground surface, or when the landed nuclear reactors are in the water;
In cases of severe incidents at ATNPP, when the Hybrid Thermal Power Cycle (HTPC) equipment cannot ensure the flight of an emergency ATNPP to the nearest MS ATNPP due to the large flight distance, then the ATNPP glider is constructed according to a modular principle and individual modules of the ATNPP glider are mutually undocked and passively parachuted to optimally safe locations;
Emergency shutdown cooling of a nuclear reactor is provided and carried out for a period of time until a special Mobile Emergency Cooling Package (MECP) arrives at the landed reactor. Such packages can be equipped with various means of their delivery to the landed nuclear reactor: by paratroop, helicopter, ground-based of a high cross-country type and water-based, or rocket-based means.

### Disclosure of the Invention in the Part of the NATSK Emergency Response System, (NATSK ERS)

The objective of the invention is to build the NATSK ERS that provides ADVANCE WARNING of disasters. In this regard, the ERS conception is focused on the compensatory safety of TWO TYPES of unlikely flight ACCIDENTS:
A full-scale emergency situation with ATNPP as a whole; in this case there may not be an accident with nuclear reactors, but their parachuting and targeting is mandatory;
Emergency situation with an ATNPP onboard nuclear reactor, or with several nuclear reactors.

IN THE FIRST CASE of severe incident at ATNPP, when the Hybrid Thermal Power Cycle (HTPC) equipment cannot ensure the flight of an emergency ATNPP to the nearest MS ATNPP due to the large flight distance, then the ATNPP glider is constructed according to a modular principle and individual modules of the ATNPP glider are mutually undocked and passively parachuted to optimally safe locations by some analogy to solutions known from [21, 22, 23, 24, 25, 26, 27, 28, 29, 30 [symbol] 116].

At the same time, the NASK ERS automatically and directively controls the undocking of the NASK aircraft and the ERS “STURMAN” subsystem generates and delivers navigation data to the undocked aircraft to the optimal landing sites on the airfields.

In the SECOND CASE, since the onboard nuclear reactors are designed as separate and maximally autonomous MODULES with a primary heat exchanger circuit, the nuclear reactor, or several reactors, is targeted and navigated for landing. The reactor MODULE is dropped down, with decoupling at the second reactor thermal circuit, for example by gravity catapulting, similar to the solutions shown in [117, 118] and using a smartly controlled active traction powered paraglider parachute system, with selecting the landing/splashdown point and providing for a soft landing. Meanwhile, the targeted parachute and powered paraglider flight of the nuclear reactor is applied to a relatively long horizontal distance and to optimally safe landing sites for nuclear reactors in a soft manner and, if necessary, with deployment of special systems for reactor shutdown cooling.

In THIS SECOND case, depending on how many reactor MODULES are dropped, the full or partial undocking of the aero-train aircraft is performed, with their possible resorting based on the prompt generation of updated logistics data by ERS. At the same time, the ERS “STURMAN” subsystem generates and delivers navigation data to the undocked aircraft to the optimal landing sites on the airfields. In addition, the ERS “STURMAN” subsystem generates and delivers, if required, data of the new aero-train construction order to the undocked aircraft. In connection with this data, the aero-train can rearrange itself.

The crestal part of the powered paraglider system of nuclear reactor drop is designed similarly to the configuration of the POWERED PARACHUTE and with an inflatable wing filled with a light safe gas, such as helium.

After the crestal part of the reactor drop system is deployed, the traction propulsion and airend consoles are arranged, and then the reactor MODULE is targeted to a specific landing site. Depending on weather conditions, the drop system is braked horizontally in the estimated proximity of the landing site by controlling the slings and thrust of the propulsion airend units of the system. Then, the inflatable soft landing cushions are deployed vertically in certain proximity of the reactor MODULE to the landing surface and it is additionally braked by soft landing jet engines using the new paste-like propellant mentioned in [119].

The electric power of the ATNPP during the flight provides charging of the onboard accumulators of the ERS BREAKERS built into the engineering dressing of the nuclear reactor module structures. By means of these breakers and drives of controlling the slings and propulsion airend units, the targeted parachute and powered paraglider airdrop of nuclear reactors can be performed, the deployment and reactor shutdown cooling can be carried out, as well as the operation of radio navigation beacons, such as ones described in [120], can be realized.

According to the inventive conception, the slings of the powered paraglider system have built-in solenoid electric generators operating on the mechanical power of the external environment. These electric generators represent electromagnetic solenoids with cores made of high-energy permanent magnets and equipped with springs, through which the linear motion between the electrical coil of the solenoid and the magnetic core is ensured when the dynamic components of the sling tension forces arise.

Dynamic components of the sling tension forces arise due to the presence of non-cyclic aerohydrodynamic pattern of atmospheric air flows during powered paraglider flight, when the reactor is on the ground after landing, or in the water from its possible waves, or in the presence of a stream. In the mentioned aerohydrodynamic pattern, there is almost always low-scale turbulence with properties changing at small length scales. Such turbulent flows exist due to areas of different atmospheric pressure, due to cloud coverage, in mountainous regions, due to the thermal boundaries of forested areas, fields and valleys and on the waterfront. In this regard, we can often observe wind gusts.

In addition, thanks to the solenoid electric generators, a useful energy recovery effect occurs in the traction propulsion unit of the powered paraglider system during active maneuvering of this system by changing the length of its different slings and during maneuvering by changing the thrust of air screws from the electric engines.

Charging of accumulator batteries of the ERS BREAKERS on board of the reactor MODULE is performed from electrical energy of the parachute solenoid electric generators operating from mechanical power of external environment during parachute powered paraglider flight and when the reactor MODULES are on the ground surface, or in the water. After the reactor MODULE is landed, the electric power of the batteries of the ERS BREAKERS is used to support the operation of the nuclear reactor cooling system and work of the radio beacon.

There is a good inventive and design groundwork in the world for the application of parachuting and landing systems in the proposed invention, including those controlled in planning and flight. For example, the Russian Scientific Research Institute of Parachute Design has developed new parachute designs for rescue of objects weighing 53 tons and 70 tons, [121]. And in the nineteen nineties this Institute developed, manufactured, carried out a full cycle of qualification tests and delivered a parachute system for the rescue of the booster of the European launch rocket Arian-5 weighing 40 tons to the customer, the Dutch company FOKKER. Parachute systems were also developed for the Karian capsule for the French company Aerospatiale and for the Express capsule by order of the German company ERNO, [121].

In regard to the inventive decision to use the powered paraglider system in the NASK ERS, it should be noted that, for example, Russia is already developing a cargo parachuting system with low-thrust engines installed to drop the cargo into a given landing area. The system is focused on providing a reduced drop area, [122].

Also one of the solutions that has been implemented for a long time is the U.S. Managed Planning Parachuting Cargo System “ONYX” designed for precise cargo drop, a good engineering groundwork of which is its navigational properties. Here the flight control is performed by means of a control computer (CC) using data from an inertial navigation system corrected by signals from the Space Radio Navigation System (RNS). The control computer processes the following data: ground distance to the landing point, barometer altitude, course, altitude calculated by the RNS, wind speed, rate of descent, ground speed, track line, overflight/underflight to the landing point, slant distance to the landing point and expected time of landing. A three-axis gyroscope, an accelerometer, a magnetometer and a barometric altimeter are used for real-time input data correction for the RNS. A pneumatic power drive is used to control the slings of the ONYX system, [123].

A good scientific and technical groundwork for the construction of NASK ERS include developments in Russia and the United States. For example, Russia is developing multi-purpose parachuting cargo systems for dropping cargo and equipment weighing up to 40 tons in the interests of the Airborne Forces. Parachute systems for dropping super-heavy objects of weapons, military and specialized equipment weighing up to 60 tons are also being developed, [124]. In addition, Russia has experience in creating a parachute system for rescuing rocket units weighing up to 70 tons, [124]. Russia is developing Rocket-Assisted Parachute System (RAPS) for prospective objects of weapon and military equipment of the Airborne Forces weighing 15÷25 tons with a non-contact system of starting the RAPS engines and with automatic correction of their trigerinm altitude, [119]. The Russian Airborne Forces have a PSB-950 parachuting system that provides a payload mass of 13,000 kg, [125]. The American company HDT Airborne Systems created a large parachuting system, GIGAFLY, with a payload of 18,144 kg back in 2008 [126].

The crucial part of the NASK ERS, along with the reactor MODULE dropping processes, is the rejection of the continuously released “residual” heat from the non-operating nuclear reactor—the so-called SHUTDOWN COOLING.

Here, for the SHUTDOWN COOLING task, the specific heat liberation value from the mass of the used nuclear propellant is relatively small due to the application of absolutely safe nuclear reactors on molten salts of undercritical type in ATNPP, significantly facilitating the task.

Both active and passive sub-systems with natural circulation can be used in the shutdown cooling system of the reactor module. The relevance and necessity of implementing the natural circulation of the coolant, which gives a new solution to the problem of safety and survivability of NPPs under unlimited time of external blackout, is recognized by everyone, [127].

Therefore, according to the inventive conception, two heat-reduction converter circuits—one from the active and one from the passive cooling subsystems—are used in the reactor SHUTDOWN COOLING system.

The active subsystem of the nuclear reactor emergency shutdown cooling uses a CRYOSTAT unit with a supply of liquid air, the coolant discharge of which provides the first stage of the shutdown cooling time, when it is heated by the reactor heat release. The compressed air is also used to drive the Micro Turbo-Electric unit and the electricity generated in this way is utilized to recharge the ERS batteries.

In the second stage of the reactor shutdown cooling time, a cooler is used, such as a compression one, the compressor of which is driven by the power of the ERS charged batteries.

Thus, according to the inventive conception, the main active emergency shutdown cooling of a nuclear reactor is carried out for a period of time until a special Mobile Emergency Cooling Package (MECP) arrives at the landed reactor. Such packages can be equipped with various means of their delivery to the landed nuclear reactor: by paratroop, helicopter, ground-based of a high cross-country type and water-based, or rocket-based means, as it is shown in the inventions [128 and 129].

The passive shutdown cooling subsystem uses the effect of the drawing tube depending on its size and the difference between the average air temperature inside the tube and the ambient air temperature, i.e. between the densities of the outgoing air and the ambient atmospheric air. Drawing, or discharging, is the reduction of air pressure in the tube, which contributes to the inflow of air into the area of reduced pressure.

The drawing tube removes heated air from the reactor heat-emitting surfaces and provides ambient air suction. For this purpose, after the reactor MODULE has landed on the ground surface, the channeled air-drawing tube of the passive safety system for shutdown cooling of the non-operating nuclear reactor, which was folded up to that time, is deployed. Such passive shutdown cooling of a landed nuclear reactor using natural air draft, which does not depend on the operation of pumps, [6, 38] is carried out if the energy resource of the active shutdown cooling subsystem is fully exhausted and, before the arrival of a special Mobile Emergency Cooling Package to the landed reactor.

At the same time, the air-drawing tube of the reactor passive shutdown cooling subsystem is held at altitude by electromechanical fixing of its head to the inflatable crestal part of the powered paraglider drop system of the nuclear reactor.

According to the inventive conception, an electromechanical valve/exhauster unit controlled by the onboard computer of the reactor MODULE is built into the head of the air-drawing tube, and due to the operation of this valve/exhauster unit the work of the passive reactor shutdown cooling subsystem is optimized according to safety criteria and the degree of heat generation by the nuclear reactor.

When there is wind or wind gusts, there is an increase in discharging due to the Venturi effect when this element acts as an aeromechanical deflector, which improves the efficiency of the reactor shutdown cooling.

### Essential Features Required to Achieve the Technical Result Providing the Invention

Availability of heavy radiation protection—nuclear reactor capsule envelope and additional shadow protection;
The reactor together with the primary circuit of the heat exchanger was designed as a separate unit equipped with a parachute system and capable of decoupling from the aircraft at a critical moment and performing a soft landing;
The use of totally safe nuclear reactors on molten salts of an undercritical type in ATNPP;
In case of a severe incident in the ATNPP flight, the NASK Emergency Response System automatically and directively controls the undocking of the NASK aircraft and the ERS “STURMAN” subsystem generates and delivers navigation data to the undocked aircraft to the optimal landing sites on the airfields;
The electric power of the ATNPP during the flight provides charging of the onboard accumulators of the ERS BREAKERS built into the engineering dressing of the nuclear reactor structures and, through these breakers the targeted parachute and powered paraglider airdrop of nuclear reactors can be performed, the deployment and reactor shutdown cooling can be carried out, as well as the operation of radio navigation beacons can be realized;
Charging of accumulator batteries of the onboard ERS BREAKERS is performed from electrical energy of the parachute solenoid electric generators operating from mechanical power of external environment during parachute powered paraglider flight and when the reactors are on the ground surface, or in the water;
In cases of severe incidents at ATNPP, when the Hybrid Thermal Power Cycle (HTPC) equipment cannot ensure the flight of an emergency ATNPP to the nearest MS ATNPP due to the large flight distance, then the ATNPP glider is constructed according to a modular principle and individual modules of the ATNPP glider are mutually undocked and passively parachuted to optimally safe locations;

### All Essential Features of the Invention

Availability of heavy radiation protection—nuclear reactor capsule envelope and additional shadow protection;
The reactor together with the primary circuit of the heat exchanger was designed as a separate unit equipped with a parachute system and capable of decoupling from the aircraft at a critical moment and performing a soft landing;
The use of totally safe nuclear reactors on molten salts of an undercritical type in ATNPP;
In case of a severe incident in the ATNPP flight, the NASK Emergency Response System automatically and directively controls the undocking of the NASK aircraft and the ERS “STURMAN” subsystem generates and delivers navigation data to the undocked aircraft to the optimal landing sites on the airfields;
In case of a severe incident in the ATNPP flight, the NASK Emergency Response System controls the targeted parachute and powered paraglider airdrop of nuclear reactors to a relatively long horizontal distance and to optimally safe landing sites for nuclear reactors in a soft manner and with deployment of special systems for reactor shutdown cooling;
The electric power of the ATNPP during the flight provides charging of the onboard accumulators of the ERS BREAKERS built into the engineering dressing of the nuclear reactor structures and, through these breakers the targeted parachute and powered paraglider airdrop of nuclear reactors can be performed, the deployment and reactor shutdown cooling can be carried out, as well as the operation of radio navigation beacons can be realized;
Charging of accumulator batteries of the onboard ERS BREAKERS is performed from electrical energy of the parachute solenoid electric generators operating from mechanical power of external environment during parachute powered paraglider flight and when the reactors are on the ground surface, or in the water;
In cases of severe incidents at ATNPP, when the Hybrid Thermal Power Cycle (HTPC) equipment cannot ensure the flight of an emergency ATNPP to the nearest MS ATNPP due to the large flight distance, then the ATNPP glider is constructed according to a modular principle and individual modules of the ATNPP glider are mutually undocked and passively parachuted to optimally safe locations;
Emergency shutdown cooling of a nuclear reactor is provided and carried out for a period of time until a special Mobile Emergency Cooling Package (MECP) arrives at the landed reactor. Such packages can be equipped with various means of their delivery to the landed nuclear reactor: by paratroop, helicopter, ground-based of a high cross-country type and water-based, or rocket-based means.

### Essential Features of the Invention Distinctive from the Ones of the Prototype

The use of totally safe nuclear reactors on molten salts of an undercritical type in ATNPP;
In case of a severe incident in the ATNPP flight, the NASK Emergency Response System automatically and directively controls the undocking of the NASK aircraft and the ERS “STURMAN” subsystem generates and delivers navigation data to the undocked aircraft to the optimal landing sites on the airfields;
In case of a severe incident in the ATNPP flight, the NASK Emergency Response System controls the targeted parachute and powered paraglider airdrop of nuclear reactors to a relatively long horizontal distance and to optimally safe landing sites for nuclear reactors in a soft manner and with deployment of special systems for reactor shutdown cooling;
The electric power of the ATNPP during the flight provides charging of the onboard accumulators of the ERS BREAKERS built into the engineering dressing of the nuclear reactor structures and, through these breakers the targeted parachute and powered paraglider airdrop of nuclear reactors can be performed, the deployment and reactor shutdown cooling can be carried out, as well as the operation of radio navigation beacons can be realized;
Charging of accumulator batteries of the onboard ERS BREAKERS is performed from electrical energy of the parachute solenoid electric generators operating from mechanical power of external environment during parachute powered paraglider flight and when the reactors are on the ground surface, or in the water;
In cases of severe incidents at ATNPP, when the Hybrid Thermal Power Cycle (HTPC) equipment cannot ensure the flight of an emergency ATNPP to the nearest MS ATNPP due to the large flight distance, then the ATNPP glider is constructed according to a modular principle and individual modules of the ATNPP glider are mutually undocked and passively parachuted to optimally safe locations;
Emergency shutdown cooling of a nuclear reactor is provided and carried out for a period of time until a special Mobile Emergency Cooling Package (MECP) arrives at the landed reactor. Such packages can be equipped with various means of their delivery to the landed nuclear reactor: by paratroop, helicopter, ground-based of a high cross-country type and water-based, or rocket-based means.

### BRIEF DESCRIPTION OF THE DRAWINGS ILLUSTRATING THE CONCEPT OF CONSTRUCTING THE EMERGENCY RESPONSE SYSTEM, (ERS ATNPP)

FIG. 10 shows an external view of the ATNPP onboard nuclear reactor in the phase of its gravity catapulting in an extremely severe emergency situation.

FIG. 11 shows the external view of the ATNPP onboard nuclear reactor in an extremely severe emergency situation, during its parachute and actively targeted landing.

FIG. 12 shows a variant of solenoid electric generator configuration operating in the course of parachute-landed ATNPP reactor and functioning when the reactor is on the ground surface, or in water after it has landed.

FIG. 13 shows an external view of the ATNPP onboard nuclear reactor after its targeted parachute landing on a solid surface and after deployment of the reactor shutdown cooling systems.

FIG. 14 shows an external view of the ATNPP onboard nuclear reactor after its targeted parachute landing on water and after deployment of the reactor shutdown cooling systems.

### The Best Option for Embodiment of Ers Atnpp Invention

As previously mentioned in the description of the ERS ATNPP, the on-board nuclear reactors 23 and 24, otherwise autonomous MODULES, as shown in FIG. 10, for example for reactor 23, can be parachuted, targeted and navigated out of the ATNPP 1—from its reactor block 227. The reactor MODULE, also known as reactor 23, carries out a gravity catapulting downwards, with uncoupling along the second reactor thermal circuit by means of quick-release couplings 110÷112. In this case, the quick-opening valves 79, 80 and 109, shown in FIG. 8, are preliminary locked, thereby preventing the molten salt coolant from leaking out.

Depending on how many reactor MODULES are dropped, the full or partial undocking of the aero-train aircraft, shown in FIG. 3÷7, is performed, with their possible resorting based on the prompt generation of updated logistics data by ERS computing tools. At the same time, the ERS “STURMAN” subsystem generates and delivers navigation data to the undocked aircraft to the optimal landing sites on the airfields. In addition, the ERS “STURMAN” subsystem generates and delivers, if required, data of the new aero-train construction order to the undocked aircraft. In connection with this data, the aero-train can rearrange itself.

The reactor MODULES are dropped down using a smartly controlled active traction powered paraglider parachute system, with selecting the landing/splashdown point and providing for a soft landing. Meanwhile, in the targeted parachute and powered paraglider flight of the nuclear modules the landing can be performed to a relatively long horizontal distance and to optimally safe landing sites for nuclear reactors and with deployment of special systems for reactor shutdown cooling.

The crestal part 228 (FIG. 11) of the powered paraglider system of nuclear reactor drop is designed similarly to the configuration of the POWERED PARACHUTE and with an inflatable wing filled with a light safe gas, such as helium.

After the crestal part 228 of the reactor drop system is deployed from the package 231 of the crestal part, the consoles 229 of traction propulsion and airend units 230 are arranged, and then the reactor MODULE is targeted to a specific landing site.

Depending on weather conditions, the drop system is braked horizontally in the estimated proximity of the landing site by controlling the slings 232 and thrust of the propulsion airend units 230 of the powered paraglider system. Then, the inflatable soft landing cushions 233 are deployed vertically in a certain proximity of the reactor MODULE to the landing surface and it is additionally braked by jet engines 234. Inflatable soft landing cushions 233 also serve as submerged pontoons, which together with the crestal part 228 of the parachute system provide buoyancy of the reactor module at its possible landing on the water, as shown in FIG. 14.

The electric power of the ATNPP 1 during the flight provides charging of the onboard accumulators of the ERS BREAKERS 170 built into the engineering dressing of the nuclear reactor MODULE structure, (see FIG. 8). By means of these breakers 170 and drives of controlling the slings 232 and propulsion airend units 230, the targeted parachute and powered paraglider airdrop of nuclear reactor 23 can be performed, the deployment and reactor shutdown cooling can be carried out, as well as the operation of radio navigation beacon 235 can be realized.

According to the inventive conception, the slings 232 of the powered paraglider system have built-in solenoid electric generators 236. The variant of solenoid electric generator configuration is shown in FIG. 12. Such generators are operating on the mechanical power of the external environment. The electric generator 236 represents the electromagnetic solenoid with a core 237 made of high-energy permanent magnet and equipped with springs 238, through which the linear motion between the electrical coil 239 of the solenoid and the magnetic core 237 is ensured when the dynamic components of the sling tension forces arise.

FIG. 12 shows an enlarged view of the solenoid electric generator 236. Here, positions 247 and 248 show the mounting pads for the electrical coil 239 of the solenoid and its magnetic core 237, to which the slings 232 are attached. The flange 249 holding the electrical coil 239 has an integrated sleeve-type bearing 250 for the magnetic core 237. Position 251 indicates the bellows protective jacket of the electrical generator 236, which is secured by rings 252 and 253 to mounting pads 247 and 248.

Dynamic components of the sling 232 tension forces arise due to the presence of non-cyclic aerohydrodynamic pattern of atmospheric air flows during powered paraglider flight, when the reactor is on the ground after landing, or in the water 246 from its possible waves 245 (FIG. 14), or in the presence of a stream which will also not be uniformly turbulent. In the mentioned aerohydrodynamic pattern, there is almost always low-scale turbulence with properties changing at small length scales. Such turbulent flows exist due to areas of different atmospheric pressure, due to cloud coverage, in mountainous regions, due to the thermal boundaries of forested areas, fields and valleys and on the waterfront. In this regard, we can often observe wind gusts 242, as shown in FIG. 13.

In addition, thanks to the solenoid electric generators 236, a useful energy recovery effect occurs during active maneuvering of the powered paraglider system by changing the length of its different slings 232 and during maneuvering by changing the thrust of propulsion airend units operating from the electric engines of the powered paraglider system.

Charging of accumulator batteries of the ERS BREAKERS 170 on board of the reactor MODULE is performed from electrical energy of the parachute solenoid electric generators 236 operating from mechanical power of external environment during parachute powered paraglider flight and when the reactor MODULES are on the ground surface (see FIG. 13), or in the water (see FIG. 14). After the reactor MODULE is landed, the electric power of the batteries of the ERS BREAKERS 170 is used to support the operation of the nuclear reactor cooling system and work of the radio beacon 235.

The crucial part of the NASK ERS is the rejection of the released heat from the non-operating nuclear reactor—the so-called SHUTDOWN COOLING.

Both active and passive sub-systems with natural circulation can be used in the shutdown cooling system of the reactor module. According to the inventive conception, two heat-reduction converter circuits—one from the active and one from the passive cooling subsystems—are used in the reactor SHUTDOWN COOLING system.

The active subsystem of the nuclear reactor 23 emergency shutdown cooling uses a CRYOSTAT unit with a supply of liquid air, the COOLANT discharge of which provides the first stage of the shutdown cooling time, when it is heated by the reactor heat release. The compressed air is also used to drive the Micro Turbo-Electric unit and the electricity generated in this way is utilized to recharge the ERS BREAKER 170 batteries.

In the second stage of the reactor shutdown cooling time, a cooler is used, such as a compression one, the compressor of which is driven by the power of the ERS BREAKER 170 charged batteries. Thus, the main active emergency SHUTDOWN COOLING of a nuclear reactor is carried out for a period of time until a special Mobile Emergency Cooling Package and appropriate specialists arrive at the landed reactor.

The passive shutdown cooling subsystem uses the effect of the drawing tube depending on its size and the difference between the average air temperature inside the tube and the ambient air temperature, i.e. between the densities of the outgoing air and the ambient atmospheric air.

The drawing tube 240, shown in FIG. 13, removes heated air from the reactor 23 heat-emitting surfaces and provides suction of colder ambient air through the diffuser 241. For this purpose, after the reactor MODULE has landed on the ground surface, the channeled air-drawing tube 240 of the passive safety system for SHUTDOWN COOLING of the non-operating nuclear reactor, which was folded up to that time, is deployed. This deployment is carried out using an electric drive (not shown in figures), which provides upward movement of the drawing tube head 240 along the rope guides 243. At the same time, the air-drawing tube 240 of the reactor 23 passive shutdown cooling subsystem is held at altitude by electromechanical fixing of its head (not shown in figures) to the electromechanical valve/exhauster unit 244 which is installed into the upper point of the inflatable crestal part 228 of the powered paraglider drop system of the nuclear reactor 23.

The electromechanical valve/exhauster unit 244 is controlled by the onboard computer of the reactor MODULE, and due to the operation of this valve/exhauster unit the work of the passive reactor shutdown cooling subsystem is optimized according to safety criteria and the degree of heat generation by the nuclear reactor.

When there are wind gusts 242, or even at constant wind speed, there is an increase in discharging in operation of the air-drawing tube 240 due to the Venturi effect when the valve/exhauster unit 244 acts as an aeromechanical deflector, which improves the efficiency of the reactor shutdown cooling.

Such passive shutdown cooling of a landed nuclear reactor using natural air draft, which does not depend on the operation of pumps, [6, 38] is carried out if the energy resource of the active shutdown cooling subsystem is fully exhausted and, before the arrival of a special Mobile Emergency Cooling Package to the landed reactor.

### INDUSTRIAL APPLICABILITY OF THE ERS ATNPP INVENTION

The claimed NASK ERS construction method can be effectively applied as safety category for air high-speed large-capacity transportation of both cargo and passengers with highly flexible NASK logistics.

The majority of component units of NASK ERS equipment with a high degree of technical proximity to it as well as those used for its construction according to the presented invention are either in operation in a number of countries or projects aimed at their improvement are intensively conducted.

### REFERENCES

1. S. A. Subbotin. THORIUM POWER INDUSTRY—A NEW CHALLENGE FOR RUSSIA?NRC “Kurchatov Institute”, Russia, 2013. http://www.bbc.co.uk/russian/
2. Konstantin Predatchenko. 2040 Conceptual Electric Aircraft: Bauhaus Luftfahrt—“Ce-liner” THE ENCYCLOPEDIA OF MILITARY AIRCRAFT. Published on 9 Oct. 2014 https://vk.com/military_aircraft?w=wall-5111774_167351
3. Daniil Revadze. NASA will build an electric aircraft by spring 2018. Published on 6 Sep. 2016 https://hightech.fm/2016/09/06/x57
4. Yulia Krasilnikova. SIEMENS ELECTRIC AIRCRAFT SETS THE WORLD SPEED RECORD. 05.04.2017 https://hightech.fm/2017/04/05/siemens_speed
5. Georgii Golovanov. The ELECTRIC AIRCRAFT Wright Electric PLANS TO EDGE OUT the Boeing 737. Published on 22 Mar. 2017 https://hightech.fm/2017/03/22/wright-electric
6. V Kudriavtsev, A. Sovenko. [symbol] [symbol] : NUCLEAR AIRCRAFT: future in the past, (article is about nuclear-powered aircraft developed in the United States and the Soviet Union). The Ukrainian aviation magazine «Aviation and Time», 2004, [symbol] 4 (72) p. 16÷20, 35.
7. NUCLEAR AIRCRAFT. AND WHAT DID THE U.S.A. HAVE? Found and sources: 29.08.2013. http://masterok.livejournal.com/1292401.html http://jpcolliat.free.fr/http://nvahof.org/_original_site/convair_x-6.html http://olymp.asclub.ru/publ/arkhiv_rabot/vosmaja_olimpiada_2010_11_uch_god/atomnye_samol ety_proekty_i_letajushhie_laboratorii/26-1-0-175
8. A. Bruk, S. Smirnov, K. Udalov. NUCLEAR AIRCRAFT: UTOPIA OR REALITY. The magazine “Wings of the Motherland”, 2001, No. 12, p. 6-8. Moscow, Russia.
9 A. Grek. RIDING THE REACTOR. The magazine “Popular Mechanics”, 2003, No. 5, p. 66-71. Moscow, Russia.
10. Izmailov A. Y., Marchenko L. A., Godzhaev Z. A., Smirnov I. G., Lichman G. I., Mochkova T. V. A COMPLEX OF AIRCRAFT FOR APPLYING LIQUID CHEMICAL AGENTS IN PRECISION FARMING. Patent of Russia, 21.04.2017. RU 2617163 C1.
11. Izmailov A. Y., Marchenko L. A., Godzhaev Z. A., Smirnov I. G., Mochkova T. V. Patent of Russia on 16 Jun. 2017. RU 2622617 C1. A COMPLEX OF AIRCRAFT FOR DIFFERENTIATED APPLICATION OF LIQUID CHEMICALS.
12. M. Kozyrev, V. Kozyrev. NUCLEAR “HEART” FROM AMERICA. About nuclear aircraft projects. The magazine “Wings of the Motherland”, [symbol] 4, 2002, Moscow, Russia, p. 25÷28.
13. Tim Skorenko. TROJAN HORSES OF WAR, MILITARY GLIDERS. The magazine “Popular Mechanics”, May of 2013, [symbol] 5 (127), p. 106÷110. Moscow, Russia.
14. Found: http://www.airwar. ru/enc/glider/cg4a.html #LTH. [symbol] “Waco CG-4A Hadrian”.
Aviation Encyclopedia “CORNER OF THE SKY”. Gliders, 2004.
15. MILITARY AVIATION. Messerschmitt Me 321 transport glider. Found: http://www.warbirds. ru/samolety_messershmitt_ag/transportnyj_planer_messershmitt_me_321.h tml
16. ON Nov. 26, 1925, THE ANT-4 (TB-1) MADE ITS FIRST FLIGHT. 26.11.2016. Information Center “AfterShock”. https://m.aftershock.news/?q=node/460275. Also in http://xn--80aafy5bs.xn--p1ai/aviamuseum/aviatsiya/sssr/bombardirovshhiki-2/bombard-1920-e-1940-e-gody/tyazhelyj-bombardirovshhik-tb-1/tyazhelyj-bombardirovshhik-tb-1-ant-4/
17. Gorbachev A. D., Mikhailov Y. I., Ivashin A. V. Patent of Russia on 15 Aug. 2017. RU 2628282 C1. JUNCTION NODE OF AIRCRAFT SEPARABLE OBJECTS.
18. Ivanov B. F., Maloi B. S., Novikov R. N., Pechenkin A. A. Patent of Russia on 20 Jan. 1998. RU 2102288. DEVICE FOR CONNECTING ELECTRICAL LINES.
19. Ageev A. M., Volobuev M. F., Zamyslov M. A. et al. Patent of Russia, 14.08.2017. RU 2628043 C1. THE WAY OF PLANE GETTING TO THE LANDING START POINT.
20. N. Aleksandrov. THE BRIEF HISTORY OF THE NUCLEAR AIRCRAFT. Scientific and Technical Magazine “ENGINE”, [symbol] 6(30), 2003. [symbol] 7(31), 2004. Moscow, Russia. [symbol]
21. Tatarenko V. N. AIRCRAFT WITH A DEVICE FOR COLLECTIVE RESCUE OF PASSENGERS AND (OR) CARGO IN CASE OF EMERGENCY. Magazine of the Ukrainian Academy of Sciences, “Inventor and Innovator”. [symbol] 1, 2014, p. 6÷15.
22. Goriachev V. V. A METHOD OF RESCUING THE CREW AND PASSENGERS IN THE EVENT OF AIRCRAFT ACCIDENT IN FLIGHT AT VARIOUS ALTITUDES. Patent of Russia, 26.04.2018. RU 2652477 C1.
23. Zachesov A. L., Mitrofanov I. V. et al. A DEVICE FOR CONNECTING THE SEPARABLE ELEMENTS OF THE AIRCRAFT. Patent of Russia, 11.09.2017. RU 2630565 C2.
24. Dergachev A. A., Gorlashkin A. A. et al. THE SYSTEM FOR SEPARATING THE AIRCRAFT COMPARTMENT. ΠaTeHT Pocc [symbol] , 23.04.2018. RU 2651780 C1.
25. Tatarenko V. N. AIRCRAFT WITH A DEVICE FOR RESCUE OF PASSENGERS AND (OR) CARGO IN CASE OF EMERGENCY. Patent of Russia for a utility model, 27.08.2014. RU 144783 U1.
26. Bertani R. L. AIRCRAFT SECURITY SYSTEM. Patent of Russia, 10.03.2011. RU 2425781 C2.
27. Khusanov K. S. KHUSANOV SPLIT FUSELAGE AIRCRAFT. Patent of Russia for a utility model, 27.04.2003. RU 29032 U1.
28. Khalidov G. Y., Khalidov U. G. AVIATION PASSENGER AUTONOMIC SAFETY CAPSULE. Patent of Russia, 27.07.2001. RU 2171209 C1.
29. Khalidov G. Y., Khalidov U. G. A method for emergency evacuation of aircraft passengers. Patent of Russia, 20.03.2003. RU 2200688 C2.
30. Tsygankov E. E. AEROBUS “LUCY”. Patent of Russia, 15.10.1994. RU 2021164 C1.
31. Kochetov O. S. Patent of Russia, 13.09.2017. RU 2630780 C1. SUBMARINE NUCLEAR REACTOR VIBRATION ISOLATION SYSTEM.
32. Belyaev V. I. Patent of Russia on 10 Feb. 2016. RU 2574295 C2. NUCLEAR-POWERED AEROSPACE AIRCRAFT AND ITS METHOD OF AEROSPACE FLIGHTS.
33. A. V. Zrodnikov, G. I. Toshinsky et al. SMALL POWER MODULAR REACTORS FOR LARGE NUCLEAR POWER ENGINEERING. The magazine “Nuclear Strategy”, No. 16, April 2005. St. Petersburg, Russia.
34. Found: https://mimt. ru/scince/novoe-pokolenie-atomnyh-reaktorov. NEW GENERATION OF NUCLEAR REACTORS (MSR reactors). World of Science and Technology. 28 Jun. 2011. U.S. Pat. No. 9,390,820. Jul. 12, 2016. ELECTRICITY PRODUCTION MODULE.
35. THE USA IS DEVELOPING A REACTOR RUNNING ON NUCLEAR WASTE. MILITARY REVIEW 21.08.2014. MIC NEWS (RUSSIA). FOUND: https://vpk.name/news/116037_v_ssha_razrabatyivayut_reaktor_rabotayushii_na_yadernyih_othodoh.html.
36. Found: https://pikabu. ru/story/reactor_na_rasplavakh_soleymsr_3832020. MOLTEN SALT REACTOR (MSR). 6÷9 Aug., 2016.
37. MOLTEN SALT REACTOR. Material from Wikipedia, the free encyclopedia. https://ru.wikipedia.jrg/wiki/PeaKTop_Ha_ [symbol] _ [symbol] .
38. E. O. Adamov, V. A. Pershukov. Project “BREAKTHROUGH” ROSATOM, 25.05.2016. Russia.
39. N. N. Klimov, N. N. LEAD-BISMUTHAL FAST REACTORS for Nuclear Power Plants of Small and Medium Powers. International Forum “ATOMEXPO 2009”, 26-28 May 2009, Central Exhibition Complex “Expocenter”, Moscow, Russia.
40. V. I. Volkov, I. N. Ostretsov. STRATEGY OF NUCLEAR POWER DEVELOPMENT. Main tools of safe nuclear power development in Russia. ASMO-press Publishing House, Russian Economy in View of the Future, 28.07.2012. 270÷279.
41. I. N. Ostretsov, V. I. Volkov, A. P. Andreev, L. N. Falkovsky, V. V. Chilap. Patent of Russia on 20 Oct. 2004. RU 2238597 C1. METHOD OF CONVERSION OF NUCLEAR ENERGY INTO THERMAL ENERGY.
42. Bykov A. Y., Mosyazh V. M. Patent of Russia, 07.07.2017, RU 2624824 C1. METHOD OF CONVERSION OF NUCLEAR ENERGY INTO THERMAL ENERGY AND DEVICE FOR ITS IMPLEMENTATION, (OPTIONS).
43. V. Volkov is the CEO of the consulting company “CRM Practice”, First Vice-President of the International Moscow Club of Independent Scientists, member of the Nuclear Society of Russia. BUT WHAT ABOUT THE CHERNOBYL DISASTER? People are afraid of it. Found http://pereprava.org/society/448-prizrak-brodit-po-miru-prizrak-posledney-socialnoy-revolyucii.html
44. Bogomolov A. S., Ostretsov I. N. Patent of Russia on 27 Feb. 2011. RU 2413314 C2. METHOD AND COMPLEX OF CONVERTING NUCLEAR ENERGY INTO THERMAL ENERGY.
45. Rubbia Carlo. Patent of Russia on 10 Jan. 2002. METHOD OF POWER GENERATION FROM NUCLEAR FUEL, ENERGY AMPLIFIER FOR IMPLEMENTATION OF THE METHOD, POWER GENERATING UNIT.
46. Carlo Rubbia. U.S. Pat. No. 5,774,514. Jun. 30, 1998. ENERGY AMPLIFIER FOR NUCLEAR ENERGY PRODUCTION DRIVEN BY A PAPTICLE BEAM ACCELERATOR.
47. REACTORS WITH ACCELERATOR DRIVER. LIVEJOURNAL, TNENERGY. Dec. 6, 2016. http://tnenergy.livejournal.com/63810.html
48. J. P. Rivol. AN accelerator-driven system FOR THE DESTRUCTION OF NUCLEAR WASTE. The magazine “Advances in Physical Sciences”, Vol. 173, No. 7, July 2003. Moscow, Russia.
49. Bogomolov A. S., Bakirov T. S. Patent of Russia on Jun. 27, 2000. RU 2152142 C1. METHOD AND DEVICE FOR PRODUCING ACCELERATED CHARGED PARTICLES.
50. A. S. Bogomolov, T. S. Bakirov, P. K. Bogdanov. BACKWARD WAVE ACCELERATORS AS AN ALTERNATIVE TO CLASSICAL SUPERCONDUCTING ACCELERATORS. CJSC Fiztehmed, Scientific and Technical Development Bulletin No. 4 (44), 2011, Moscow, Russia.
51. N. Popova, A. Schmidt. IVAN AND MRIA. The Magazine “OBJECTIV”, No. 01 (24), January 2016. Publisher: International Bureau of Investigative Journalism . . . 20, Medousis street, 6302 Larnaca, Cyprus.
52. Evgenia Olkhovik, Science, 17.01.2017. A NEW HYBRID REACTOR. http://comandir.com/2017/01/17/40759-novyj-gibridnyj-reaktor-na-rasplave-solej.html
53. Pivin I. F. Patent of Russia on 20 Feb. 2013. RU 2475870 C2. REACTOR.
54. Yurin V. E., Egorov A. N. Patent of Russia, 09.01.2018. RU 2640409 C1. METHOD OF NUCLEAR POWER PLANT MANEUVERABILITY AND SAFETY IMPROVEMENT BASED ON THERMAL AND CHEMICAL ACCUMULATION.
55. E. P. Velikhov, M. V. Kovalchuk, E. A. Azizov, V. V. Ignatiev, S. A. Subbotin, V. F. Tsibulsky. HYBRID FUSION REACTOR FOR NUCLEAR FUEL PRODUCTION WITH MINIMUM CONTAMINATION OF THE FUEL CYCLE. National Research Center “Kurchatov Institute”, Moscow, Russia. Oct. 13, 2014.
56. Leonid Popov. HYBRID REACTOR WILL DESTROY THE MOST DANGEROUS NUCLEAR WASTE. Jan. 29, 2009. Found: http://www.membrana. ru/particle/3309
57. B. Kuteyev. HYBRID SYSTEMS FOR RUSSIAN FUSION STRATEGY. Winter School in Roshchino, Petersburg Nuclear Physics Institute, National Research Center “Kurchatov Institute”. 27.02.2014. Roshchino settlement, Leningrad region, Russia.
58. FUSION-FISSION HYBRIDS-AGENTS FOR NUCLEAR ENERGY RESURGENCE—GREENING OF NUCLEAR ENERGY+SUSTAINABLE NUCLEAR FUTURE. CIMPA/ICTP GEOMETRIC STRUCTURES AND THEORY OF CONTROL. 1-2 Oct. 2012. Swadesh M. Mahajan. University of Texas at Austin USA.
59. E. A. Azizov, F. B. Mineev. ON THE LIMITS OF NEUTRON SOURCES COMPACTNESS ON THE BASIS OF TOKAMAK. The magazine “Nuclear Science and Technology Issues”, National Research Center “Kurchatov Institute”, Russia. Fusion Series, 2012, Issue 2, p. 5÷20.
60. E. A. Azizov, G. G. Gladush, V. N. Dokuka, R. R. Khayrutdinov, V. P. Smirnov, A. A. Gostev, A. V. Lopatkin, N. A. Obysov. USE OF COMPACT TOKAMAKS AS NEUTRON SOURCES FOR SOLVING NUCLEAR POWER PROBLEMS. The magazine “Nuclear Science and Technology Issues”, National Research Center “Kurchatov Institute”, Russia. Fusion Series, 2009, Issue 3.
61. GLOBUS-M SPHERICAL TOKAMAK (UNU GLOBUS-M). FEDERAL STATE BUDGETARY SCIENTIFIC INSTITUTION IOFFE PHYSICAL-TECHNICAL INSTITUTE OF THE RUSSIAN ACADEMY OF SCIENCES, ST. PETERSBURG, RUSSIA. Found: http://www.ckp-rf. ru/usu/73569/
62. THE UPGRADED GLOBUS-M2 TOKAMAK WILL START OPERATING IN 2018. PROCEEDINGS OF THE SCIENTIFIC RUSSIA PORTAL, JULY 26, 2017. FOUND: https://scientificrussia. ru/articles/modernizirovannyj-tokamak-globus-m2-zarabotaet-v-2018-godu
63. Handbook edited by V. A. Grigoriev and V. M. Zorin. THERMAL AND NUCLEAR POWER PLANTS. Book 3, “Energoatomizdat”, Russia, Moscow, 1989, p. 577.
64. ITER: VACUUM CHAMBER, DIVERTER, BLANKET. Apr. 5, 2015. http://tnenergy.livejournal.com/2565.html
65. E. Havlicková, W. Fundamenski, M. Wischmeier, G. Fishpool and A. W. Morris. INVESTIGATION OF CONVENTIONAL and Super-X Divertor CONFIGURATIONS OF MAST UPGRADE USING SCRAPE-OFF LAYER PLASMA SIMULATION. The following article appeared in Plasma Physics and Controlled Fusion, Vol. 56, No. 7, July 2014, p/075008.
66. Michael T. Kotschenreuther, Shadesh M. Mahajan, Prashant M. Valanju. U.S. Pat. No. 8,279,994 B2. Oct. 2, 2012. TOKAMAK REACTOR FOR TREATING FERTILE MATERIAL OR WASTE NUCLEAR BY-PRODUCTS.
67. Michael T. Kotschenreuther, Prashant M. Valanju, Swadesh M. Mahajan. United States Patent Application Publication, No.: US 2011/0170649 A1. Jul. 14, 2011. MAGNETIC CONFINEMENT DEVICE WITH ALUMINUM OR ALUMINUM-ALLOY MAGNETS.
68. Laila El-Guebaly, Arthur Rowcliffe, Jonathan Menard and Thomas Brown. TBM/MTM FOR HTS-FNSF: AN INNOVATIVE TESTING STRATEGY TO QUALIFY/VALIDATE FUSION TECHNOLOGIES FOR U.S. DEMO. Department of Engineering Physics, University of Wisconsin-Madison, 1500 Engineering Drive, Madison, Wis. 53706, USA. Published: 11 Aug. 2016.
69. Kernozhitsky V. A., Kolychev A. V. Utility model patent of Russia, 17.08.2017. RU 173179 U1. DEVICE FOR THE PROTECTION OF THE VACUUM CHAMBER WALLS OF THE TOKAMAK REACTOR DIVERTER.
70. Kernozhitsky V. A., Kolychev A. V. Utility model patent of Russia, 17.08.2017. RU 173227 U1. THE DIVERTER DEVICE OF THE TOKAMAK REACTOR.
71. Kuteev B. V., Azizov E. A., Bykov A. S. et al. STEADY-STATE OPERATION IN COMPACT TOKAMAKS WITH COPPER COILS.—Nucl. Fusion, 2011, vol. 51, p. 073013/
72. Alexander Voytyuk. KSTAR TOKAMAK SET A WORLD RECORD IN PLASMA CONFINEMENT. Technomania. Found: https://texnomaniya. ru/na-tokamake-KSTAR-postavili-mirovoiy-record-po-uderzhaniyu-plazmi [symbol] : 2016-12-21
73. TO THE DELIGHT OF THERMONUCLEAR PHYSICISTS—A NEW RUSSIAN TOKAMAK, (DEVICE AND REVIEW OF TOP TOKAMAKS). FOUND: http://www.termoyadu.net/index.php?topic=6.120 [symbol] : Feb. 27, 2017.
74. Tritium in controlled fusion units. Found: http://profbeckman.narod. ru/DisAjizhan.files/Gll.pdf
75. D. V. Yurov, V. V. Prikhodko. HYBRID SYSTEMS FOR POST-BURNUP OF TRANSURANIC WASTE OF NUCLEAR POWER PLANTS: STATE OF RESEARCH AND PERSPECTIVES. The Magazine “Advances in Physical Sciences,” Moscow, Russia. Vol. 184, No. 11, November 2014. p. 1243÷1244.
76. M. Y. Zharkov, A. V. Vertkov, I. E. Lyublinsky. A VERTICAL LITHIUM LIMITER FOR EXPERIMENTS AT T-11M TOKAMAK. JSC “Krasnaya Zvezda”, A. N. Tikhonov Moscow Institute of Electronics and Mathematics, National Research University “Higher School of Economics”, Moscow, Russia. Proceedings of XXII International Conference “Radiation Physics of Solid State”, 2012, Sevastopol, Ukraine, p. 316÷323.
77. V. B. Lazarev, S. V. Mirnov, et al. STUDY OF PECULIARITIES OF LITHIUM CIRCULATION NEAR THE T-11M LITHIUM LIMITER USING AN ADDITIONAL LIMITER COLLECTOR RING. Proceedings of the XV Conference on Plasma Surface Interaction. Moscow, Russia. National Research Nuclear University “MEPhI”, Feb. 2÷3, 2012. p. 48÷54.
78. First experiments with lithium limiter on FTU/M. L. Apicella [et al.]//J. Nucl. Mater. V. 363÷365.2007. P. 1346÷1351.
79. Mirnov S. V., Evtikhin V. A. Application of Ga and Li as a LIMITER MATERIAL IN T-3M and T-11M TOKAMAKS. The magazine “Nuclear Science and Technology Issues”. Fusion Series. 2005. Issue 4. p. 3÷18.
80. Poltavets M. A. Patent of Russia on 20 Jan. 2016. RU 2572841 C2. A METHOD FOR INCREASING THE EFFICIENCY OF LASER FUSION ENERGY CONVERSION AND A DEVICE FOR ITS IMPLEMENTATION.
81. Y. A. Chivel. Patent of Russia, Sep. 10, 2012. RU 2461083 C2. METHOD OF ABSORPTION OF LASER FUSION ENERGY AND DEVICE FOR ITS IMPLEMENTATION.
82. Nesterov A. V., Niziev V. G. Patent of Russia, 20.11.2001. RU 2176132 C2. METHOD OF PLASMA LASER HEATING.
83. James C. Hedstrom. U.S. Pat. No. 3,762,992. Oct. 2, 1973. LASER-DRIVEN FUSION REACTOR.
84. Found: http://www.dogswar. ru/voennyi-flot/podvodnye-lodki/7282-atomnye-podvodnye-lo.html 11.07.2014. NUCLEAR SUBMARINES OF PROJECTS 627 AND 627A, (USSR).
85. A. V. Karpenko. LARGE MISSILE SUBMARINE OF PROJECT 651E WITH AUXILIARY POWER UNIT (APU). The magazine of the defense-industrial complex “Military-technical collection BASTION”. 22.06.2017. Internet—edition, Russia. Found athttp://bastion-karpenko. ru/project-651e/
86. PROJECT 651 SUBMARINES. MODIFICATION 651E Material from Wikipedia, the free encyclopedia. https://en.wikipedia.org/wiki/Juliett-class_submarine.
87. V. A. Khrustalev, D. O. Bashlykov, A. A. Simonyan. Patent of Russia on 2602649 C2. STEAM-TURBINE NUCLEAR POWER PLANT.
89. Ohad Zimron, Gan Yavne; Danny Batscha, Ramat Hascharon. U.S. Pat. No. 6,960,839 B2. Nov. 1, 2005. METHOT OF AND APPARATUS FOR PRODUCING POWER FROM A HEAT SOURCE.
90. B. G. Ganchev, L. L. Kalishevsky, R. S. Demeshev, et al; Under general editorship of N. A. Dollezhal. 2nd edition. NUCLEAR ENERGY STATIONS: Textbook for Higher Education Institutions. “Energoatomizdat, 1990. Moscow, Russia.
91. Sevastyanov V. P. METHOD FOR THE PSEUDO-DETONATED GASIFICATION OF COAL SLURRY IN A COMBINED CYCLE “ICSGCC” Patent of Russia, 2011. RU 2433282.
92. D. P. Gokhstein. ON THE THERMAL CYCLE OF NUCLEAR POWER PLANTS. Physics and Heat Engineering of Reactors. Supplement No. 1 to the magazine “Nuclear Power” dated 1958. ATOMIZDAT. Moscow, Russia. p. 198.
93. Zaryankin A. E., Arianov S. V., Zaryankin V. A., Rogalyov N. D. Patent of Russia, 10.10.2008. RU 2335641 C2. METHOD OF INCREASING EFFICIENCY AND CAPACITY OF A TWO-CIRCUIT NUCLEAR POWER PLANT.
94. V. A. Khrustalev, Z. Y. Novikova, A. S. Naumov. Patent of Russia, 10.08.2012. RU 2489574 C1. A COMBINED CYCLE GAS TURBINE ON THE BASIS OF A NUCLEAR POWER PLANT.
95. Aminov R. Z., Egorov A. N. Patent of Russia, Jul. 13, 2018. RU 2661231 C1. METHOD OF HYDROGEN SUPERHEATING OF STEAM AT A NUCLEAR POWER PLANT.
96. Aminov R. Z., Bayramov A. N. Patent of Russia, 28.08.2011. RU 2427048 C2. HYDROGEN COMBUSTION SYSTEM FOR STEAM-WATER SUPERHEATING OF FRESH STEAM IN THE CYCLE OF A NUCLEAR POWER PLANT.
97. Steam Organic Rankine Cycle (SORC) for Distributed Generation and Combined Heat and Power Production/Y. Chudnovsky, M. Gotovsky, M. Greenman et al.//Proc. Of IHTC-14 (IHTC-14-22704). Washington, 2010.
98. Gafurov Ayrat Maratovich. Patent of Russia on 10 Jun. 2015. RU 2552481 C1. METHOD OF OPERATION OF A THERMAL POWER PLANT.
99. THERMAL POWER ENGINEERING AND HEAT ENGINEERING. BOOK 2. EDITED BY V. A. GRIGORIEV AND V. M. ZORIN. THEORETICAL FOUNDATIONS OF HEAT ENGINEERING. THERMOTECHNICAL EXPERIMENT. REFERENCE BOOK. MOSCOW, “ENERGOATOMIZDAT”, 1988.
100. Jay D. Wethe; William M. Waters. U.S. Pat. No. 3,971,211. Jul. 27, 1976. THERMODYNAMIC CYCLES WITH SUPERCRITICAL CO₂ CYCLE TOPPING.
101. James Jun Xu, Albert Andreas Scharl, Shamim Imani. United States, Patent Application Publication, Number US 2013/0168972 A1. Jul. 4, 2013. WASTE HEAT RECOVERY SYSTEMS. And also Grant U.S. Pat. No. 8,984,884. Publication date Mar. 24, 2015.
102. Gafurov Ayrat Maratovich. Patent of Russia on 10 Jul. 2015. RU 2555597 C1. METHOD OF OPERATION OF A THERMAL POWER PLANT.
103. SMIRNOV L. N. PATENT OF RUSSIA ON 27.04.1997. RU 2078253 C1. A METHOD OF CONVERTING THE THERMAL ENERGY OF AN EXTERNAL SOURCE INTO MECHANICAL WORK.
104. THERMAL POWER ENGINEERING AND HEAT ENGINEERING. BOOK 3. EDITED BY V. A. GRIGORIEV AND V. M. ZORIN. THERMAL AND NUCLEAR POWER PLANTS. HANDBOOK. MOSCOW, ENERGOATOMIZDAT, 1989.
105. U.S. Pat. No. 1,952,281. Mar. 27, 1934. METHOD AND APPARATUS FOR OBTAINING FROM A FLUID UNDER PRESSURE TO CURRENTS OF FLUIDS AT DIFFERENT TEMPERATURES.
106. A. P. Merkulov. VORTEX EFFECT AND ITS APPLICATION IN ENGINEERING. “Engineering”, Moscow, 1969.
107. Martynov A. V. WHAT IS THE VORTEX TUBE? Moscow, “Energy”, 1976.
108. Kovalev L. K., Kovalev K. L., Koneev S. M.-A., Penkin V. T., Poltavets V. N., Ilyasov R. I., Dezhin L. S. Electrical Machines and Devices Based on High-Temperature Superconductors. Russia, Moscow: FIZMATLIT, 2010.
109. RUSSIAN PHYSICISTS HAVE SYNTHESIZED SUPERCONDUCTORS OF A NEW GENERATION. 29.07.2013. https://ria. ru/20130729/952733606.html
110. A RUSSIAN PHYSICIST HAS FOUND OUT HOW TO CREATE A “ROOM” SUPERCONDUCTOR. 07.11.2016. https://ria. ru/2016.11.07/1480828218.html
111. SCIENTISTS AT THE CENTRAL AEROHYDRODYNAMIC INSTITUTE OF RUSSIA (TSAGI) ARE ENGAGED IN RESEARCH OF AIRCRAFT ENGINES WITH THE EFFECT OF SUPERCONDUCTIVITY. 18.09.2018. https://riamo. ru/article/312313/uchenye-tsagi-zanimayutsya-issledovaniem-aviatsionnyh-dvigatelej-s-effektom-sverhprovodimosti.xl
112. TESTS OF AN AIRCRAFT ELECTRIC ENGINE ON SUPERCONDUCTORS WERE SUCCESSFULLY CONDUCTED. 11.02.2019. https://promvest.info/ru/tehnologii-i-oborudovanie/tsiam-uspeshno-provel-ispyitaniya-sverhprovodnikovogo-elektrodvigatelya/
113. SUPERCONDUCTOR ON BOARD: A POWERFUL ELECTRIC AIRCRAFT ENGINE HAS BEEN CREATED AT THE MOSCOW AVIATION INSTITUTE (MAI). 26.02.2019. https://zen.yandex. ru/media/id/5aded8b748c85ece27e530dd/sverhprovodnik-na-bortu-v-mai-sozdali-moscnyi-elektricheskii-aviadvigatel-5c6fcff803b2f900af5bdcce
114. Pavel Andreev. REACTOR UNDERGROUND. The newspaper “Energy and Industry of Russia” [symbol] 22 (138), November, 2009. NEW TECHNOLOGIES.
115. SYNCROLIFT rope vertical ship-lift: https://www.youtube.com/watch?v=E2IpngG117g
116. Prokhorov D. A., Korshikov N. V. et al. PYROTECHNIC FASTENER. Patent of Russia, 11.04.2017. RU 2655978 C1.
117. Golovko K. I. Application of Russia for the invention of 17.05.2017. RU 2017103885. GRAVITY CATAPULTING.
118. Vekhov A. S., Zyryanov A. S., Kuzoro V. I. Patent of Russia on 9 Jan. 2018. RU 2640498 C2. METHOD OF PAYLOAD SEPARATION TAKING INTO ACCOUNT THE POWER OF A SPRING PUSHER.
119. A. V. Karpenko 2014÷2019. ROCKET-ASSISTED PARACHUTE SYSTEM PRSM-925 “REAKTABP”. DOMESTIC WEAPONS AND MILITARY EQUIPMENT. http://bastion-opk. ru/prsm-925
120. S. E. Zelensky, A. N. Kozyrev, P. I. Ermakov. SIGNAL DEVICE FOR MARKING THE AIRCRAFT ACCIDENT SITE. Patent of Russia, 06.12.2017. RU 2637712 C1.
121. Found: http://rostec. ru/news/1700. The Celestial Dome. A living history from a sheet tent to space advances. Apr. 19, 2013.
122. Salopakhin S. K., Trushlyakov V. I. et al. ENSURING RESCUE OF PAYLOAD ELEMENTS AT ENTRY INTO THE ATMOSPHERE AT HYPERSONIC VELOCITY. Collection of abstracts of the conference “Innovations in Aviation and Cosmonautics—2015”, p. 239÷240. Publishing house LLC “Print-salon”, 2015. St. Petersburg, Russia.
123. C. Prokofiev. THE ONYX AMERICAN PARACHUTE SYSTEM. Foreign Military Review, No 5, 2007. Magazine of Russia. p. 46÷51.
124. B. Popov, S. Antonov. HERE THE PARACHUTES ARE DESIGNED AND TAUGHT TO FLY. AVIA PANORAMA magazine, [symbol] 1, 2013. Russia.
125. Robotics, Cosmonautics. Systems for soft landing of the first stage of the launch rocket. https://harb.com/ru/post/193810/
126. Alex Alexeev. A PINPOINT DROP FROM THE AIR. MILITARY REVIEW, ARMIES OF THE WORLD. RUSSIA. Apr. 9, 2014. https://topwar. ru/43327-tochnaya-vybroska-s-vozduha.html
127. Blagoveshensky A. Y. Current State and Perspectives of Nuclear Power Engineering Development in Russia. Kurchatov Readings of A. P. Alexandrov Scientific Research Institute, 03.04.2013. On Nuclear Power Engineering in Russia in the Year of its Big Anniversary. Interview, 23.09.2014. Sosnovy Bor, Leningrad region, Russia. http://www.proatom. ru/modules.php?name=News&file=article&sid=5543.
128. O. G. Pilyavets, A. S. Budanov, S. S. Novikov. METHOD OF CARGO TRANSPORTATION. Patent of Russia, 04.07.2018. RU 2660087 C1.
129. Leonov A. G., Blagov A. V. et al. Patent of Russia, 19.04.2018, RU 2651350 C1. METHOD OF OPERATIVE DELIVERY OF MEANS OF RESCUE TO PEOPLE IN DISTANT AREAS WITH INACCURATELY KNOWN COORDINATES AND MISSILE COMPLEX OF OPERATIVE DELIVERY OF MEANS OF RESCUE.

1-20. (canceled)

21. Nuclear Aircraft Transportation System “Karavan” (NATS KARAVAN) represents an INFRASTRUCTURE COMPOSED OF OBJECTS, together providing fast and long-distance multi-tonnage air transportation with highly flexible logistics and maintaining these OBJECTS in a proper technical and organizational condition, and is formed by the AERO-TRAIN in which the following aircrafts are used: the unmanned drone nuclear tow aircraft representing a flying Aircraft Thrust Nuclear Power Plant (ATNPP), which generates in the course of flights the grid electric power for the whole AERO-train, in which towed aircraft are flying due to ATNPP electric power and can take off and land independently using their electric engines and on-board accumulators; the aircraft can independently dock in the air to the tow aircraft and to other electric airplanes of the AERO-TRAIN; LOGISTICS of AERO-TRAIN application is LIMITLESS, due to the possibility of sorting towed aircraft during its flight, namely due to the ability to undock one or another towed aircraft from any place in the AERO-TRAIN, as well as due to the opportunity to insert “new” aircraft, at any place in the aero-train in the air; in the NATS KARAVAN, the airfield facilities for maintenance of electric aircraft OF AERO-TRAINS are used as infrastructure units, including the charging of their batteries; the ATNPP has the ability to stay in the air for longer periods of time in comparison to the capabilities of aircraft using conventional JP fuels; the ATNPP has nuclear reactors on board, which are equipped with radiation protection, mostly shadow protection, and its glider is constructed according to a modular principle and individual modules of the ATNPP glider can be passively targeted and parachuted in case of severe incidents; in the ATNPP the totally safe nuclear reactors on molten salts of an UNDERCRITICAL type are applied; in ATNPP the external in-flight active devices are used, such as electrical cables, feeders and bars ensuring in-flight transmission of electrical power to towed electric aircraft over sufficient distances in relation to their radiation safety; in case of a severe incident at ATNPP, the targeted parachute and powered paraglider airdrop of nuclear reactors is applied to optimally safe landing sites for nuclear reactors in a soft manner with deployment of special systems for non-operating reactor shutdown cooling; the NATS KARAVAN also contains Hybrid Thermal Power Cycle (HTPC ATNPP), applied as an invention embedded in the ATNPP invention, by which ATNPP on-board mechanical and electrical power and grid electricity for the AERO-TRAIN are generated; the HTPC ATNPP is designed as a binary cycle with steam-turbine cycle—STC and with a low-boiling fluid cycle, organic turbine cycle—OTC; a peculiarity of the HTPC ATNPP is the application of vortex mass-temperature stratification units to improve the intermediate superheating of vapors in the STC and the OTC, as well as to increase the efficiency of cycles in the processes of vapor condensation during the discharge of thermal energy into the external environment that is ensured by using the incoming airflow in the ATNPP flight with its additional overcooling through air-cooled vortex units—Mass-Temperature Stratification Condensers (MTSC); in the HTPC ATNPP more than one undercritical nuclear reactor on molten salt is applied, and the binary cycle of the HTPC ATNPP is performed with several and parallel working second circuits of the OTC; in order to improve the mass-dimensional parameters of the HTPC ATNPP equipment, the ATNPP on-board electric machines are used based on high-temperature superconductors; the Nuclear Aircraft Transportation System Karavan uses the Emergency Response System of the Nuclear Aircraft System Karavan, (NASK ERS); in case of a severe incident in the ATNPP flight, the ERS automatically controls the undocking of the AERO-TRAIN aircraft and the ERS “STURMAN” subsystem generates and delivers navigation data to the undocked aircraft to the optimal landing sites on the airfields; the nuclear reactors together with the primary circuits of the heat exchangers are designed as a separate units equipped with parachute systems and capable of decoupling from the aircraft at a critical moment; at the same time the ERS controls the targeted parachute and powered paraglider airdrop of nuclear reactors to optimally safe landing sites for nuclear reactors in a soft manner and with deployment of special systems for reactor shutdown cooling; the electric power of the ATNPP during the flight provides charging of the onboard accumulators of the ERS BREAKERS built into the engineering dressing of the nuclear reactor structures and, in addition, the electric power of the parachute solenoid electric generators recharges the onboard accumulators of the ERS BREAKERS; in cases of severe incidents at ATNPP, when the HTPC equipment cannot ensure the flight of an emergency ATNPP to the nearest MS ATNPP due to the large flight distance, then the ATNPP glider is constructed according to a modular principle and individual modules of the ATNPP glider are mutually undocked and passively parachuted to optimally safe locations; special distributed Mobile Packages are created as part of the ERS ATNPP for handling emergency dropped nuclear reactors, including their shutdown cooling and transportation; the arrival of such Mobile Packages to the landed nuclear reactor is performed by paratroop, helicopter, ground-based of a high cross-country type and water-based, or rocket-based means.

22. The AERO-TRAIN NATS is composed of the TOWING “Tiagach-aircraft” and the towed gliders of up to 10 units, the takeoff and flight of which is provided by the mechanical thrust of the “Tiagach-aircraft”, and the landings of the gliders are independent in sequence from the last glider in flight to the first one, with their detaching from the tow cables according to this sequence and, at the same time the landings of gliders are performed without forced thrust, due to aerodynamic properties of these gliders, is distinguished by the fact that as a part of AERO-TRAIN aircraft the towing airplane is used, which is an unmanned aircraft representing a Nuclear Power Plant (NPP), with nuclear reactors on the molten salts, and towed aircraft are flying due to electric power generated in the onboard NPP, from thermal energy of nuclear reactors on molten salts, and they can take off and land independently using their electric engines and onboard accumulator batteries; thus the aircraft can dock to the tow airplane in the air; the number of towed aircraft in the aero-train is up to several dozens; the towed aircraft have high carrying capacity and unlimited delivery range to their landing sites by using the energy of nuclear reactors on molten salts, and at the same time the high flight speeds of aero-trains are ensured, like those of modern airplanes; the logistics of aero-train application is limitless, due to the possibility of sorting towed aircraft during its flight, namely due to the ability to undock one or another towed aircraft from any place in the aero-train, as well as due to the opportunity to insert “new” aircraft, at any place in the aero-train in the air.

23. THE AERO-TRAIN OF CLAIM 22 is distinguished by the fact that forming an aero-train, electrically towed aircraft can be lined up not only behind the ATNPP in flight, but also as over-flight ones in relation to the ATNPP, i.e. ahead of it.

24. THE AERO-TRAIN OF CLAIM 22 is distinguished by the fact that to form the AERO-TRAIN with a large number of towed aircraft, the number of nuclear reactors in the composition of the AERO-TRAIN is increased—several ATNPP are used, with the ability to attach and detach them to the AERO-TRAIN during the flight route of the AERO-TRAIN.

25. THE AERO-TRAIN OF CLAIM 22 is distinguished by the fact that during its flight, the towed aircraft are provided with electric power from the ATNPP thanks to the use of nuclear reactors not only to create in-flight thrust of the aero-train aircraft, but also to recharge their onboard batteries, which are discharged during takeoffs.

26. Aircraft Thrust Nuclear Power Plant (ATNPP)—several engines are used in the ATNPP glider construction, where the nuclear reactor is installed that is the source of thermal energy used to generate thrust in flight cruising modes, while the nuclear reactor on molten salt is applied and a closed type propulsion system is used (when no atmospheric air is blown through the nuclear reactor), and traction engines with air screws are driven by steam turbines; the aircraft has the ability to stay in the air for longer periods of time in comparison to the capabilities of aircraft using conventional JP fuels; the energy generated by a nuclear reactor is applied only for cruising flights, (when take-offs and landings of nuclear aircraft are performed by other on-board energy sources); alternatively, unmanned operation of a limited format is used, where the atomic aircraft could be controlled remotely by an electrical cable from a special manned aircraft/glider that could be mechanically towed behind the atomic aircraft; the on-board Auxiliary Power Units (APUs) are applied in the aircraft, equipped with heavy radiation protection, mostly shadow protection, is distinguished by the fact that the ATNPP glider is constructed according to a modular principle and individual modules of the ATNPP glider can be passively targeted and parachuted in case of severe incidents; the ATNPP glider structure has relatively high aerodynamic maneuverability and maneuverability of traction engines in terms of their acceleration response relative to ATNPP hybrid drives based on the mechanical power of steam turbines combined with the booster use of electric vehicles; the use of more than one on-board nuclear reactor increases the reliability of the power supply of ATNPP as a whole and raises energy maneuverability in cruising modes; totally safe nuclear reactors are applied on molten salts of an undercritical type, driven by a proton accelerator for pulsed control of several on-board nuclear reactors, through proton beam deflection devices to one or the other reactor; in flight, the ATNPP, by means of one or more electric turbine-generator units, produces grid electrical power; in ATNPP the external in-flight active devices are used, such as electrical cables, feeders and bars ensuring in-flight transmission of electrical power to towed electric aircraft over sufficient distances in relation to radiation safety; in some cruising flight modes, the possible “excess” of mechanical energy on the shafts of the organic steam generating units that drive the ATNPP air traction screws is transferred to the electric machines, which are switched from motoring modes to generating ones, and the electrical power generated in this way is directed to the ATNPP generating electric grid; in ATNPP, rejected heat from heat and power cycles of electric power generation is used in engineering solutions to combat icing in flight of its glider; in ATNPP the unmanned control of its take-offs, flights and landings is applied as well as of maneuvering during dockings and undockings with towed electric aircraft, piloted not only by crews of towed aircraft, but also by their own autopilot and remote control from the ground; in case of a severe incident at ATNPP, the targeted parachute and powered paraglider airdrop of nuclear reactors is applied to a relatively long horizontal distance and to optimally safe landing sites for nuclear reactors in a soft manner and, if necessary, with deployment of special systems for reactor shutdown cooling.

27. The ATNPP of claim 26 is distinguished by the fact that landing gear and glider design of ATNPP could ensure take-off and landing using not only the hard surface of the runway, but also the water surface.

28. The ATNPP of claim 26 is distinguished by the fact that control of on-board undercritical reactors is performed from a single source of neutrons, the compact fusion reactor, due to the properties of “ultrafast” neutrons penetration through special transit structural elements of fission reactors, which have low neutron absorption properties.

29. The ATNPP of claim 26 is distinguished by the fact that the design placement of the reactor units on board of the ATNPP is carried out in vibration insulation supporting nodes.

30. The ATNPP of claim 26 is distinguished by the fact that turbojet engines without screws based on evaporation of liquid air are used for realization of “propulsion function” on ATNPP and if a cryogenic unit is installed on board of ATNPP liquefying air, the liquid air can be used during its expansion as a source of mechanical energy during ATNPP takeoffs and landings.

31. The ATNPP of claim 26 is distinguished by the fact that expansion of liquid air is used to generate the part of grid-wide power.

32. The ATNPP of claim 26 is distinguished by the fact that in the version of its glider design as an amphibious aircraft, the ATNPP movement is performed along the seaway of the airfield structure for positioning to and from the MS dock/hangar, ATNPP is equipped with an integrated unmanned pilot navigation system for its interactive collaboration when towing ATNPP by robotic sea tugs.

33. Hybrid Thermal Power Cycle of the Aviation Thrust Nuclear Power Plant (HTPC ATNPP), in which three different fluids are used and the system is constructed as a binary cycle with a steam-water first circuit (steam-turbine cycle—STC) and with a low-boiling fluid in the second circuit (organic turbine cycle—OTC); Here the thermal power discharged from the STC is utilized mainly in the second circuit and can also be partially discharged into the external environment; thermal energy of the heat source is transferred both to the first circuit of the binary cycle—to the STC, and to the second circuit of the binary cycle—to the OTC; meanwhile, the STC is carried out according to the Rankine cycle with intermediate superheating of vapor, and regenerative heating of feed water by means of an independent coolant is carried out using heat from the LPC; to achieve the highest efficiency of the STC, the supercritical parameters of the fluid are created from the heat source transmitted to the superheater of the STC and thus additional superheating of the fluid is carried out; in order to improve the efficiency of the OTC, the vapors exhausted in the medium pressure cylinder (MPC) and the low pressure cylinder (LPC) are compressed, as well as the cold part of the vapors obtained from the separation of vapors in the cascade of ADIABATIC VORTEX UNITS of the OTC from the vapors exhausted in the HPC and compressed after their discharge from the HPC; in addition, these combined vapors are supplemented (before their compression) with preheated vapors from the inter-cycle condenser of the STC, which are formed and flow out as overcooled from the adiabatic vortex cascade of the OTC mass-temperature stratification; this compression ensures that the condensation temperature of the OTC fluid vapors is increased; the thermal energy is discharged by the vapors directed to the OTC from the STC, after their utilization in the OTC these fluid vapors of the first circuit of the binary cycle are condensed through the cold part of the vapors exhausted in the OTC turbine and obtained by the separation of the vapors exhausted in the OTC—in the cascade of the OTC ADIABATIC VORTEX UNITS; condensation of the OTC fluid vapors is provided by an independent compression cooler refrigerant in the circuit, in which the refrigerant vapors are pre-cooled from the process heat recovery heater before the condenser of the cooler, and then another cooling of cooler condenser from the unit or a cascade of OTC vortex mass-temperature STRATIFICATION as well as from external environment, that is DISTINGUISHED BY THE FACT THAT the equipment supporting the operation of the HTPC ATNPP, including nuclear reactors, is placed on board of the flying ATNPP glider, and more than one undercritical hybrid nuclear reactor on molten salts, or accelerator-driven undercritical nuclear reactors on molten salts, is used as the primary source of thermal energy in the HTPC ATNPP; the HTPC ATNPP is designed as a binary one with several and parallel working second circuits with low-boiling fluids, and the transmission of thermal energy to the HTPC ATNPP from the nuclear reactors is carried out both continuously and in an alternate mode, meanwhile in order to ensure the maneuverability of power generation in the HTPC ATNPP, the pulse ratio and duration of reactor operation are controlled with periods that ensure the maintenance of reasonable temperatures of the coolant transferring energy to the STC and to the OTC, and a thermal flywheel energy storage unit is used to smooth out pulses of supplying thermal energy to the STC and the OTC; in the reset conditions of the HTPC ATNPP, the heat source coolant is heated from external energy sources; in the OTC, regenerative heating of the OTC fluid from the OTC cooler circuit is carried out; in order to improve the efficiency of the STC and ensure the maneuverability of the rejected heat transfer from the STC to the external environment and to the OTC, compression of the exhaust vapor from the LPC and the cold part of the vapor from the adiabatic VORTEX UNITS—superheater, is applied, thus improving also the operation of the condenser of the rejected heat to the external environment; the efficiency of condensation of some vapors when discharging thermal energy from the STC to the external environment is ensured by using the incoming airflow in the ATNPP flight with its additional overcooling through a VORTEX UNIT—Mass-Temperature Stratification Condenser (MTSC), or through a cascade of such units; in order to improve the mass-dimensional parameters of the HTPC ATNPP equipment, the ATNPP on-board electric machines are used based on high-temperature superconductors; the by-product heat generated by the applied vortex units such as air-cooled MTSC in the HTPC is used for technological fighting against possible in-flight icing of the ATNPP glider.

34. HTPC ATNPP of claim 33 is distinguished by the fact that in the first circuit of the binary cycle a composition representing titanium tetrachloride with a relatively small amount of helium or metal vapor, such as potassium, is used as a working medium, and in the second circuit of the binary cycle, saturated fluorocarbons, such as perfluoroheptane, are used as a working medium.

35. HTPC ATNPP of claim 33 is distinguished by the fact that parts of the supercooled air flows coming out of the MTSC VORTEX UNITS, are used to create working temperatures of superconductors in the ATNPP onboard electric machines.

36. The Emergency Response System of the Nuclear Aircraft System Karavan (NASK ERS), which is based on the towing aircraft—Aircraft Thrust Nuclear Power Plant (ATNPP) having on board a heavy radiation protection—a nuclear reactor capsule shell and additional shadow protection, while the nuclear reactor together with the primary heat exchanger circuit is designed as a separate unit equipped with a parachute system and capable of decoupling from the aircraft at a critical moment and performing a soft landing, is distinguished by the fact that to counteract emergencies in the ATNPP the totally safe nuclear reactors on molten salts of an UNDERCRITICAL type are applied; in case of a severe incident in the ATNPP flight, the ERS automatically and directively controls the undocking of the NASK aircraft and the “STURMAN” subsystem generates and delivers navigation data to the undocked aircraft to the optimal landing sites on the airfields; in case of a severe incident in the ATNPP flight, the ERS controls the targeted parachute and powered paraglider airdrop of nuclear reactors to a relatively long horizontal distance and to optimally safe landing sites for nuclear reactors in a soft manner and with deployment of special systems for reactor shutdown cooling; the electric power of the ATNPP during the flight provides charging of the onboard accumulators of the ERS BREAKERS built into the engineering dressing of the nuclear reactor structures and, through these breakers the targeted parachute and powered paraglider airdrop of nuclear reactors can be performed, the deployment and operation of reactor shutdown cooling systems can be carried out, as well as the operation of radio navigation beacons can be realized; charging of accumulator batteries of the onboard ERS BREAKERS is performed from electrical energy of the parachute solenoid electric generators operating from mechanical power of external environment during parachute powered paraglider flight and when the reactors are on the ground surface, or in the water; in cases of severe incidents at ATNPP, when the Hybrid Thermal Power Cycle (HTPC) equipment cannot ensure the flight of an emergency ATNPP to the nearest MS ATNPP due to the large flight distance, then the ATNPP glider is constructed according to a modular principle and individual modules of the ATNPP glider are mutually undocked and passively parachuted to optimally safe locations; emergency shutdown cooling of a nuclear reactor is provided and carried out for a period of time until a special Mobile Emergency Cooling Package (MECP) arrives at the landed reactor, and such packages can be equipped with various means of their delivery to the landed nuclear reactor: by paratroop, helicopter, ground-based of a high cross-country type and water-based, or rocket-based means.

37. The NASK ERS of claim 36 is distinguished by the fact that the heat released by the non-operating nuclear reactor, when it cools down, is directed through a gas pipeline into the inflatable soft wing, thus providing additional buoyancy during the drop of the reactor, and after its landing both on land and on water; in these cases, the gas pipeline serves as a drawing tube to reject the heat generated by the reactor to the external environment, and a controlled valve/exhauster is used in the inflatable soft wing, regulating the amount of gas required in the inflatable soft wing.
